(19) United States
(12) Patent Application Publication
(10) Pub. No.: US 2007/0180509 A1
(43) Pub. Date: Aug. 2, 2007

(54) Practical platform for high risk applications

(76) Inventors: Alon R. Swartz, Raanana (IL); Liraz Siri, Ariel (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/330,697

(22) Filed: Jan. 11, 2006

Related U.S. Application Data
(60) Provisional application No. 60/748,535, filed on Dec. 7, 2005.

(51) Int. Cl. H04L 9/32

(52) U.S. Cl. 726/9

(57) ABSTRACT

The present invention is a portable device that a computer can boot from, containing a prefabricated independent operating system environment which is engineered from the ground up to prioritize security while maximizing usability, in order to provide a safe, reliable and easy to use practical platform for high risk applications. An embodiment of the present invention may temporarily transform an ordinary computer into a naturally inexpensive logical appliance which encapsulates a turn-key functional solution within the digital equivalent of a military grade security fortress. This allows existing hardware to be conveniently leveraged to provide a self contained system which does not depend on the on-site labor of rare and expensive system integration and security experts.

### CROSS-REFERENCE TO RELATED APPLICATIONS

This application claims priority from U.S. Provisional Patent Application No. 60/748,535, filed on Dec. 7, 2005, which is incorporated herein by reference in its entirety.

### BACKGROUND OF THE INVENTION

1). Field of the Invention

The present invention relates to computers, computer security, and the security of online transactions. More particularly, the invention relates to a platform that provides security for the applications running on top of it.

2). Discussion of Related Art

Security is a common goal of computer systems. Security can be defined as the converse of vulnerability. The objective of computer security is to protect the confidentiality, integrity and availability of the data, resources and services of a computer system. This is accomplished by reducing the computer system's vulnerability to attack.

When a computer system is insufficiently secure, an attacker may gain unauthorized access to confidential data, violate the integrity of the system by changing it in some fashion (e.g., installing a backdoor), or interfere with the availability of the services or resources provided by the computer system.

It is counterintuitive that the nature of security prevents it from being simply added on to an existing system like a functional component. Security is a holistic emergent property of the entire system. Security needs to be carefully structured from the ground-up, and depends on a system's security architecture, the choice of platform, the components, how the pieces are integrated together, how they are configured and how the system is eventually used.

The security of any given computer system is relative, and can be measured by how difficult it is for an attacker to achieve objectives that conflict with the objectives of the defense.

a). Minimum Cost of Attack

The sum of all resources (time, specialized labor, equipment, financing, etc.) expended in a particular attack is called the cost of attack.

A security architecture can be interdependent. In this case, security is said to be like a chain, as strong as its weakest link.

For example, consider an online banking transaction. At the highest level, there are three interdependent security links: the bank's system, the encrypted transport layer, and the client side which may be an end-user conducting the banking transaction with his personal computer.

An attacker who wishes to compromise an online banking transaction to steal funds will naturally seek the easiest way to achieve his malicious objective.

The first link, the bank's system, is usually well protected with millions of dollars worth of equipment, expert security consultancy and mock penetration tests.

The second link, the transport layer, is encrypted with nearly unbreakable cryptography.

The third link, the client side, is probably using a PC with a mainstream operating system environment that was never designed for high risk applications such as online banking. Furthermore, this PC is usually installed, configured, maintained and operated by someone who is not a security expert. Someone who probably does not even understand the threats and most certainly does not have the skills or resources to protect against them.

In this example, the client side is the weak link in the chain because an attack against the client side will usually be vastly easier than an attack against the bank's system or the encrypted transport layer. Choosing to attack the client side will thus result in a lower cost of attack.

For any given malicious objective and computer system, the minimum cost of attack is that of the easiest or least expensive path (i.e., path of least cost) to achieve the malicious objective against the computer system.

Attackers may vary in sophistication, positioning (insider, vs. outsider) and the resources at their disposal.

Note that the minimum cost of attack may vary wildly with time, the positioning of an attacker, and the resources at the attackers disposal. For instance, it may be significantly more difficult (i.e. higher minimum cost of attack) for an outside attacker to break the security of a computer system than for an internal attacker with better positioning. Similarly, the minimum cost of attack may suddenly decrease if a vulnerability in the software used in a computer system becomes known to the attacker (e.g., by public disclosure, or word of mouth in underground communities) before it is fixed.

b). The Definition of a Secure System

In abstract economics terms, a system can be said to be secure if the minimum cost of attack is either greater than the resources at the attacker's disposal, or greater than what it is worth for an attacker to successfully compromise the system.

For example, it does not make economical sense for an attacker to spend a million dollars to compromise a computer system to steal confidential information or perform a transaction worth less to the attacker than one million dollars.

Additionally, even if the fruits of a successful attack are worth more than the minimum cost of attack, a system is still secure so long as the cost of attack is beyond the means of potential threats. So, for example, if you have one billion dollars worth of assets stored in a secure facility that will cost a minimum of 100 million dollars to compromise, the assets are secure so long as the cost of attack is beyond the means of the potential attackers.

In practice, it is difficult to make precise quantitative estimations regarding the minimum cost of attack, what a compromise is worth to an attacker, or what resources potential attackers will have at their disposal. A good deal of qualitative judgment is thus required in analyzing the security of a system. Experts must assign probabilities to approximate estimations, and provide generous margins for error.

c). The Source of Security Vulnerabilities

The reason computer systems are vulnerable in the first place is due to the fact that they are highly complex, imperfect constructs, which are created and used by people who can not fully understand them.

Security vulnerabilities exist in the gap between what is desired and what is.

The behavior of a computer is controlled by the software components it executes. The security of a computer system depends on how its software components are designed, implemented, integrated together, configured and used, and how closely the actual behavior of the resulting system is aligned with what is desired in relation to the system's security objectives.

A primary part of the problem can be attributed to the nature of software. Software is arguably the most complex class of man-made creations, in the sense that nearly all its interacting parts (e.g., routines, objects, libraries) are each unique because it is much more efficient to develop a solution for any given software task only once, and then re-use the solution where it is required by calling the software part that embodies the solution from other parts that need it. Software that does not adhere to this principle is considered poorly programmed and in need of refactorization. In contrast, hardware is usually engineered by combining groups of identical or similar parts which vary somewhat in specification but are usually standard in production and principle of operation (e.g. wheels, springs, screws, gears). Software is created to satisfy certain predefined objectives in a multiple-level process called software engineering.

Because software is so critical to the operation of computer systems, it is necessary to understand in general terms how software is created in order to understand where security vulnerabilities come from, and what can be done about them. At the highest level, software engineering often begins with a design process that translates objectives into an abstract system architecture that describes the essential parts of a software system and their relation.

At the next level, the architecture is translated into a specification to bridge the gap between architecture and implementation. This specification is a description of components, functionality, interfaces and interactions at a level of detail that allows the intended programmers to implement the software such that it will satisfy the intended objectives (usually functional requirements).

At the lowest level, programmers implement the software by translating each component of the specification into computer language instructions (code), which will be automatically compiled into low-level native or virtual machine code instructions that the computer can execute.

Unfortunately, the translation at each stage of the software engineering process is imperfect due to inherent complexities of software logic and the limitations of human intelligence to fully comprehend this complexity. There is only so much human beings can hold in their mind at once, and it is often necessary to divide a software project into smaller chunks and delegate responsibility for the different parts to different people.

The imperfect translation creates a gap at each level between what is desired and the actual result.

The aggregate gaps created at all levels of the engineering process result in a significant gap between the desired behavior of the software and its actual behavior in any given possible circumstance.

This is the reason many programming projects fail altogether and why programmers commonly spend a majority of their time debugging malfunctioning code rather than writing new code.

Debugging is the process of testing the resulting functional behavior of software in comparison to what is desired. Debugging is often employed in iterative fashion and is how software eventually becomes reliable enough to be useful.

Debugging, however, can only test against functional requirements, not security requirements. A program may satisfy all of its functional requirements perfectly and still be vulnerable to attack in some scenario (and hence be insecure).

Contrary to a functional requirement that can be positively tested for, one can not positively test for the absence of vulnerability. This means it is possible to prove a program is vulnerable, but impossible to prove it is secure.

The only way to test security is to assume the role of the attacker, and repeatedly attack the weakest links of a system with sophistication and resources comparable to those of a potential attacker that is trying to take advantage of unintended aspects of a system's actual behavior to trick it into providing unauthorized access.

The security of a system can be said to have improved only if the minimum cost of attack for that system has increased.

The role of the defense is intrinsically harder than the role of the attacker because while the defense's security objectives require that it finds and block all paths to a successful attack, attackers only need one path to achieve their objectives.

This further complicates reducing the gap between what is desired and actuality in the dimension of security objectives.

How large the gap is in the first place, depends on the functional objectives that are directing the engineering process.

d). Functionality vs. Security

Functional and security objectives naturally work against each other.

This is because the more functional objectives a system needs to satisfy, the more parts it will have at all levels of engineering.

Having more parts increases the complexity of the system, making it harder to fully understand all of the possible interactions between those parts. This increases the gap between what is desired and the actual result.

Since it is harder to evaluate security than functionality, the more functional objectives a system aims to satisfy, the harder it will be to satisfy its security objectives.

If complexity is defined as the sum of all possible interactions between the interdependent parts of a system, it is possible to mathematically demonstrate how adding parts will tend to increase the possible combinations of interactions, and hence complexity, exponentially.

As such, an exponential proportional relationship is suspected to exist between the desired functionality of a system and the corresponding difficulty of achieving any given level of security for that system (minimum cost of attack). That is, increases in functionality can unintuitively lead to exponentially large increases in the difficulty (or associated price) of achieving the same fixed level of security.

To reiterate, regardless of the specifics, a one thousand line software program is inherently much easier to secure than a one million line software system. In similar fashion, a large computer network is inherently much harder to secure than a small one.

Designing a system such that it will achieve its functional objectives with a minimum of parts, and combining those parts as independently as possible such that there is a minimum of interaction between parts, will decrease the complexity of the system, making the system easier to understand, decreasing the gap between what is desired and actuality and generally making the system easier to secure.

However, for any given level of functionality there will always be a minimal price in complexity that can not be escaped. Increasing functionality inevitably increases complexity.

This relationship between functionality and security is the fundamental inescapable conflict at the heart of computer security. Understanding this relationship is critical to understanding the failings of the prior art and the design principles of the present invention.

e). The Pervasive Insecurity of the Computer Systems of Today

Computer systems today are pervasively insecure to the extent that profitable attacks against them are commonly within the means of a wide range of potential attackers.

Common media reports of successful attacks against computer systems indicate that this is more than just a potential problem, but public perception of the problem is influenced by only the tiny minority of the successful attacks that receive exposure.

In practice, because the security of a computer system may be successfully compromised covertly, the majority of successful attacks remain undetected. A still smaller minority of the attacks that are detected, the tip of the iceberg, are brought to the attention of the public through the media.

The crisis is well demonstrated by the fact that many of the most widely reported security compromises against the computer systems of multi-billion dollar corporations, government and military networks have been carried out by bored teenagers. This has happened so often it has given rise to a mythology of the “genius” teenage computer hacker, strange, possibly superhuman beings with an almost magical ability to circumvent security mechanisms and gain unauthorized access to computer systems at will.

The minimum cost of attack was low, considering that the attacks were perpetuated by relatively unsophisticated amateurs in their spare time, with only the most basic equipment and no significant funding.

A primary reason that computer systems are pervasively insecure is because they are built on top of general purpose platforms that prioritize functionality over security, and as such suffer from weak security architectures.

Weak security architectures are an inevitable result of designing a platform such that it is useful in the widest range of circumstances with a minimum of resistance, because security and usability naturally work towards conflicting goals. Security tends to restrict the functionality and flexibility of a system, while usability aims to make everything possible as easily as possible.

Prioritizing usability will inevitably lead to a level of complexity that makes it very difficult to achieve any significant level of security for systems built on top of the platform.

The overwhelming priority given to usability at the expense of security can be attributed to the differences in visibility between the two, and their relative historical importance during the course of a platform's development. Market pressures will tend to prioritize development along dimensions of improvement that are most visible to the consumer.

Usability is easy to evaluate immediately, whereas poor security performance is invisible until it starts getting broken. In addition, the core design of today's mainstream platforms was developed in a historical context guided by different perceptions of the types of threats that would have to be protected against. For example, Microsoft Windows XP, the most common consumer operating system platform, shares its security architecture and much of its ancestry with Microsoft Windows NT. The security architecture for Microsoft Windows NT was designed before the massive development of the Internet and its associated flora of threats had emerged.

Similarly, the architecture of the Internet itself was originally developed in a research context to provide connectivity for academic institutions. Little attention was paid to security because it was not expected that the Internet would eventually evolve into the standard global network platform for high risk applications such as e-commerce.

The computer systems of today need to survive in a network environment that is far more hostile than anything the platforms they are built on top of were originally designed to handle. Internet connectivity exposes systems to attack by literally anyone on the planet, and there is increasing pressure to use such systems for high risk applications that attracts to them to an even wider and more dangerous range of threats.

f). Security Architectures

A security architecture is the pattern of elements that security depends on in relation to any given attack strategy.

A security architecture is said to be interdependent if the elements that security depends on are dependent on one another such that breaking the weakest element will break the security objectives of the whole. In this sense, an interdependent security architecture is like a chain (as strong as its weakest link), or a house of cards (pull one card out and the entire structure collapses).

For interdependent elements of a security architecture, the minimum cost of attack is the cost of breaking the weakest element.

Contemporary mainstream platforms suffer from weak security by default because prioritizing usability will naturally result in the emergence of a weak interdependent security architecture.

In contrast, a security architecture is independent if its elements are structured such that they contribute to the security of the system independently of one another. This is also called a multi layered security architecture.

For independent elements of a security architecture, the minimum cost of attack is the combined cost of attack for all elements that come into effect along the dimension of the given attack strategy.

In other words, if compromising the security objectives of a computer system requires an attacker to separately overcome a series of redundant security obstacles then the security architecture is multi layered in the dimension of that attack. This is accomplished by designing each layer to redundantly enforce the desired behavior in a way that compensates for potential failure elsewhere.

For example, Mandatory Access Control (MAC) is a common security mechanism supported by operating system platforms designed to enable multi layered security. MAC can restrict what resources a program is allowed to access based on a global set of rules called a MAC policy.

MAC makes it possible to carefully restrict the privileges of each program to the minimum it needs to carry out its function, which limits what a program can be tricked into doing regardless of how it is internally implemented.

A carefully configured MAC policy isolates the potential damage that the compromise of any individual program might otherwise have had on the rest of the system, protects the integrity of the system and its security controls from tampering, and intrinsically reduces the complexity of a system by reducing the potential for undesired behavior and interaction between components.

Additionally, the software that implements MAC in the operating system is orders of magnitude less complex than the software that it restricts, and interacts with the rest of the system in a clean and simple way. This makes it easier to understand and easier to audit, therefore reducing its potential for vulnerability.

Providing sufficient independent reinforcement of desired behavior at multiple layers is the only practical and effective strategy for achieving significant levels of security in sufficiently complex systems.

Multi layered security works by assuming that any individual layer of software may eventually fail to resist attack, so other layers must be prepared to compensate for this potential failure in order to defend the system's security objectives.

It is necessary to make this assumption because, as previously described, sufficiently complex software is nearly impossible to implement perfectly, due to the natural limitations of human intelligence, and this results in a gap between the actual behavior potential of imperfect software and what is desired by the programmer and users of the software. In some circumstances, an attacker may take advantage of this gap to trick the software into doing something it is not supposed or expected to do.

The aggregate effect of multiple layers of software may significantly increase the cost of attack by independently reinforcing the desired security objectives.

In other words, multi layered security is the only practical strategy for providing reliable security from unreliable software.

Multi layered security is also called the principle of the inevitability of failure, and has been recognized by the national defense and military establishments, where many of the mechanisms for implementing multi layered security were first researched and developed, and where multi layered security architectures are most commonly used today.

This is perhaps not surprising considering the magnitude of threats a military system is often expected to protect itself from: threats from nation state adversaries and a price of failure that is measured in human lives.

Despite providing for obviously superior security performance, actual usage of multi layered security architectures is surprisingly rare, even in the military settings it was originally developed for.

A number of factors have conspired to prevent the widespread adoption of multi layered security.

As previously explained security and usability work towards conflicting goals.

Assuming a finite budget is available for implementing a computer system, prioritizing security will inevitably come at the expense of usability, limiting a system's functionality, flexibility and its ultimate usefulness.

The higher our target security requirements (i.e., minimum cost of attack), the more expensive it will be to achieve any given level of usefulness.

In practice, this means the functionality of secure systems in the prior art has tended to be locked-down to specific specialized tasks in extremely high risk applications such as military command and control, stock exchange, and online banking (server-side). Tailor making these task-specific secure systems has tended to rely on the labor intensive efforts of high-end security and systems specialists. As such, they often do not benefit significantly from economies of scale and are prohibitively expensive.

For many uses, the prospect of a very expensive, inflexible task-specific computer system is not a viable replacement for the cheap, user friendly, general purpose computers currently being used that users have become accustomed to.

Without a fundamental understanding of security, it is difficult to accept that the same systems that work so well for general purpose low risk applications, can not be made secure enough for high risk applications without changing the systems such that the resulting compromise is incompatible with how existing general purpose computers are expected to work.

The price of this necessary compromise is not clearly understood by the decision makers that manage priorities. It is not even clearly understood at the technical levels that are implementing priorities, and certainly not at the level of the users who will suffer from its ramifications.

Again, it is counterintuitive that the nature of security prevents it from being simply added on to an existing system like a functional component. Security is a holistic emergent property of the entire system. Security needs to be carefully structured from the ground-up, and depends on a system's security architecture, the choice of platform, the components, how the pieces are integrated together, how they are configured and how the system is eventually used.

As long as the security architecture is interdependent, strengthening any of the elements that security depends on may not have a significant effect on the minimum cost of attack.

For example, consider again the security of an online banking application. Authenticating to a bank with a hardware cryptographic token is generally more secure than authenticating with a password, so some banks have begun providing their customers with such tokens.

Security is, however, also dependent on the integrity of the client side software that is providing the user with an interface to the bank. As long as the client's integrity is vulnerable to attack, strong authentication will not prevent an attacker from performing unauthorized transactions.

A compromised client could simply be reprogrammed to inject requests for unauthorized transactions into an authenticated online banking session, and even hide the evidence that the unauthorized requests had happened in the first place. This is harder than just stealing or guessing a password, but is not a significant obstacle relative to the billions of dollars at stake.

The choice of platform limits what security architecture a system can support. As previously explained, contemporary mainstream platforms are not designed for security. As a side effect, they usually do not support many of the security mechanisms that are useful in structuring a system for multi layered security, such as Mandatory Access Control, for example.

g). Inherently Weak Security Mechanisms

Instead, systems built on top of mainstream platforms most often rely on inherently weak reactive security mechanisms: the patch cycle, anti-virus and anti-spyware software.

### The Patching Cycle

Understanding why patching is a weak security mechanism requires one to understand how security holes are discovered and exploited in practice.

Imperfect implementation of software will result in security holes that allow an attacker to trick a program into doing something that is not desired.

The routine for taking advantage of a specific security hole is called an exploit, and is often embodied in software as an exploit program.

Installing a security patch will prevent a specific security hole from being exploited by changing the behavior of the software so it at least fixes the specific software imperfection that caused the security hole.

It can take some skill and effort to discover a security hole, figure out how to exploit it and write an exploit program that automates the process.

In practice, many security holes and exploit routines follow predictable, well known patterns, so this is not as difficult to accomplish as one might otherwise imagine. Also, part of the work can be automated by various means, and the rest can be easily divided amongst a group of people who each specialize in different parts of the process. This further reduces the cost of discovering security holes and developing exploits.

It takes even less skill and effort to actually use an exploit, especially through the friendly graphical user interface provided by contemporary penetration testing frameworks (Core Impact, Metasploit framework, Cortex—SecurityForest framework). In other words, possession of a working exploit reduces the minimum cost of subsequent attacks against vulnerable systems to nearly nothing. Just point and shoot.

Amateur exploit developers commonly share the fruits of their labor to gain reputation in the security community. First privately with each other, then with a growing circle of friends and eventually with the public at large via security mailing lists, websites, etc.

Part of the amateur's rational for sharing exploits is that vendors are occasionally reluctant to publicly acknowledge the existence of security holes in their products. Once a public exploit makes it possible for customers to verify exploitability of a vulnerability themselves, it is no longer possible to deny or downplay the ramifications of a security hole and the vendor has no choice but to acknowledge it and develop a patch.

Some in the security community thus argue that public disclosure of security holes and exploits is necessary, because otherwise vendors are motivated to keep newly discovered security holes a secret for as long as possible, to perhaps be fixed silently in the next version.

By contrast, professional attackers are highly motivated to keep the results of their research and development efforts secret. The longer they can keep an exploitable security hole secret, the longer it will be before the vendor will release an advisory and a patch, and the longer they will benefit from being able to use the exploit to compromise vulnerable systems in the wild.

As professional attackers are more powerfully motivated, sophisticated, and resourceful than amateurs, it is suspected that the majority of security holes are discovered and exploited in secret significantly in advance (sometimes years) of public disclosure and the availability of vendor patches.

Ironically, vendors and professional attackers share the same sentiments with regard to the public disclosure of security holes and exploits; they wish it would just go away.

Often public disclosure of a security hole and its corresponding exploit comes in advance of the availability of a vendor patch. This can happen for example, when a private “underground” exploit is caught being used in the wild.

Even after availability of a patch, there is still a public window of vulnerability until the actual installation of the patch by system administrators or an automated patch installation mechanism such as Microsoft Windows Update.

During this window, the widest range of potential threats can successfully compromise vulnerable systems with little to no effort. At this stage, opportunistic attackers will often race against the clock, against system administrators, and against each other to capture as many vulnerable systems as possible. Attacks can be fully automated and significantly accelerated by leveraging already compromised systems as platforms to deliver subsequent attacks.

While an automated patch installation mechanism can shorten the window of vulnerability, they are often disabled by users and system administrators.

Patches are sometimes very large, and so they are an inconvenience to download for users with only basic Internet connectivity such as dial-up. In private networks, Internet connectivity might not be available at all, and so patches must be obtained and applied manually.

It is nearly impossible to test the effect of a patch on all possible configurations of a general purpose computer system in advance, so it is not unheard of for a patch to break the system or destabilize it in some fashion. This is especially true for patches to operating system components that many other components are delicately interdependent with.

System administrators often disable automatic patching because they can not risk disabling production systems. Manually testing and applying patches is a labor intensive process, which can lengthen the public window of vulnerability and further increase the expense and inconvenience associated with the patch cycle.

Additionally, there is always the risk that patching one vulnerability may introduce another. The inherent imperfection of software applies recursively to software patches as well.

Relying on patches as a security mechanism is weak because it implies that software is somehow secure until the availability of an exploit makes it vulnerable to attack.

In truth, as long as software can not be perfectly implemented to align with what is desired, it must be assumed that failure is inevitable. When strong security is required we must use systems that have been structured to compensate for the inherent unreliability of software.

While it is possible to explain the weak security supported by mainstream platforms as an effect that has emerged unguided from historical circumstances and market pressures, some have suggested that a conflict of interest with platform vendors may contribute in some measure to further complicate the problem.

It has been observed that the weak security of mainstream platforms may actually serve the business interests of platform vendors, by increasing consumer dependence on the vendor, which the vendor may leverage as a pressure point to exercise increased control over the market.

For instance, a vendor may pressure consumers to upgrade to a newer version of a product by announcing that security patches will no longer be available for older versions after a certain date. Microsoft recently announced it would no longer release security patches for certain older versions of Windows.

Users are effectively forced to pay for upgrades because users of mainstream platforms depend on the patch cycle to achieve a minimum baseline of security. The cost of compromising an unpatched system is as low as running a public exploit against it, resulting in an often trivial minimum cost of attack that is ripe for mass automated exploitation by even the most unsophisticated class of attackers.

For example, recent studies have indicated that a fresh unpatched installation of Microsoft Windows XP survives uncompromised only a few minutes on average from the moment it is connected to the Internet, because malicious parties are constantly scanning the Internet automatically for unpatched machines which can be taken advantage of.

Similarly, limiting the availability of patches to legitimately licensed copies of the software can be used to deter software piracy, which can also increase vendor revenues.

Additionally, the patch cycle allows vendors to change and extend functional aspects of existing software installations, by bundling functional updates together with security fixes. For proprietary platforms, the contents of patches is usually opaque so users have little choice but to accept arbitrary changes to software they are using in order to enjoy the benefits of the required security fixes. Vendors can take advantage of this power to continually adjust the functionality of computer systems that depend on their platform to align with their current business interests. For example, a platform vendor might undermine a potential competitor by degrading interoperability with his products, or maybe add new functionality that removes the need for a competitor's products altogether.

### Anti-Malware

Another very commonly used security mechanism is anti-virus and anti-spyware software. Both will be collectively referred to as anti-malware, because they are technically equivalent except for the class of nuisances they target.

Contemporary products have existed in separate categories only due to historical circumstances and are already rapidly converging into one category.

Anti-malware can be defined as any software that is designed to react to the presence of suspected malicious software, including self-propagating virii and worms, trojan horses, backdoors, adware, etc.

Unlike the patch cycle, anti-malware does not actually fix or reduce vulnerability to security holes, but instead reacts to the presence of suspected malicious signatures at the operating system level of a protected computer.

The effect of anti-malware on the minimum cost of attack is insubstantial, because it does not actually reduce vulnerability.

For many attack scenarios anti-malware simply has no effect, and it is trivial and routine for even an amateur attacker to avoid its effect for other scenarios.

The weakness of anti-malware is inherent in its design, and holds true regardless of how any specific anti-malware program is implemented.

To understand why anti-malware is so weak, it is useful to understand in general terms how it works.

In abstract, Anti-malware software has three primary elements.

First, a database containing signatures that have been blacklisted. This database is continually updated with the signatures of new threats, usually through the network.

Second, a monitor that is hooked into system software to intercept events. This can be low-level operating system (OS) events such as attempting to read or execute a file, write to the registry (on Microsoft Windows) or higher-level events such as receiving email. A monitor interactively intervenes in the operation of the software it hooks into, reacting if attributes of an event match against signatures in the blacklist database.

The objective of the monitor is to prevent execution of malicious programs and warn the user.

Third, a scanner that scans the system for signatures in the blacklist database. A scanner may inspect files, running processes and various system records (for example, the Microsoft Windows registry) for evidence of malicious software.

The objective of the scanner is to detect the presence of malicious programs on the system after they have already been executed, so that they can be removed from the system.

An anti-malware program may have both monitor and scanner elements, or either without the other. For instance, most popular anti-virus programs have both, while some anti-spyware and anti-adware programs only have the scanner component.

Both scanner and monitor components rely on the blacklist database to tell the good from the bad.

But relying on a blacklist makes anti-malware a very weak security mechanism for several reasons that will be further explored in the following.

At a conceptual level, the assumption that software can be separated into black and white, good and evil, is much too simplistic. Most often, whether or not software is evil is decided based on the perceived intention of its developer. This works for clear and cut cases such as self-propagating virii and worms, but beyond simple vandalism the notion breaks down.

A software program is most often developed to be used as a tool. A tool does not have intention in itself. Without understanding what is desired, it is impossible to determine whether or not a tool is being used for legitimate purposes. This can not be accomplished by automated means because it requires human intelligence to understand what is legitimate in the correct context.

In other words: supposedly good tools can be used for evil purposes and vice versa. For example, anti-malware purports to detect illegitimate trojan horse programs, but little prevents an attacker from using legitimate remote administration tools (Microsoft Windows RDP, SMS, PcAnyWhere) for the same purpose.

In another example, it was made public that the Federal Bureau of Investigation (FBI) had developed its trojan horse program (Magic Lantern) for use in remote surveillance during criminal investigations. When asked to comment, major vendors of anti-malware stated they would not add the FBI's program to their database so as not to obstruct its legitimate crime-fighting efforts.

But what would happen if Magic Lantern leaked into the hands of criminals? Perhaps this is not so difficult to imagine considering the FBI has to install the software on the computers of suspects in order to use it, which naturally puts the software within the reach of potential criminals. What would prevent use of Magic Lantern for illegitimate purposes?

The weak distinction between good and evil software is well illustrated by the fact that even commercial attack frameworks (e.g., Core Impact) are usually not blacklisted by anti-malware. What prevents criminals from using pirated commercial attack software for purposes other than legitimate penetration testing?

Similarly, supposedly evil tools can be used for good purposes. For example, it is all too common for anti-malware vendors to include exploits and network vulnerability scanners in their blacklists. The rational is that attackers sometimes leverage compromised computers to launch subsequent attacks, so by detecting their tools, one can be alerted to their presence.

The problem with this argument is that there is a perfectly legitimate use for these supposedly evil programs. For instance, system administrators might use them to legitimately evaluate the vulnerability of the systems they are responsible for.

Setting aside for the moment how desirable it is to surrender often arbitrary judgment as to the legitimacy of software to a third party anti-malware vendor. Consider, how strong is a security mechanism that is dependent on the assumption that the bad guys will always use evil tools, the good guys will always use good tools, and that it is even possible to separate the world into such neat black and white categories in the first place?

A blacklist is weak at another level. Even when it is useful, it is trivial for even an amateur to bypass.

Assuming for argument's sake, that for some applications, a blacklist is conceptually good enough to be practically useful if there is a strict association between any specific software program and malicious intent.

Making such an association is easiest when the software developer is also the attacker. This is true in the case of self replicating virii and worms that were historically the primary threat that anti-malware programs were designed to protect against.

Given a sample of a software program (e.g., executable file), it is possible to calculate a unique signature that will allow a pattern matching algorithm to uniquely identify other instances of the sampled program against the extracted signature.

Matching against a signature makes the most sense for self-replicating programs written by vandals, because they are either identical or restricted by the naturally simple ways a program can change itself without a human programmer. So while in fact some self-replicating programs do try to evade signatures by changing themselves, anti-malware developers have developed techniques for seeing through their disguises.

Anti-malware software was effective enough in protecting against vandalism that it was natural for vendors to try and extend the blacklist pattern matching approach to blacklist undesired software such as trojan horses and spyware.

Unfortunately, this doesn't work very well because it is trivial for even an unsophisticated human amateur to outsmart the most sophisticated automated pattern matching algorithm.

By setting up an environment with all the common anti-malware programs, an attacker can receive feedback as to what passes the blacklist driven pattern matcher of an anti-malware program.

Before launching an attack, it is a routine precaution for an attacker to make sure none of the instruments of attack (e.g., a trojan horse) are identified by common anti-malware programs.

An attacker can bypass the blacklist by either selecting tools that are not in the blacklist to begin with, or by changing or repackaging existing tools so they no longer match the signature.

When source code is available, a program is easy to manually change so it no longer matches the original sample's signature. Commercial tools also exist that will obfuscate the source code of a program and achieve the same effect automatically, though this is not what they are intended for.

Even when source code is not available, repackaging a program inside the protective envelope created by a legitimate software encryption tool will achieve the same effect.

Software encryption tools exist to make it more difficult to reverse engineer or make unauthorized modifications to bypass license restrictions and copy protection enforcement. Anti-malware programs can not peek inside the protective envelope created by a legitimate software encryption program, and they can't blacklist the envelope itself because then the signature would match many legitimate programs as well. Developers of software encryption programs are in a constant arms race against the reverse engineering efforts of software pirates, so they can not afford to make the envelope weak enough to allow anti-malware programs to peek through it.

A blacklist is weak at yet another level, because you need a sample to generate a signature. As it shall be shown, the dynamics revolving sample collection weaken the blacklist concept even further.

So before you can generate a signature (that we have demonstrated is easy to bypass), you need to collect a sample of the software you are going to blacklist.

Customers of anti-malware sometimes send in the samples they catch themselves for analysis at the vendor's labs, but mostly vendors collect samples by setting up bait.

A statistically meaningful distribution of specially configured computers (called “sensors” or “honeypots”), which are spread across the network survey the Internet for threats and intercept samples for analysis.

This is best at catching various types of indiscriminate self-replicating software vandals and unsophisticated bruteforce attacks opportunistically targeting thousands if not millions of computers by automated means.

For these low-end threats the vendor's survey group is a roughly accurate scaled-down statistical representation of the entire network. It is useful to collect samples because the generated signatures can be used to scan and remove malicious software from infected systems and prevent its execution in systems that have yet to be infected.

For other threats, samples are not likely to be collected to begin with, and may be of only marginal usefulness even if they are.

As previously explained, an attacker's instruments of attack will not be identified by common anti-malware programs, if the attacker takes certain routine precautions.

This means initially, by definition, the anti-malware monitor will not prevent execution of the attacker's software.

Subsequently, a signature will be generated from a sample of the attacker's software if the attacker's software is manually detected and sent for analysis, or if the attacker unwittingly targets the bait set up by anti-malware vendors.

For more sophisticated attacks, it is not likely a sample will be collected manually because an attacker's tools can be carefully hidden or camouflaged such that it can be very difficult to detect them manually unless one knows exactly what to look for, even when aided by rare systems expertise.

Also, a sample is not likely to be collected automatically unless the attackers indiscriminately attack a large enough numbers of computers so that they also unwittingly target the bait.

Even when a sample is collected, by definition the reaction to the threat always lags behind the actual attacks. A signature will be generated and updates to the blacklist database will be made available, but by then, the malicious software has already executed on the initially attacked computers and the damage may already be done.

Scanning the system with the updated blacklist database may detect the malicious software and allow its removal, but only if the integrity of the anti-malware program itself and the integrity of the software it is dependent on has not yet been tampered with. For example, an anti-malware program won't detect and remove the attacker's software in retrospect if the attacker disables the ability of the anti-malware program to update its blacklist. Following the compromise of a system there is literally countless ways an attacker can tamper with anti-malware software to circumvent its effect.

It is very difficult for an anti-malware vendor to significantly protect the integrity of the anti-malware mechanism against tampering by an attacker that has already compromised the system, because the integrity of anti-malware is dependent on the security of the operating system, and the security of mainstream operating systems is inherently weak, for reasons previously described (prioritizing usability over security leads to interdependent security architecture).

Even if we take the integrity of anti-malware for granted, for argument's sake, it is still possible for an attacker to automatically generate software with new signatures to replace previous software that has been blacklisted faster than users of anti-malware can update their blacklist databases and scan their systems. Fully scanning a system is resource intensive and time consuming, so users are naturally reluctant to do it very often. Also, the attacker's active initiative gives him a significant advantage compared with the passive reactive role of the defense.

It should be noted that anti-malware is not the only popular class of security mechanism to rely on the blacklist and suffer its conceptual weaknesses.

In particular, the IPS (Intrusion Prevention System) shares many conceptual similarities with anti-malware, including a very similar principle of operation, and nearly identical weaknesses.

The primary distinction is that an IPS is designed to monitor the network to detect and react to blacklisted traffic signatures such as those generated by exploit routines, instead of trying to detect and react to the presence of blacklisted software at a system level.

In conclusion, it is easy to see why relying on a blacklist weakens anti-malware, so that as a security mechanism it is only statistically effective for maintaining system availability in the face of blind vandalism and against attacks from the weakest opportunistic opponents.

For many applications, anti-malware may not be worth its associated costs, which include the significant performance hit which is suffered from continually monitoring and scanning the state of the system against a large blacklist.

Additionally, there is risk that the false sense of security promoted by the misleading advertising of commercial anti-malware vendors will increase the chances that consumers will use their inadequately secured computer systems for high risk applications and suffer substantial damages.

The widespread dependency on anti-malware is a testament to the general confusion regarding computer security and the aggressive marketing efforts of anti-malware vendors representing their business interests.

While the security provided by anti-malware is technically very weak, it supports a lucrative business model that provides a steady stream of revenue from service contracts (subscription) to anti-malware customers in need of constant blacklist updates. This has grown over the years to a huge global multi billion dollar industry. Today, nearly all of the largest computer security companies in the world are anti-malware vendors.

The use of anti-malware has historically been limited to computers based on the Microsoft Windows platform.

Much to the disappointment of anti-malware vendors, users of other platforms have yet to recognize the need for anti-malware, because other platforms, such as the Apple Macintosh have yet to be effected substantially by the regular plagues of spyware and self replicating software vandals, which have been the bread and butter of the anti-malware industry on Microsoft Windows.

Some have argued this might change if any of the platforms became nearly as popular as Windows, which has a majority share of the operating system market, monopolizing the desktop.

However popularity is not the only reason Windows has been such a fertile breeding ground for vandalism and spyware.

Due to historical circumstances, users of Microsoft Windows have become accustomed to running untrusted software on their computers with full privileges. Out of the box, the functionality of a Windows based computer is rather limited, so users are used to complimenting it with various free and shareware software they download from the Internet, in a hard to inspect binary package. Users routinely intensify the problem by running everything with full Administrator privileges. This is naturally considered bad form in the security community, but most users don't understand anything about the security model or the risks, and it is much easier to install and run software this way.

The business model for many of these supposedly free programs is to smuggle various forms of undesired software into an unsuspecting user's computer along with the desired program.

In contrast, users of Unix-like systems tend to be more technically astute. Unix-like systems have more complete functionality to begin with, and when complimentary software is desired, it is often downloaded from reputable vendors as cryptographically signed source code, which is easier to inspect for changes and unwanted functionality compared to executable binaries. Furthermore, users of UNIX-like systems are much more likely to run software with limited privileges as a security precaution and to prevent accidental damage to the system.

This is the primary reason spyware and self replicating vandal-ware have always been orders of magnitude less common on Unix-like systems than on Microsoft's family of operating systems, despite Unix's longer history.

The need for anti-malware springs from weak security design. It is possible to eliminate the problem that has given rise to anti-malware from the root by preventing execution of untrusted code altogether or sufficiently restricting its privileges.

A simple, yet somewhat limiting strategy could be to use a whitelist to restrict execution of software instead of a blacklist.

In other words, instead of playing unwinnable cat and mouse games attempting to blacklist all the programs that are not allowed to run, a whitelist can be used to conversely restrict execution only to programs that are allowed.

Another well known approach would be to restrict the privileges of untrusted software such that it can not violate the system's security objectives. This might be accomplished by running untrusted software in a jail or sandbox, logically isolated from the rest of the system. Most operating system platforms support reduced privileges to an extent, but the security controls are usually not fine grained enough to provide strong enforcement of the proposed logical isolation.

Unfortunately, neither of these solutions would be practical to implement for use with mainstream platforms because too many other things would have to change at the same time for them to work, such as how users expect a system to function, what privileges popular software is developed to run under, what type of skills are required to integrate and configure the components of a computer system together, and so forth.

For example, users will most likely protest at not being able to install any software they want on their own computers. Software developers don't expect their programs to run in some kind of jail or sandbox, so existing software won't work if it is dependent on having full access to the system. And even if multi layered security controls were suddenly supported by mainstream platforms, they would most likely be ignored because few understand why they are needed and fewer have the skills to actually use them correctly.

Making computer systems secure enough so that there is little use for anti-malware is perhaps possible, as demonstrated so far by the Apple Macintosh. This is only because anti-malware is so technically weak to begin with.

But making computer systems secure enough so they can be used safely for high risk applications is not possible without re-adjusting usability expectations and then re-engineering a computer system from the ground up to prioritize security at every level that it is dependent on, especially architecture, design and implementation of components, how they are integrated together, configured and used.

h). Ideal Systems

As previously explained, computer systems of today are pervasively insecure because they have been designed as general purpose tools that prioritize functionality and flexibility over security and as such suffer from weak interdependent security architectures that rely on correspondingly weak reactive security mechanisms.

Ideally, computer systems would provide exactly as much functionality as is required, with security that is designed from the ground up, in an independent multi layered security architecture that ensures a minimum cost of attack that is either greater than the resources at the attacker's disposal, or greater than what it is worth for an attacker to successfully compromise the system.

Ideally, secure systems would be tamper-proof and fault tolerant, and would not depend on either a patch cycle for security maintenance, or various incarnations of blacklist driven security mechanisms such as anti-malware and Intrusion Prevention Systems. Security would thus be a reliable, predictable property of computer systems that could be taken for granted to safely enable high risk applications.

On the other hand, it is often considered impractical to replace contemporary computer systems with systems engineered from the ground up to prioritize security because the functionality of secure systems tends to be limited in ways that are incompatible with how computer systems are expected to work.

Another deterrent to the widespread adoption of secure systems is cost. Secure systems are currently very rare and expensive because developing them requires the labor intensive efforts of rare high-end security and systems integration experts in a manual client-specific process that does not benefit from economies of scale.

Accordingly, it would be desirable to somehow overcome these deterrents and make the widespread adoption of task-specific secure systems practical, at least for the high risk applications that require high-end security (online banking, for example).

To achieve widespread adoption, the solution would ideally need to be made affordable by designing it to benefit more significantly from economies of scale and leverage existing investments in hardware.

As users will never become security or system experts, special expertise should not be required to setup or use the solution.

The solution is ideally as easy and convenient to use as possible, because users won't benefit from the security provided by a solution they avoid using. To users, security is intangible until it is broken, whereas as the inconvenience suffered by security requirements is a tangible burden that users will often try to avoid.

The solution should ideally take advantage of existing commodity hardware architectures, such that it does not require consumers to purchase new computers or replace their existing hardware to enjoy its benefits.

For some applications, it would be desirable to allow users to switch into a high security mode only for the high-risk tasks that need it, so that the necessary tradeoff that sacrifices functionality and flexibility for security is temporary, and the compromise is enabled only when security requirements justify it. Users may be willing to tolerate some inconvenience for the sake of security when it is absolutely necessary, but it is not practical to expect them to altogether abandon the functionally rich, flexible general purpose computers they have become accustomed to and have grown dependant on.

It can also be desirable to allow the solution to be easily distributable by service providers. For example, a bank could distribute the solution to its online banking clients to so that the client side would no longer be the weak link Achilles heel of online banking. Similarly, a company could distribute the solution to its employees so that they could remotely access company resources securely from any PC without worrying whether or not it has been previously compromised by trojan horses that an attacker could have installed to intercept confidential data.

Further objects and advantages of the present invention will become apparent from a consideration of the drawings and ensuing description.

### SUMMARY OF THE INVENTION

Methods and apparatus consistent with the principles of the invention for providing a prefabricated independent operating system environment which is engineered from the ground up to prioritize security while maximizing usability, in order to provide a safe, reliable and easy to use practical platform for high risk applications.

An embodiment of the present invention may temporarily transform an ordinary computer into a naturally inexpensive logical appliance which encapsulates a turn-key functional solution within the digital equivalent of a military grade security fortress. This allows existing hardware to be conveniently leveraged to provide a self contained system which does not depend on the on-site labor of rare and expensive system integration and security experts.

According to one aspect of the invention, an apparatus is provided comprising at least a portable non-volatile memory element, an operating system environment stored on the memory element, and boot means for loading the operating system environment from the memory element to provide an independent operating system environment.

In one embodiment, the present invention may be used to secure the client side of a transaction between a client and a service provider through a network by providing the client with an apparatus in which the operating system environment includes means for interfacing with the service provider. A service provider may easily and economically distribute the portable apparatus to enable its clients to securely access sensitive services (e.g., online banking, corporate Intranet, medical database) through an untrusted network from untrusted and potentially insecure computers.

According to another aspect of the invention, to satisfy the demanding security requirements of high risk applications, the provided apparatus may integrate physical security hardware with security mechanisms included in the independent operating system environment. The integrated security mechanisms are configured to provide a substantially fault-tolerant multi layered security architecture. Each security layer independently reinforces security objectives in a way that compensates globally for the potential for local security failure in any specific component.

According to another aspect of the invention, the independent operating system environment provided by the apparatus may include features that promote convenience and ease of use such as boot process optimizations for reducing how long it takes to switch into the independent operating system environment, advanced automated hardware configuration, a user-friendly graphical interface that will feel familiar to users of mainstream platforms, a connectivity agent mechanism for assisting in establishing network connectivity across a variety of scenarios with minimum user interaction, and a migration agent mechanism for assisting in migrating a user's application data from the mainstream operating system environment.

According to another aspect of the invention, in one embodiment, the independent operating system environment provided by the apparatus may include support for creating and accessing a persistent safe storage element for storing data inside an opaque container residing either on the filesystems of the mainstream operating system environment or at a predetermined network storage location. The persistent safe storage mechanism may be used to overcome the obvious limitations inherent in loading an operating system environment from a read-only (logically or physically) memory element. Using this mechanism, the integrity and confidentiality of data is protected while it is stored within the filesystems of a potentially insecure mainstream operating system or network storage location.

In another embodiment, optimized for use with dedicated computer hardware, the independent operating system environment provided by the apparatus may include support for creating and accessing a logical volume element which may more efficiently and flexibly utilize the storage capacity of the computer's internal storage devices, in comparison to the persistent safe storage mechanism.

According to another aspect of the invention a method is provided for securing the client side of a transaction between a client and a service provider through a network comprising providing the client with an apparatus that a computer can boot from in order to provide an independent operating system environment. The apparatus is comprised of a portable non-volatile memory element and an operating system environment stored on the portable non-volatile memory element. The operating system has an environment including client software for interfacing with the service provider to perform the transaction, wherein the client software is configured to encrypt communication with the service provider and has a bootloader for booting the operating system environment from the portable non-volatile memory element.

According to another aspect of the invention an apparatus is provided that a computer can boot from, in order to provide an independent operating system environment, comprised of a portable non-volatile memory element, an operating system environment stored on the portable non-volatile memory element, and a bootloader for booting the operating system environment from the portable non-volatile memory element.

According to another aspect of the invention a method is provided for providing an independent secure operating system environment on a computer. The method includes providing a portable non-volatile memory element, storing an operating system environment on the portable non-volatile memory element, providing a bootloader for initial bootstrapping of the operating system environment from the portable non-volatile memory element, wherein initialization of the operating system environment is started by booting the computer from the portable non-volatile memory element using the bootloader.

According to another aspect of the invention a method is provided for providing an independent operating system environment on a computer, including inserting into the computer an apparatus that the computer can boot from and booting the computer from the apparatus, wherein the apparatus is comprised of a portable non-volatile memory element, an operating system environment stored on the portable non-volatile memory element, and a bootloader for booting the operating system environment from the portable non-volatile memory element.

According to another aspect of the invention, a computer system is provided comprised of a network, a service provider interfacing with the network, a client computer interfacing with the network, and an apparatus that the client computer can boot from, wherein the apparatus is comprised of a portable non-volatile memory element, an operating system environment stored on the portable non-volatile memory element, and a bootloader for booting the operating system environment from the portable non-volatile memory element, wherein the client computer communicates with the service provider over the network.

According to another aspect of the invention a method is provided for communicating between a client computer and a service provider. This method includes interfacing a service provider with a network, interfacing a client computer with the network, inserting into the client computer an apparatus that the client computer can boot from, and booting the client computer from the apparatus, wherein the apparatus is comprised of a portable non-volatile memory element, an operating system environment stored on the portable non-volatile memory element, and a bootloader for booting the operating system environment from the portable non-volatile memory element, wherein the client computer communicates with the service provider over the network.

### BRIEF DESCRIPTION OF THE DRAWINGS

The invention is further described with reference to the accompanying drawings wherein like reference numerals indicate like components or steps, and wherein

FIG. 1 is a diagram illustrating a high-level overview of an exemplary environment in which one embodiment of the invention may be used;

FIG. 2 is a diagram illustrating the computer hardware architecture of an exemplary computer system with which the invention may interface with;

FIG. 3A is a diagram illustrating exemplary physical hardware architecture of a portable tamper-resistant security device that is consistent with the principles of the invention which may connect to the device interfaces of the computer hardware shown in FIG. 2;

FIG. 3B is a diagram illustrating an exemplary embodiment of a security device that is consistent with the principles of the invention as portable tamper-resistant storage media which can be read by the media interfaces of the computer hardware of FIG. 2;

FIGS. 4A, 4B are high-level flow diagrams that illustrate exemplary user interaction steps with the preferred and alternative embodiments of the invention;

FIG. 5 is a diagram illustrating the outer filesystem that is stored inside variations of the security device shown in FIG. 3A, 3B;

FIGS. 6A, 6B are diagrams illustrating exemplary multi-level functional overviews for the preferred and alternative embodiments of the invention;

FIGS. 7A,7B are high-level flow diagrams that illustrate exemplary steps in the boot process for the preferred and alternative embodiments of the invention;

FIGS. 8A, 8B are flow diagrams that illustrate exemplary steps in the operation of the initialization manager software during the boot process of FIGS. 7A, 7B for the preferred and alternative embodiments of the invention;

FIGS. 9A-I, 9A-II are flow diagrams illustrating exemplary steps for creating and accessing the persistent safe storage element used by the preferred embodiment's initialization manager software shown in FIG. 7A;

FIGS. 9B-I, 9B-II are flow diagrams illustrating exemplary steps for creating and accessing the logical volume element used by the alternative embodiment's initialization manager software shown in FIG. 7B;

FIGS. 10-I, 10-II, 10-Ill are flow diagrams illustrating exemplary steps in the operation of the connectivity agent software used, in one embodiment of the invention, to establish and maintain network connectivity across a variety of circumstances with minimum user interaction;

FIGS. 11-I, 11-II, 11-III, 11-IV are flow diagrams illustrating exemplary steps in the operation of the migration agent software used, in one embodiment of the invention, to assist in migrating application content and configuration data to application software integrated into the independent operating system environment provided by the security device;

FIG. 12 is a high-level block diagram illustrating the exemplary runtime operating system architecture initialized by the boot process of FIGS. 7A, 7B;

FIG. 13 is a block diagram illustrating the exemplary multi-level security layers for one embodiment of the invention; and

FIG. 14 is a high-level flow diagram illustrating the exemplary steps in the secure production process of one embodiment of the invention.

### DETAILED DESCRIPTION OF THE PREFERRED EMBODIMENT

The present invention involves novel methods and apparatus for enabling, within the context of the existing computing environments, the practical adoption of task-specific computer systems which can prioritize security while maximizing usability.

1). Overview

A brief overview of the preferred embodiment in the context of its particular applications and requirements, will now be described.

As previously discussed, for many high risk applications, the client side is the weak link in the chain of security. For example, in an online banking session, the server side and transport layer will usually be well protected, while the client side will usually be orders of magnitude more vulnerable to attack.

In contrast to the server side which is often secured with significant investments in special security equipment, software protections and the labor of skilled experts, the client side computer is most likely to be installed, configured, maintained and used by a regular user who is not a security expert, and can not be expected to become a security expert.

The client side will usually be a computer running a mainstream graphical operating system such as Microsoft Windows, which currently enjoys over 90% market share on the desktop.

To make matters even worse, it is also clear that mainstream platforms such as Microsoft Windows were never designed to be platforms for high risk applications to begin with and that contemporary versions of these platforms have inherited much of this heritage.

For example, this means the minimum cost of attacking a Windows PC, even a relatively secure Windows PC with the latest security patches, anti-virus and anti-spyware programs, and a personal firewall, is still much lower than what it could be worth to attackers, and well within the means of a range of potential threats including organized crime.

The client side can be the to be the weak link because an attacker seeking to compromise the security of a high risk client-server application will naturally look for the easiest path to achieving his goals and will thus prefer to target the client side.

In an ideal world, it would be practical to provide users with separate special purpose secure computers that would be safe for high risk applications. Unfortunately, for many applications this is not considered economical.

In practice, it would be highly desirable to provide sufficient security using the PCs that are already in the possession of most users. The preferred embodiment is an embodiment of the invention that is optimized for personal use.

Assuming most users will continue using the regular PCs they have become accustomed to, the preferred embodiment is optimized to exist in symbiosis with potentially insecure mainstream PC operating systems, allowing users to quickly switch into a temporary high security mode that is independent of the security of their normal PC operating system.

In other words, when used, the security provided by the present invention is not weakened by a user's PC being infested with any manner of sophisticated trojan horses, key loggers, backdoors, virii, spyware or any other arbitrary software.

As it is intended for personal use, the preferred embodiment is also optimized to be convenient and easy to use by the average computer user.

In part, all of the above is achieved by booting an independent secure operating system environment live from a device consistent with the principles of the invention, so that installation to hard-drive is not required. Furthermore, the computer system provided by the invention requires minimal configuration, because the computer system was preconfigured by experts during the device's production process, thus making it easier for users to use the preferred embodiment of the present invention, and is also critical to the security provided by the invention as unskilled users are not expected to be capable of installing and configuring a computer system in a way that provides sufficient security.

Additional convenience and ease of use may be achieved by reducing how long it takes to switch into the high-security mode provided by the present invention, by providing support for automatic migration of a user's application data from the insecure PC environment, by providing a user-friendly graphical user interface that will feel familiar to users of mainstream platforms, and by providing mechanisms that will assist in establishing network connectivity across a variety of scenarios with minimum user interaction.

In one embodiment, a cryptographic component may be integrated into a device that is consistent with the principles of the invention. Integrating a cryptographic component may increase security by providing stronger authentication and may also make the invention easier to use by reducing the amount of passwords the users is required to remember.

Naturally, any application that requires security would benefit from the solution provided by the preferred embodiment of the invention, not merely the most demanding high-risk applications such as online banking.

Other applications, for example, include enabling users to safely access any security sensitive computer service or resource in commercial, government or military settings. Such access could be safely provided with a very high degree of security by using the preferred embodiment in conjunction with any computer equipped with a network connection. Using the present system, it would no longer be necessary to trust the software integrity of the computer being used, as the security provided by the invention is self contained.

The preferred embodiment is also optimized to be easily and economically distributable by service provides as a practical client side security solution.

For example, a bank might distribute a device that is consistent with the principles of the invention to its clients, a company IT department might distribute it to employees, or to third party affiliates. A government might distribute it to citizens to enable secure remote access to government facilities and sensitive services such as online voting.

Achieving this advantage involves, in part, a small and light physical form factor, the ability to work seamlessly with the majority of existing hardware combinations, and a relatively low target cost that is a result of a production process that significantly benefits from economies of scale.

The preferred embodiment will now be further described in elaborate detail with reference to the diagrams. An alternative embodiment will also be described. Reference in the drawings for “PE” signifies the preferred embodiment and “AE” signifies the alternative embodiment.

2). Exemplary Environment in Which the Invention May be Used

The following description of an exemplary environment in which the present invention may operate is presented to illustrate examples of utility of the present invention and to illustrate examples of contexts in which the invention may operate.

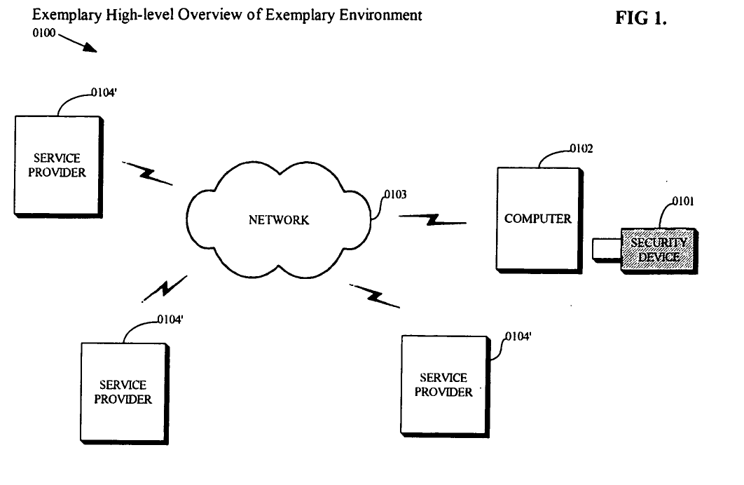

However, the present invention can be used in other environments and its use is not intended to be limited to the exemplary service provider, network environment, computer hardware, security device and user interaction steps 0401 introduced below with reference to FIGS. 1, 2, 3A, 3B and 4A, respectively.

FIG. 1 is a diagram illustrating a high-level overview of an exemplary environment 0100 in which at least some aspects of the present invention may be used. In this environment 0100, a computer 0102 (client) used in conjunction with a security device 0101 embodiment consistent with the principles of the invention, may be used to securely access a service or resource provided by service providers 0104 (servers) through a network 0103 (such as the Internet, or an Intranet for example) they are both connected to.

For example, a service provider 0104 may be an online financial services provider such as an online bank. Clients of the bank may connect the security device 0101 to their home or work computer's 0102 to safely communicate with the service provider 0104 and access banking information or conduct secure online banking transactions.

Another example of a service provider 0104 is a company that wants to allow employees to securely access corporate network resources (e.g. email, instant messaging, voice over IP, file servers, project collaboration, terminal client servers, databases, source code repositories or custom applications, for example), through the Internet 0103 even from the untrusted home computers 0102 that employees children may play around with.

Other example environments 0100, include providing secure access to sensitive services or resources in any commercial, government or military setting. A doctor accessing a patient's confidential medical records, a lawyer that needs to work on confidential legal material protected by client-attorney privilege, a supplier interfacing with a customer's supply chain network, a research and development laboratory developing a valuable technological breakthrough, and so forth. Any client-server scenario where security is a requirement.

Network 0103 may include a local area network (LAN), a wide area network (WAN), a wireless local area network (WLAN), a telephone network such as the Public Switched Telephone Network (PSTN), an Intranet, the Internet, or another type of network or a combination of networks.

A computer 0102 may be, for example a Microsoft Windows desktop computer running on x86-compatible hardware, an Apple Macintosh, a Linux workstation, a laptop, a PDA, an advanced wireless phone, a game console (for example, a Sony Playstation or Microsoft Xbox), or any other device that may be used as a computer.

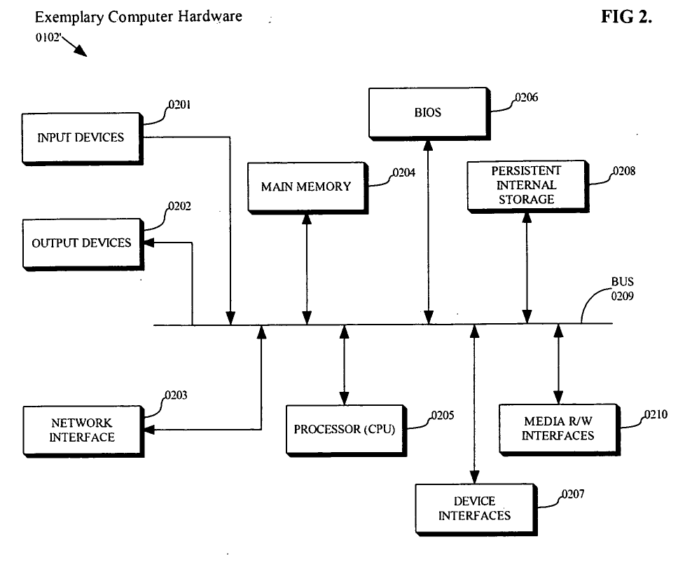

FIG. 2 is a high-level diagram illustrating in abstract the computer hardware of an exemplary computer 0102 the security device 0101 may be used in conjunction with. The hardware of a typical computer may include a processor or CPU 0205 coupled by a bus or other interface 0209 to persistent internal storage 0208 mechanisms on which operating system software is usually stored and loaded into main memory 0204 in a process controlled in part by a BIOS 0206. The computer interfaces with the user through input devices 0201 and output devices 0202, and interfaces with the network through a network interface 0203. The computer hardware can usually be expanded by connecting additional peripheral devices to the device interfaces 0207. Usually the computer hardware includes media r/w interfaces 0210 for reading and writing to external removable storage media.

Processor 0205, can be for example, a microprocessor, such as the Pentium TM or XScale microprocessors made by Intel, the Athlon line of microprocessors made by Advanced Micro Devices (AMD), a Cell or PowerPC microprocessor made by IBM, or other processor.

Main memory 0204 can include, for example, random-access memory (RAM), read-only memory (ROM), virtual memory, or any other working storage medium accessible by the processor 0205.

Persistent internal storage 0208 can include, for example, persistent magnetic or optical internal storage mechanism such as a hard drive, flash memory, ROM or EPROM chip, another type of persistent storage or a combination of different types, on which operating system and application software may be persistently stored along with user data.

BIOS 0206, can be, for example, the Phoenix BIOS made by Phoenix Technologies, the opensource OpenBIOS, or any other element for first initialization of a computer's hardware and boot process.

Input devices 0201 can include, for example, an alphanumeric keyboard with function and cursor-control keys, a pointing device such as a mouse, trackball, touchpad, stylus, joystick or the like.

Output devices 0202 can include, for example, a CRT or flat panel display, a printer, a sound card, or other human interface devices.

A network interface 0203, can include, for example, a modem, a wired Ethernet, GigaEthernet, token ring network interface card, a wireless network interface card for use with 802.11a, 802.11b, 802.11g, WiMax or cellular wireless networks, or any other device that allows a computer to interface with a network.

Device interfaces 0207, can include, for example, USB, FireWire, PCMCIA, SDIO, wireless device interfaces such as bluetooth, and other device interfaces by which a computer can communicate with peripherals.

Media read/write interfaces 0210, may include, for example, floppy drives, drives for high capacity removable magnetic storage media such as SuperDisk, IOMega ZIP Drives, and the like, optical storage drives for removable CDROM, DVD, HD-DVD, Blu-ray disc media, readers for Flash, memory stick, Secure Digital (SD), Multimedia Memory Card (MMC), SmartMedia, XD and other memory chip media, including any other interfaces for accessing a standard or proprietary removable storage media format.

3). Exemplary Physical Embodiments of the Security Device

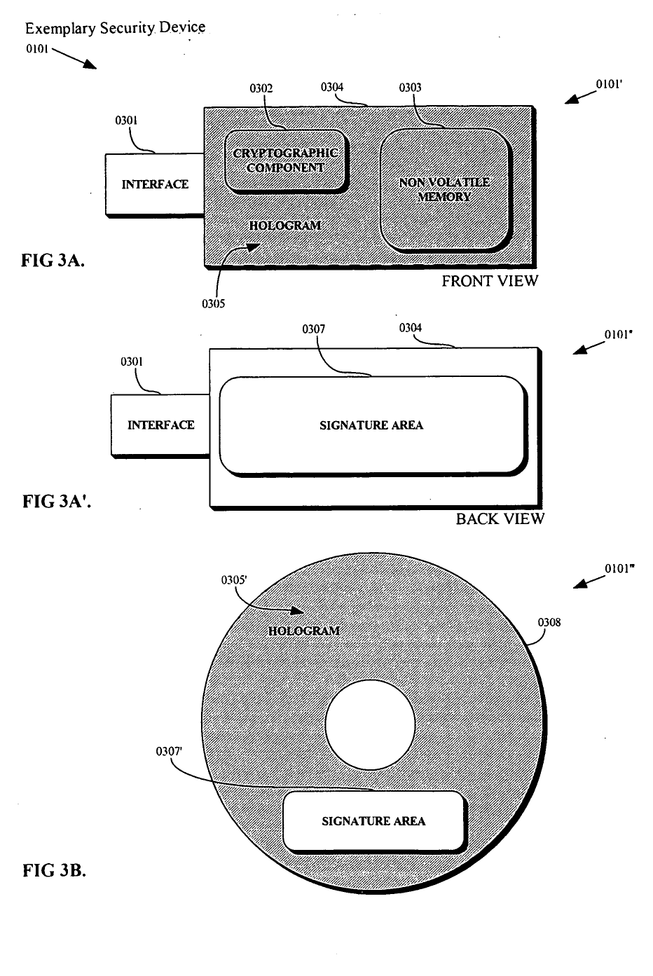

FIGS. 3A and 3A′ are diagrams illustrating the physical level hardware architecture of an exemplary embodiment of the invention as a portable tamper-resistant security device 0101 that is designed to be used in conjunction with a computer 0102. This may involve physically connecting the interface 0301 of the security device 0101 to a compatible device interface port 0207 on the computer 0102.

The type of interface 0301, can include, for example, a USB, FireWire, PCMCIA or SDIO interface, another type of interface, or even a plural combination of interfaces.

To work in conjunction with any specific computer 0102, a security device 0101 may provide at least one interface 0301 that is compatible with the corresponding computer device interfaces 0207. It is preferable if the computer's BIOS 0206 supports bootstrapping an operating system directly from the security device's interface type, otherwise a separate bootstrapping element (e.g., boot floppy or boot CD) may be required.

For example, a user could use an exemplary security device 0101 equipped with a USB interface 0301 by connecting it to a USB port at the interface 0207 of the computer 0102 with a BIOS that supports booting from USB devices.

Note, that providing a plurality of interfaces would increase the range of computer 0102 hardware any specific embodiment of the security device 0101 is compatible with, though a device with multiple interfaces would likely be physically larger and also more expensive to manufacture. An alternative approach to achieving compatibility would be to produce multiple embodiments of the security device 0101 each with a different type of interface 0301 and supply users with a security device 0101 with an interface 0301 that is compatible at least with their primary computer.

Also, as is well known in the art, interface types vary in properties such as the speed at which a device can communicate with the computer it is interfacing with.

In order to provide optimal performance it is preferable to use a security device 0101 with an interface 0301 that is best suited to provide maximal communication bandwidth and the lowest latency with the specific computer 0102 the security device 0101 is intended to be used in conjunction with, assuming the computer 0102 includes a corresponding compatible device interface 0207 which its BIOS 0206 supports bootstrapping the operating system from.

FIG. 3A shows a semi-translucent front view of the security device.

The front view of the physical casing 0304 of the exemplary security device 0101 is shown to include a hologram 0305, the purpose of which is to provide a visual mark of the security device's 0101 authenticity, increasing how difficult it is for an attacker to convincingly forge the security device.

Security will obviously be compromised if an attacker manages to physically replace the security device with a seemingly identical functionally equivalent device that includes a backdoor or trojan horse.

For example, an attacker might attempt to realize this threat by physically intercepting a shipment of devices in transit to users and replacing the devices. Or by somehow stealing and covertly replacing a security device that is already in the possession of a user, and so forth.

A hologram is suggested because creating and embedding it on the device may require specialized knowledge and access to manufacturing equipment that increases the cost of forging an authentic looking security device such that it may be beyond the means of a range of potential attackers, or not worth the trouble.

It should be noted that other means for providing a visual mark of authenticity may substitute for the hologram 0305 shown in FIG. 3A. Alternative techniques for embedding a special visual property on the physical casing 0304 that is similarly difficult or expensive to manufacture may provide an equivalent or even superior level of protection against forgery.

The signature area 0307, an additional countermeasure to mitigate the threat of forgery is shown in FIG. 3A′, which illustrates an opaque back view of the security device 0101. The signature area is a blank appropriately marked space that the users may be instructed to sign when they receive the security device 0101. Assuming the user can identify an attempted forgery of his own signature, signing the signature area 0307 will further increase how difficult it is for an attacker to forge the security device 0101.

The physical casing 0304 of the security device 0101 provides resistance to tampering, using techniques that are well known in the art. Tamper resistant casing may increase how difficult it is for an attacker that has achieved physical access to the security device 0101 to covertly alter it in a way that may compromise the security of an unsuspecting user. Tampering with a tamper resistant physical casing 0304 may function to, for example, trigger the destruction of private keys stored in the cryptographic component 0302, permanently disable the security device 0101, and invoke other effects which are intended to frustrate an attacker's attempts to violate security by tampering with the security device 0101.

Referring back to FIG. 3A, the security device 0101 is shown to include non volatile memory 0303 which may be used to persistently store the independent secure operating system environment the computer 0102 will boot into.

Due to security considerations, it is preferred that the non volatile memory 0303 is a physically read-only memory type (for example, a ROM chip). This provides better security as it is physically impossible to remotely tamper with the integrity of the software in a read-only memory regardless of the sophistication and resources available to a potential attacker. This ensures the initial logical integrity of the computer 0102 after it has been booted from the security device 0101, but not the integrity of the computer system during runtime, which still relies on the software security mechanisms to protect it from highly sophisticated attacks that could still theoretically compromise integrity, even if only temporarily, by carefully subverting the parts of the operating system loaded into a running computer's 0102 main memory (RAM) 0204.

A readily apparent though less secure alternative to a read only memory (ROM), is a non-volatile random access memory (RAM) such as flash chip. Though a RAM provides relatively less security than a ROM, it may be more suited for some lower risk applications that are willing to trade off security for increased flexibility that a modifiable memory allows.

Referring again back to FIG. 3A, the security device 0101 is shown to include a hardware cryptographic component 0302.

In one embodiment, the cryptographic component 0302 may function to provide a range of public key cryptographic services including secure generation and storage of private keys, public-key decryption and public-key encryption operations.

Due to security considerations, it may be preferable to use a type of cryptographic component 0302 that is designed to resist tampering. This may increase, for example, how difficult it is for an attacker that has achieved physical access to the security device 0101 (e.g., by stealing it) to retrieve the private cryptographic keys that are stored inside it. Note, that techniques for achieving tamper resistance in cryptographic hardware are well known in the art.

Public key cryptography and the utility and advantages of cryptographic hardware that may be used to facilitate it are also well known in the art.

There are significant advantages in integrating a cryptographic component 0302 into the security device 0101, both in terms of security and ease of use.

Note, that it is possible to embed the cryptographic component such that it is detachable from the security device 0101, the way a SIM card can be removed from a GSM cellular telephone and transferred into another, for example. This is one way to allow the private identity keys associated with an old or broken security device to be easily transferred into a new, improved security device. This may make it less expensive and more convenient to upgrade security devices. On the other hand, how this impacts security must be carefully considered, in the context of a specific application, as allowing transfer of the cryptographic component between devices may weaken security by providing additional opportunities for attack.

A cryptographic component may be used as an authentication mechanism that supplements or replaces the most popular authentication mechanism, the password. There are several motivations for decreasing the use and dependence on passwords.

A significant part of security is dependent on access control. Access control mechanisms control who can access what, based on a set of rules. However in order to determine if someone is authorized to access a specific resource (e.g., a file, a bank account, a medical record), it is first necessary to establish his identity. Authentication is the process of establishing identity, and its strength is measured by how difficult it is for an unauthorized attacker to pass for an authorized user.

From the perspective of the user, there are three basic principles for establishing identity: something you know (a secret, a password), something you have (a token, a smartcard), something you are (a voice, a fingerprint, an iris).

An authentication process may combine several factors based on these principles, to achieve a higher level of security. This is called N-factor authentication. Two out of three, or 2-factor authentication is considered secure enough for most applications.

Passwords are something you know. Once an attacker discovers the secret password, the attacker knows what you know. If an authentication process only depends on a password, the attacker will be able to use the password to assume the identity of the user, and gain unauthorized access.

Passwords (something you know) are considered inherently weaker than authentication tokens (something you have) or biometrics (something you are) because it is possible for an attacker to covertly intercept a secret password in a way that will not provide indication to the user that security has been compromised. For example, an attacker that compromises the security of a computer being used for online banking, could remotely install a trojan horse that covertly intercepts a user's online banking credentials. An attacker that manages to gain physical access to a computer could intercept passwords by connecting a hardware keylogger. A pinhole camera could similarly be positioned to achieve the same effect. A co-employee might learn the password by simply observing the keyboard (“shoulder surfing”) when it is being entered. And so forth.

Additionally, many users find it difficult to remember passwords, so when given a choice they will tend to choose very simple passwords, use the same passwords for nearly everything, or both.

This makes the problem worse, as it makes it easier for an attacker to guess the password. Also, in some conditions, automated password guessing software may be used that allows an attacker, for example, to try all the words in a dictionary (password dictionary-attack), or even all possible combinations of passwords (password bruteforce).

Forcing users to use complicated passwords that are harder to remember but also harder for an attacker to guess can, under some conditions, backfire and make it even easier for an attacker to intercept a password. This can happen, for example, because users might make it easier for themselves to remember a complicated password by using it everywhere, which would offer the attacker more opportunities to intercept it, or by writing the password down on a sticky note attached to their monitor or under the keyboard.

Once a password has been intercepted, an attacker can use it to gain unauthorized access until the password is changed.

Thus, depending only on a password for authentication may significantly lower the minimum cost of attack for an otherwise secure system.

In contrast, stealing a physical item such as a cryptographic authentication token (something you have) is usually more difficult than intercepting a password and will not go unnoticed, allowing the association between the token and the identity of an authorized user to be revoked.

In effect, embedding the cryptographic component 0302 integrates the capabilities of a traditional cryptographic authentication token (or smartcard) into the security device 0101, which may significantly increase the security and convenience of one embodiment of the present invention.

In one embodiment, embedding the cryptographic component 0302 may additionally allow the security device 0101 to provide the same functionality in the same usage contexts as traditional cryptographic authentication tokens like, for example, the RSA USB authenticator made by RSA Security, or the eToken USB token made by Aladdin Knowledge Systems. In this context, it may be preferable to design the security device 0101 to allow conformance, in part or in full, to standards such as Cryptoki (PKCS 11), or ISO 7816. Supporting standard authentication token interface protocols may promote interoperability by allowing a variety of other devices (e.g., a physical perimeter gateway, a Windows PC) to more easily interface with the cryptographic functions of the security device 0101. Allowing the security device 0101 to double as a traditional authentication token may reduce costs and increase convenience by eliminating the need to purchase and carry around a separate device for authentication. This may have otherwise been necessary for users that need, for example, to authenticate access to physical facilities.

Similarly, for some applications, where costs and circumstances allow it, it may provide further advantage to embed a biometrical sensor (not shown in the drawings) into an embodiment of the security device 0101.

A biometrical sensor may be, for example, a fingerprint reader (such as those made by UPEK), an iris scanner, or any other means for measuring unique biological metrics (something you are).

Integrating both a biometrical sensor and a cryptographic component into the security device would allow the security device 0101 to support 2-factor authentication (something you have, something you are) without requiring the user to create, remember and input a secure password. This may be more convenient for the user, while still providing sufficient security.

In practice, the security and convenience provided by any combination of authentication means depends on the quality of components. For example, a biometrical sensor may suffer from poor reliability that will result in false positives and or false negatives, impacting the security and ease-of-use, respectively, of a security device 0101 that embeds it.

While those skilled in the art may consider it obvious, it may be helpful to note, for the sake of completeness, that the security device 0101 embodiment of FIG. 3A may naturally include means for communication amongst its components (i.e., cryptographic component 0302, non volatile memory 0303, interface 0301). Such means may be comparable in principle to the computer BUS 0209.

FIG. 3B is a diagram illustrating a simpler, alternative embodiment of the security device 0101 as a tamper-resistant storage media 0308, that is compatible with the media read/write interfaces 0210 of a computer 0102.

For the media embodiment of the security device 0101′″ to work in conjunction with any specific computer 0102, it is preferable for the BIOS 0206 to support booting from that type of media, otherwise a separate bootloader element (e.g., boot floppy or boot CD) may be required. Nearly all contemporary BIOS 0206 support booting from CDROM optical storage media at the very least.

Note, that the hologram 0305′ and signature area 0307′ elements of FIG. 3B satisfy the same objectives as the corresponding hologram 0305 and signature area 0307 elements of FIGS. 3A and 3A′.

The type of storage media 0308 may include, for example, a CDROM, DVD, HD-DVD, Blu-ray or other type of optical storage media disc, a SuperDisk floppy drive, an IOMega ZIP drive, or other type of magnetic storage media, a Sony memory stick, Secure Digital (SD) memory card, MMC, SmartMedia, XD or other type of solid state memory media.

Media types mostly differ in cost, physical size, capacity, performance and most importantly compatibility with any specific computer's 0102 media read/write interfaces 0210. These differences may influence how well suited any specific security device 0101 media type is for use in conjunction with any specific computer 0102 relative to a specific application.

Note, that it is possible to shape some types of optical media into a smaller physical form. For example, a CDROM may be shaped into roughly the size of a business card. While such miniature discs may be more convenient to carry around they provide less storage capacity. Whether or not this tradeoff is desirable depends on the amount of storage capacity required to contain the software of a specific embodiment of the security device 0101′″.

As previously explained in reference to the non volatile memory 0303 of FIG. 3A, there are security advantages to using a physically read-only media type 0308.

Comparing the security device embodiments of FIG. 3A and FIG. 3B

Advantages of FIG. 3B exemplary security device embodiment

The exemplary embodiment of the security device 0101′″ as storage media 0308 shown in FIG. 3B may generally be simpler and significantly less expensive to produce because the security device 0101 of FIG. 3A has more parts, which may also be more expensive to produce than storage media which benefits from larger economies of scale.

From the perspective of consumers, this will influence the initial cost of the security device 0101, as well as the cost of future upgrades, should they be required.

Compared to a security device 0101 with an integrated cryptographic component 0302 with which identity may be associated, an upgrade of the storage media embodiment of the security device 0101′″ would be easier to support as identity would not usually be associated with a mass-produced storage media embodiment of the security device 0101′″.

Note, that associating identity with a storage media embodiment is possible, by storing encrypted private keys on the storage media itself, but it would be much easier for an attacker to extract the secret private keys from storage media 0308, compared to a suitably protected cryptographic component 0302.

Alternatively, a separate cryptographic token (not shown) may be used in conjunction with the storage media embodiment to benefit from security advantages similar to those provided by the integrated cryptographic component 0302 in the security device 0101 of FIG. 3A. In this arrangement, the storage media 0308 may be easily replaced or upgraded without having to update the association between private keys and a user's identity.

A separate cryptographic token may be, for example, an RSA USB authenticator or RSA Smart Card made by RSA Security, or an eToken smartcard or USB token made by Aladdin Knowledge Systems.

A separate cryptographic token may be used to achieve a similar effect with a variation of the security device 0101 embodiment of FIG. 3A that does not include an integrated cryptographic component 0302, assuming the computer 0102 has sufficient device interface slots 0207 to accommodate both devices along with the required peripherals.

On the other hand, it may be significantly less convenient for some users to have to carry around two items to use the security device rather than just one.

Some computers may lack of support in the BIOS 0206 for bootstrapping the operating system from peripherals attached to any of its available device interfaces 0207. In this case, the security device 0101 embodiment of FIG. 3A may not work in conjunction with this specific computer, while an embodiment of the security device 0101 as storage media 0308 may still be used, assuming the computer supports booting from this type of storage media. In practice, it is more common for computers, especially older computers, to support booting from storage media such as a CDROM, than a device peripheral such as a USB device.

Alternatively, it is possible to work around an old incompatible BIOS 0206 by using separate appropriately configured storage media (e.g., a boot floppy or boot CDROM) of a type which even an old BIOS supports booting an operating system from. In this case booting starts from operating system initialization software on the separate storage media, and control is passed to software on the security device 0101 once the necessary drivers have been loaded. This would allow the security device 0101 to be used in conjunction with a wider range of computers, especially older computers. The disadvantage of using a floppy boot disk, for example, is that reading a floppy is prohibitively slow, and floppy disks tends to be unreliable, because it is based on an earlier generation of technology. Booting from optical storage media (e.g., CDROM), a newer, faster, more reliable media type, is thus preferred when possible. From the user's perspective, it may be an inconvenience that the security device 0101 requires an additional item (e.g., the floppy disk or boot CD) to work.

To summarize, the primary advantages of the FIG. 3B storage media embodiment of the security device 0101′″ relative to the security device embodiment of FIG. 3A is that first, it is less expensive to produce, upgrade, and support. Second, it compatible with a wider range of computer BIOS 0206 types, especially those found in older computers.

On the other hand, some disadvantages should be considered as well.

First, passive storage media is inherently less flexible that a hardware device.

For example, it is not possible to embed cryptographic hardware or a biometrical sensor into optical media such as a CDROM. Thus, to achieve N-factor authentication, additional hardware may be required that increases the cost, and significantly decreases convenience by requiring users to either be tied down to one computer or carry around multiple devices.

There are also strict limitations to what physical shapes and sizes can be supported by any specific type of storage media. For example, the hardware embodiment of the security device of FIG. 3A may be shaped such that it can be attached to an everyday item such as a key-chain, a belt, a necklace or other piece of clothing. This would make the security device 0101 easier to carry around, harder to steal, and harder to accidentally misplace. On the other hand, there are fewer possibilities for achieving the same effect with optical storage media such as a CDROM, aside from the small form factor described in more detail above.

It is suspected that optimal convenience and ease to use of the security device 0101 are critically important to the widespread adoption of the present invention, and secure systems in general. It is well known that the average user has little patience for security when it gets in his or her way.

Second, some types of storage media 0308 are more susceptible to physical damage. Optical media discs such as CDROM and DVD media, in particular, require careful handling to prevent scratching.

Damage accumulated during normal daily use of a storage media embodiment of the security device 0101′″ may eventually render the device unusable, in a relatively short time.

Third, running an operating system environment live from a storage media embodiment of the device may occupy the media interface 0210 in a way that prevents the media interface 0210 from being used for other purposes. However, if enough main memory 0204 is available, it is possible to free up the media interface 0210 by loading the required contents of the storage media into main memory 0204 during boot. If possible, loading the system into memory 0204 may also increase system performance (main memory may be accessed significantly faster than storage media) and decrease power consumption (accessing main memory may draw significantly less power than accessing storage media, such as CDROM). The latter may be especially useful for extending battery life on laptops.

4). Exemplary User Interaction

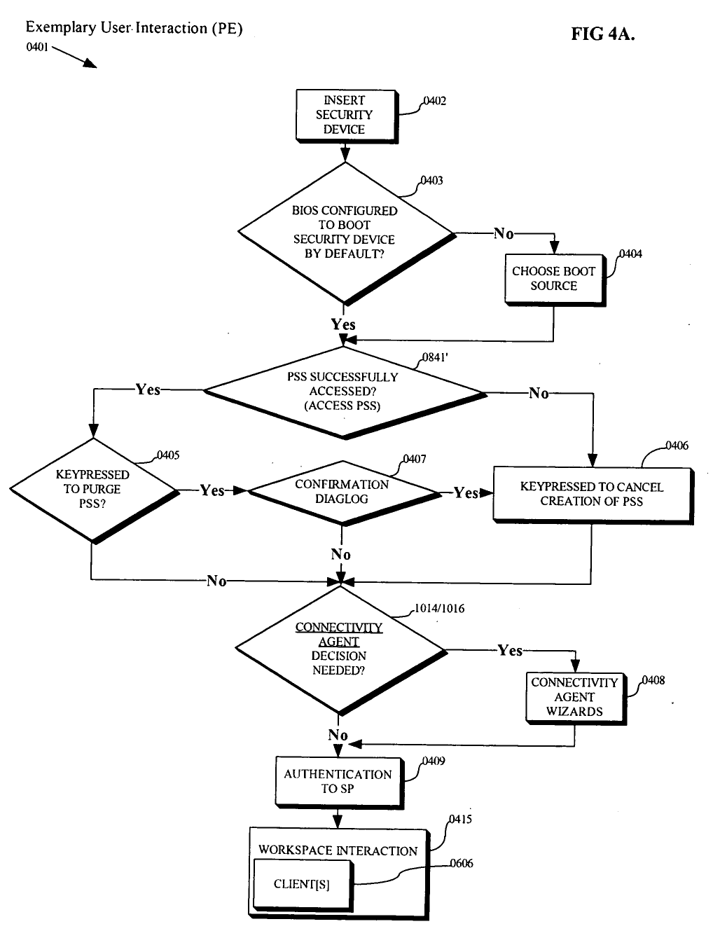

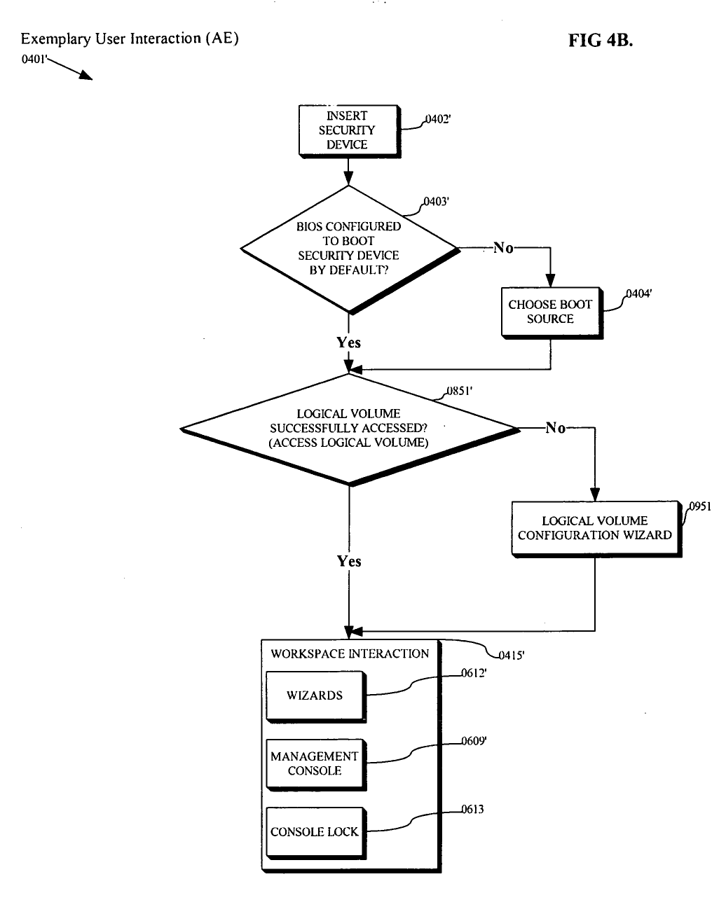

FIG. 4A. is a high-level flow diagram that illustrates exemplary user interaction steps with the preferred embodiment of the invention.

Before describing in detail the structure and operation of the various exemplary aspects of the preferred embodiment of the present invention, it may be helpful to explain how a user may interact with an exemplary embodiment of the invention.

First, the user inserts the security device 0101 into either the computer's 0102 (step 0402) device interfaces 0207 or media r/w interfaces 0210. The security device 0101 embodiment of FIG. 3A may be attached to the device interfaces 0207, while a security device 0101′″ embodiment as storage media, shown in FIG. 3B may be inserted into the media r/w interfaces 0210.

If the computer 0102 BIOS 0206 is not already configured to boot from the security device 0101 (condition 0403), the user may instruct the BIOS 0206 to boot from the security device 0101 (step 0404), assuming the BIOS 0206 supports booting from the type of device interface or media of a specific security device 0101 embodiment.

Each specific BIOS 0206 may provide a different interface by which the user can choose the security device 0101 as a temporary (just for the next session) or default (all sessions) boot source (step 0404).

Once the BIOS 0206 is properly configured, the computer may start booting the secure operating system software contained inside the non-volatile memory 0303 element of the security device embodiment of FIG. 3A, or the storage media security device embodiment of FIG. 3B, as the case may be.

Next, while the secure operating system is booting, the user may influence the boot process (step 0405) and choose to purge the Persistent Safe Storage (PSS), for example, by manually pressing a function key on the keyboard. The user may be notified of this option through the computer's 0102 output devices 0202, for example, by displaying a visual notification message to the screen.

If the user requests to purge the PSS (conditional 0405), for example, by pressing an appropriate function key on the keyboard, a confirmation dialog (step 0407) may function to explain the ramifications of this action and prompt the user for further confirmation, in order to prevent accidental purging.

Similarly, the user may influence the boot process to cancel the creation of the PSS (step 0406) which may otherwise be performed by default the first time the security device 0101 is booted into, or immediately after the PSS is purged.

Note, that the user interaction described above is only required for special circumstances, which will are further described the Exemplary system initialization section.

Later in the boot process, the user may be required to interact with the connectivity agent wizards (step 0408), if the connectivity agent requires the user to make a decision or provide network configuration parameters (condition 1014/1016). It should be noted that by default, the connectivity agent wizards may only interact with the user if the connectivity agent software has failed to configure and establish network connectivity automatically.

At this point, the user might be required, for example, to manually provide the required settings for a dialup or ADSL modem connection, select which wireless network to use, or configure a network's required proxy settings.

Next, after connectivity to the network 0103 has been successfully established, the user may be required to authenticate to the service provider (step 0409). For example, the user may be required to provide a password, interact with a biometrical sensor, and so forth.

It should be noted, that in some embodiments the user may be required to authenticate earlier in the boot process. For example, in one embodiment, the user may be required to provide a password or interact with a biometrical sensor in order to access the PSS.

In some embodiments, the user may be required to authenticate multiple times, early in the boot process and later to a service provider. In another more convenient embodiment, the user may only need to authenticate once, and the secure operating system will communicate and provide proof for this authentication to a service provider 0104 transparently.

Finally, the user may interact securely with a service provider. For example, by using a web browser to interface with a service provider such as an online bank.

Additionally, at this point, in one embodiment of the invention, the secure operating system environment that has been booted from the security device 0101 may provide the user a GUI workspace (step 0415) with enough functionality to allow the user, for example, to conveniently access reference material (e.g., a financial spreadsheet) stored on his computer's 0102 hard drive, optical media disc, USB key-drive, floppy disk, network file share, or company website.

In one embodiment, the user may interact with a migration agent to migrate useful client side application content (e.g., browser bookmarks, email messages) and configuration data (e.g., email configuration, instant messaging and VoIP accounts) from the files of the local operating system environment installed to the computer's 0102 internal storage devices 0208.

The migration agent may either be launched automatically during system initialization, or manually by the user (e.g., through a GUI menu item, desktop icon or management console).

5). Exemplary Outer Filesystem

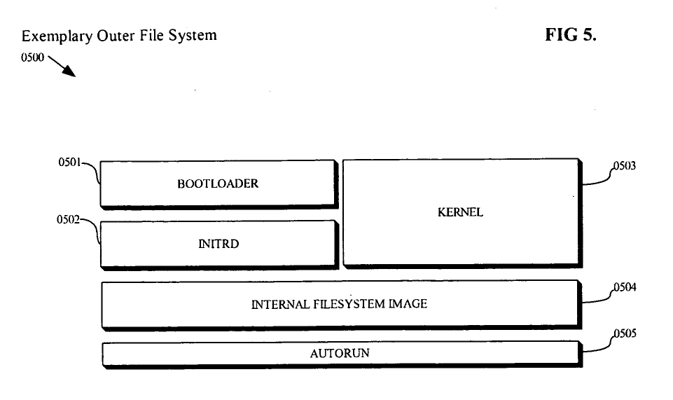

FIG. 5—is a diagram illustrating an exemplary outer filesystem that is stored inside variations of the security device shown in FIG. 3A, 3B.

The outer filesystem may be stored inside the non volatile memory 0303 element of the security device variation shown in FIG. 3A, or written to the storage media 0308 for the security device variation shown in FIG. 3B.

The type of the outer filesystem 0500 may be, for example, an ISO9660 (CDROM filesystem), ext2, ext3, reiserfs, vfat, NTFS, or other type of filesystem. For security device variations as CDROM optical storage media, the preferred filesystem type may be the ISO9660 CDROM filesystem standard.

As shown in FIG. 5, the contents of the outer filesystem 0500, may include, for example, a bootloader 0501, an operating system kernel 0503, initrd 0502, internal filesystem image 0504, and autorun element 0505.

When the computer 0102 is booted, the bootloader 0501 may be used to pass control from the computer's 0102 BIOS 0206 to the kernel 0503. The type of bootloader may be, for example, an isolinux bootloader compatible with ISO9660 filesystems, an extlinux bootloader compatible with ext2/3 filesystems, a syslinux bootloader compatible with multiple types of filesystems, a grub bootloader also compatible with multiple types of filesystems, or another type of bootloader.

The kernel 0503 may include security mechanisms for supporting a multi layered security architecture, including for example, Mandatory Access Control (MAC), Role Based Access Control (RBAC), Trusted Path Execution (TPE), memory protections, exploit countermeasures, Virtual Private Network (VPN) driver, or other security mechanisms.

The operating system kernel 0503 may be, for example, a Linux kernel to which the grsecurity patch has been applied, a Linux kernel to which the NSA SELinux and PAX patches have been applied, a Linux kernel to which the RSBAC patch and PAX patches have been applied, a Linux kernel to which the openwall hardening patches have been applied. Other examples of a suitable operating system kernel 0503 may include, for example, a trusted Solaris kernel, a trusted HP-UX kernel, or another type of kernel including security mechanisms for supporting a multi layered security architecture.

The initrd 0502 is an image of a RAM disk containing initialization scripts and a basic set of drivers, which may be initialized by the bootloader 0501 before the kernel 0503 is started, for a two phased system boot-up mechanism that is supported by some types of operating system kernel (e.g., Linux).

In the first boot-up phase, the kernel 0503 starts up and mounts an initial root filesystem from the contents of the initrd 0502 RAM disk initialized by the bootloader. In the second phase, the kernel 0503 calls a userland initialization program (e.g., /linuxrc) on the initial root filesystem, which may load the necessary drivers and probe devices, in order to mount the internal filesystem image 0504 as the new root filesystem, and continue the boot process.

Other types of kernel 0503 may use different bootstrapping techniques to achieve similar results.

The internal filesystem image 0504 is a usually large compressed file, which may occupy most of the space inside the outer filesystem 0500.

The internal filesystem image 0504 may contain additional drivers, system software, application software, configuration files, and data, which together may comprise the bulk of the functional components for the secure prefabricated computer system provided by one embodiment of the present invention. The contents of the internal filesystem are described in further detail in the Exemplary functional overview section.

The internal filesystem may be of any type that is supported by the kernel 0503, including, for example, ISO9660, ext2, ext3, reiserfs, vfat, NTFS, or other type of filesystem. A filesystem optimized for reduced overhead such as cramfs, for example, may be preferred. The internal filesystem image 0504 may be compressed to make optimal use of the limited storage capacity of the non volatile memory 0303 or storage media 0308 of the security device 0101.

The autorun element 0505 may include software and special configuration files, which may be used by the security device 0101 to instruct some types of mainstream operating systems, such as Microsoft Windows, to automatically run user assistance software contained on the outer filesystem 0500 by conforming to that operating system's specific autorun protocols.

The autorun element 0505 may be used, for example, to run smart reboot software that instructs the computer's local operating system to preserve the state of running applications (i.e., hibernation mode) before rebooting the computer 0102 from the security device 0101. This may provide increased convenience by allowing the user to switch from the local operating system installed on his computer's internal storage devices to the independent secure operating system environment provided by the security device 0101 and back, without having to go the trouble of closing and later reopening all of his running applications.

The autorun element 0505 may also be used, for example, to present a user manual for the security device 0101, help the user reconfigure his computer's 0102 BIOS 0206, create boot disks (e.g., boot floppy, boot CD), start a web browser with online support, or run any other useful software on the user's computer prior to actually booting into the security device 0101.

It should be noted, that the autorun element 0505 may execute in an insecure operating system environment that may already be compromised by an attacker, and as such, can not be fully trusted. For example, an attacker that has compromised the security of the user's Windows PC may install special software that is designed to specifically subvert any of the functions performed by the autorun element. A specific embodiment that depends on the autorun element to reboot the user's computer 0102 may be vulnerable to a sophisticated attack in which the special software installed by the attacker identifies that the security device 0101 has been inserted into the computer (while it is still running Windows, for example) and instead of rebooting into the security device, the attacker will reconfigure the system to reboot into a simulation of the security device, which may include specially crafted malicious software that can compromise the user's security by fulfilling the objectives of the attacker.

Consequently, for very high risk applications, it may be preferable not to include the autorun element at all, while for other applications, it may be preferable to at least minimize dependency on the autorun element in order to correspondingly minimize potential avenues for sophisticated attack.

6). Exemplary Functional Overview

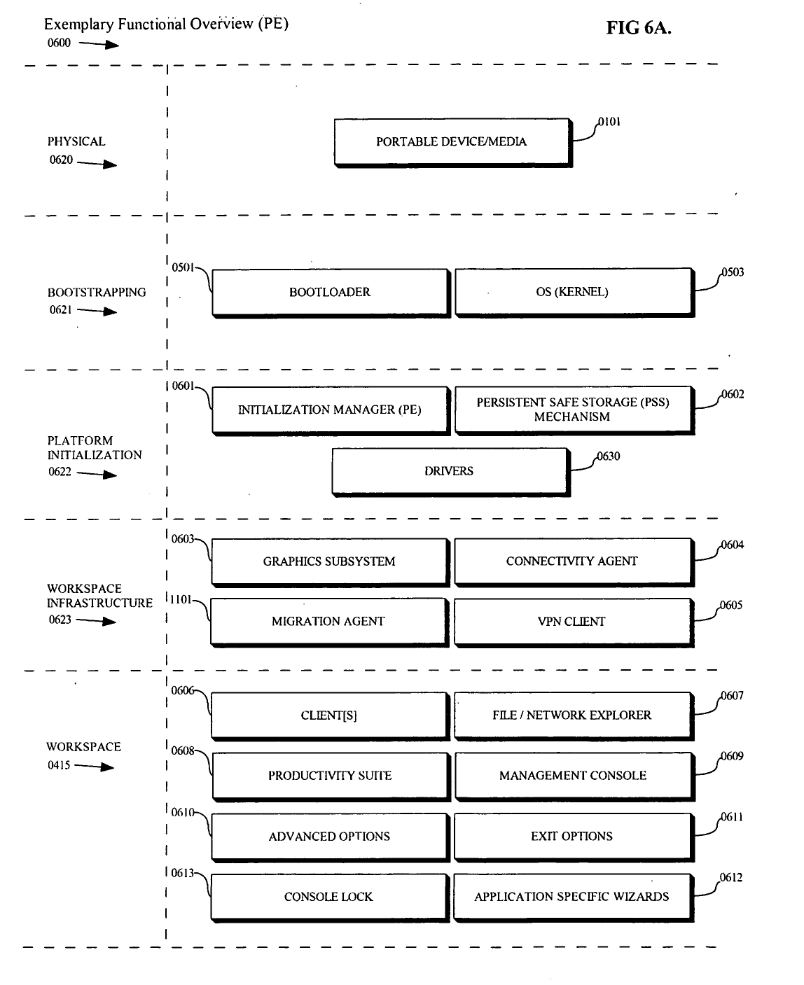

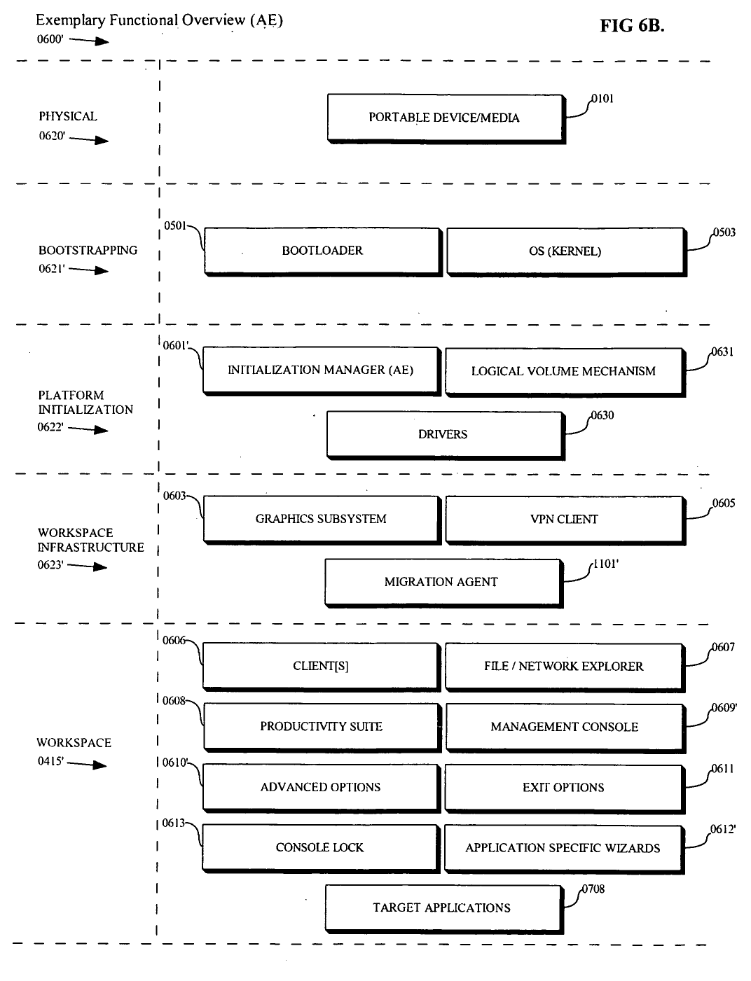

FIG. 6A is a diagram illustrating an exemplary multi-level functional overview for the preferred embodiment of the invention.

At the top physical level, the invention may be embodied as a security device 0101 that includes software elements for performing functions at the bootstrapping 0621, platform initialization 0622, workspace infrastructure 0623 and workspace levels 0415. Together these functions may provide a task-specific prefabricated computer system that is easy to use, yet secure enough even for high risk applications.

Exemplary physical embodiments of the security device 0101 have been previously described above in the Exemplary physical embodiments of the security device section with reference to FIGS. 3A, 3A′ and 3B.

Exemplary bootstrapping level 0621 elements, the bootloader 0501 and operating system kernel 0503 have been previously introduced in the Exemplary outer filesystem section above with reference to FIG. 5.

Other exemplary elements, at the platform initialization 0622, workspace infrastructure 0623 and workspace 0415 levels may be contained inside the internal filesystem image 0504 similarly introduced above in the same section.

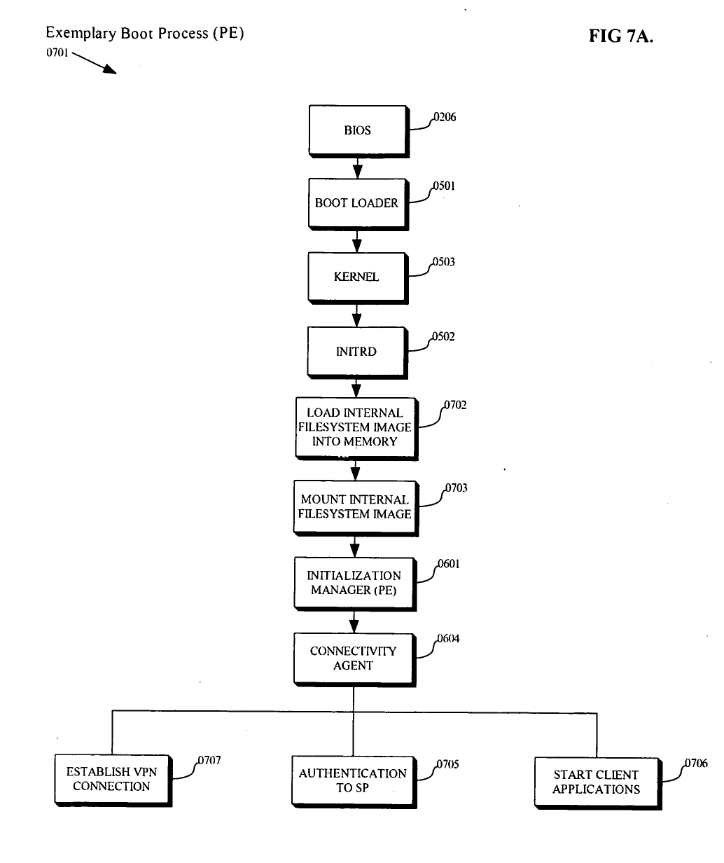

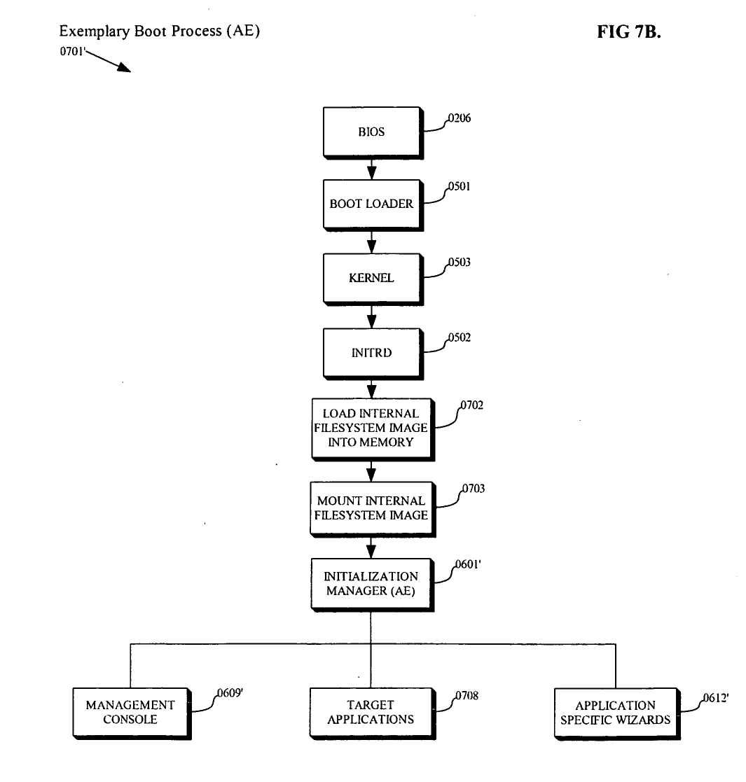

Exemplary platform initialization elements 0622, may include, for example, an Initialization Manager 0601, a Persistent Safe Storage mechanism 0602 and drivers 0630. Exemplary platform initialization for the preferred embodiment is further described in the Exemplary system initialization section with reference to FIGS. 7A, 8A, 9A-I and 9A-II.

Control of the boot process may eventually be passed to the initialization manager 0601, which may function to, for example, optimize the boot process, determine hardware configuration parameters, load drivers, cache the detected hardware profile, load system services, maintain a record of initialized system state, or perform other initialization operations.

In one embodiment, drivers 0630 may be modular operating system components, which support a wide variety of modular kernel-level operating system functionality such as, for example, hardware abstractions, filesystems, security mechanisms, network protocol stacks, and so forth.

It would usually be considered inefficient to integrate the functionality for supporting a wide range of hardware peripherals within the main kernel 0503 when it is likely only a small portion of this functionality will be required for any given computer 0102. Using drivers 0630, it is possible for a wide range of kernel-level functionality to be loaded on demand, saving valuable computer resources such as memory.

Workspace infrastructure level 0623 elements may provide the necessary support for establishing a context in which the user interface workspace level 0415 elements may operate.

Exemplary workspace infrastructure elements 0623 may include, for example, a graphics subsystem 0603, connectivity agent 0604, VPN client 0605, migration agent 1101, and other elements that assist in establishing the operational context for the workspace 0415.

The graphics subsystem 0603 may function to, for example, provide a higher level interface to a computer's 0102 output devices 0202 hardware, thus creating a shared context in which other programs can provide a Graphical User Interface (GUI).

The graphics subsystem 0603 may include, for example, an Xorg graphics server, XFree86 graphics server, kdrive graphics server, framebuffer based graphics server, or other type of graphics subsystem.

The graphics subsystem 0603 may further include, for example, window/desktop management software such as KDE, GNOME, XFCE, Enlightenment, Fluxbox, or other window/desktop management software.

The VPN client 0605 may be used, for example, to establish a secure connection to a Virtual Private Network (VPN) through another network 0103 such as the PSTN, an Intranet, the Internet, or other type of network or combination of networks. First, this is useful because a VPN connection may be the only way to interface with some security sensitive networks from the outside. Second, a Virtual Private Network may be used to provide an additional layer of security by logically isolating the computer systems in the virtual private network from the range of threats on a potentially hostile public network.

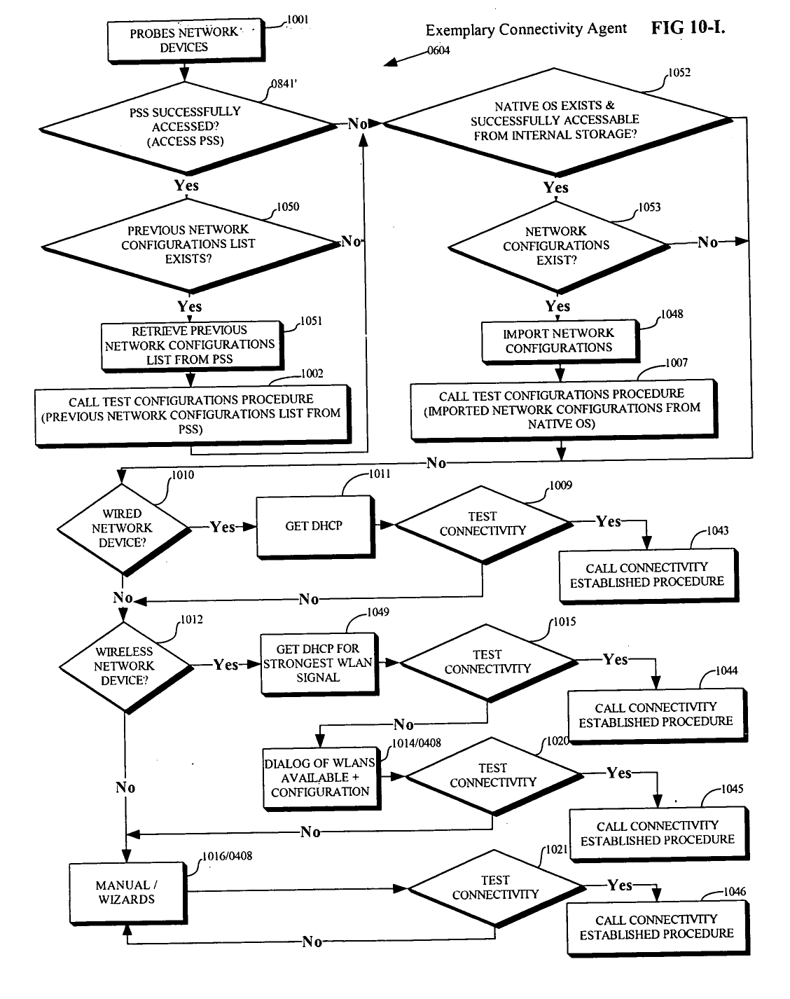

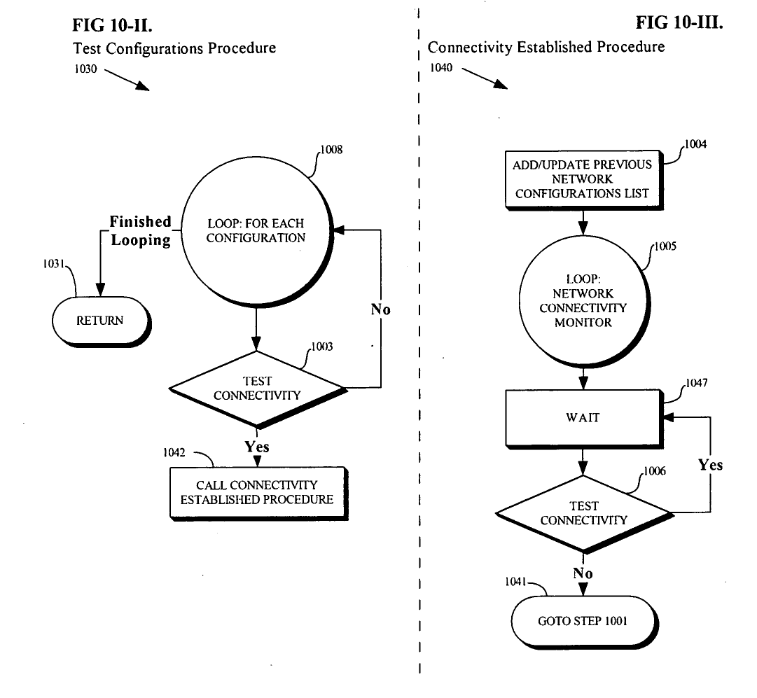

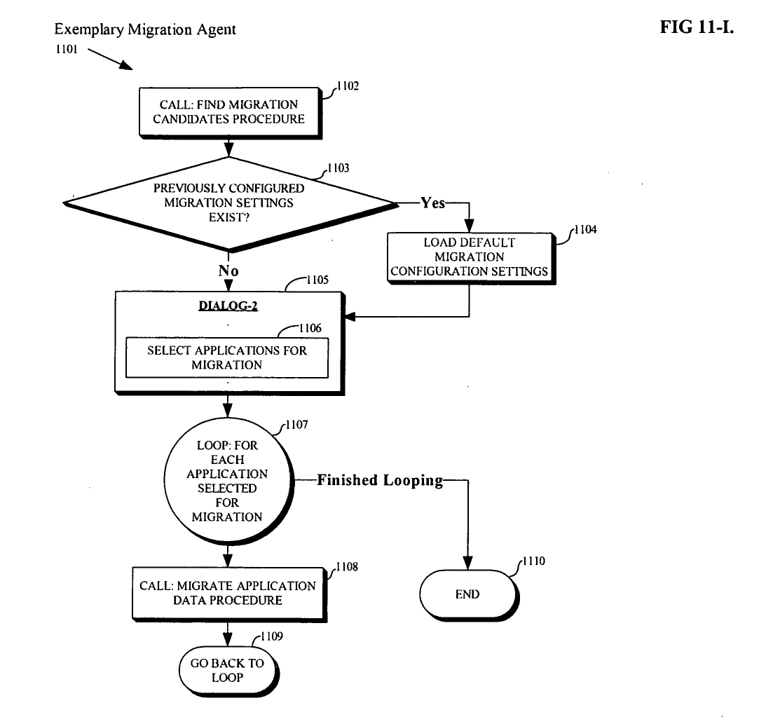

The connectivity agent 0604, which may be used to assist users in establishing network connectivity across a variety of circumstances, is further described in the Exemplary connectivity agent section below with reference to FIGS. 10-I, 10-II and 10-III.

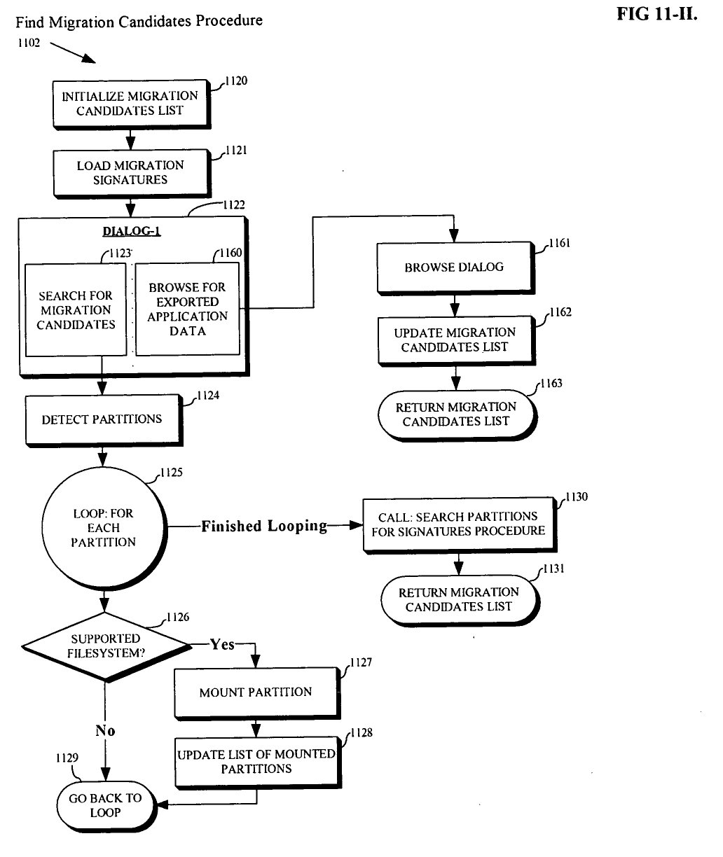

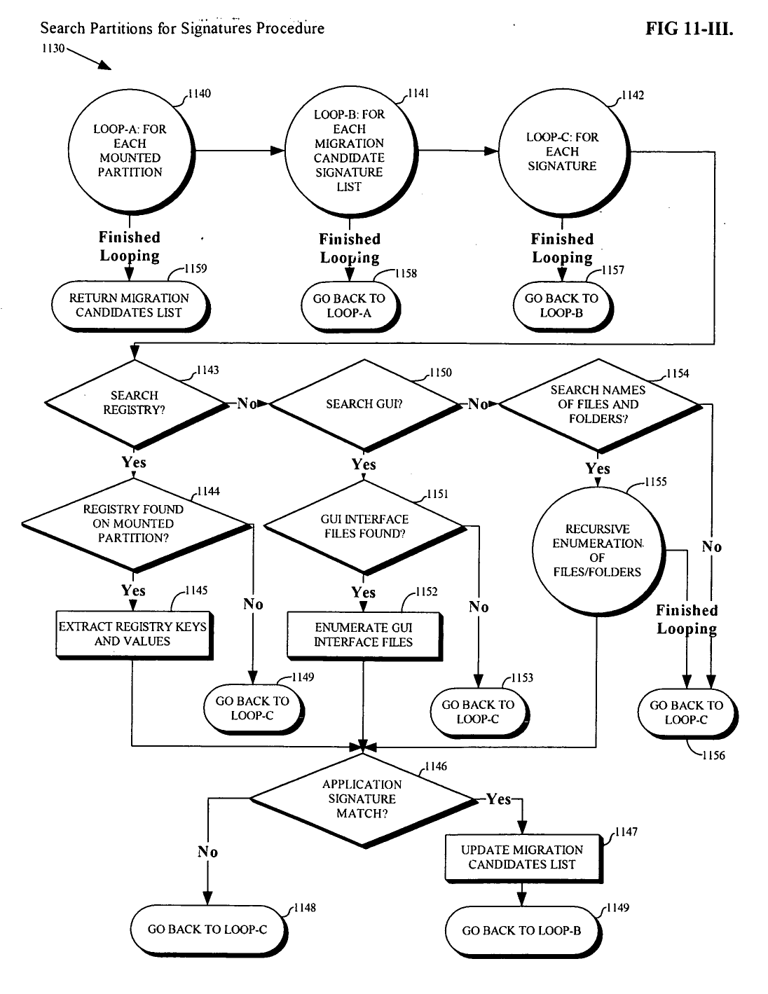

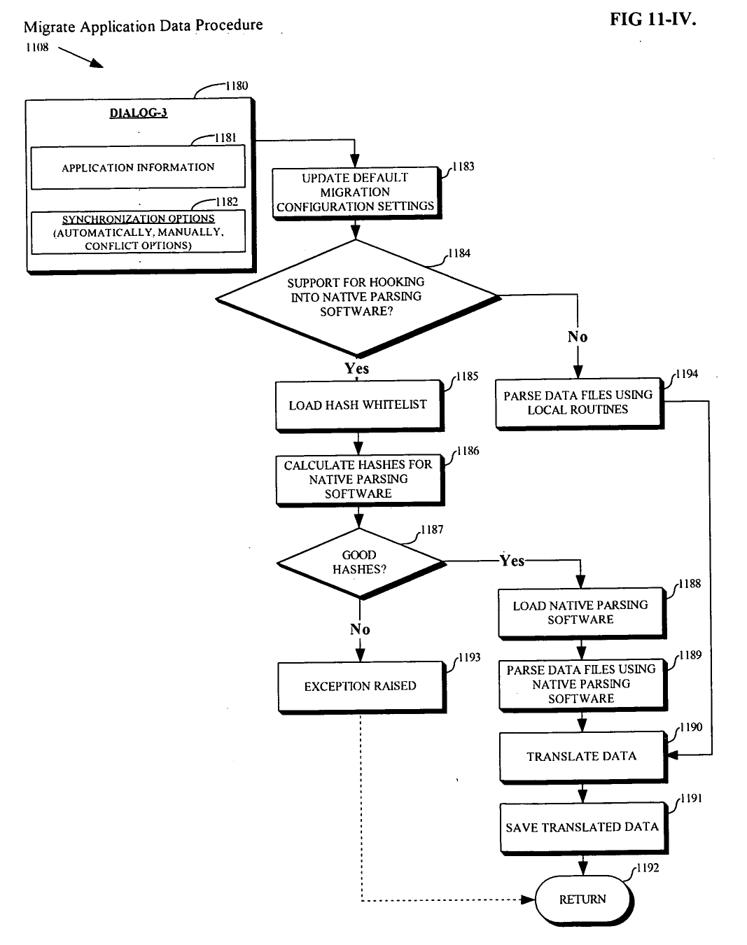

The migration agent 1101, which may be used to assist users in migrating useful application content and configuration data from, for example, the files of the local operating system environment installed to the computer's 0102 internal storage devices, is further described in the Exemplary migration agent section below with reference to FIGS. 11-I, 11-II, 11-III and 11-IV.

The user interacts primarily with the workspace 0415 level elements, which may provide the functionality required to perform the specific tasks a specific embodiment is optimized for.

Exemplary workspace elements 0415 may include, for example, client applications 0606, file/network explorer 0607, productivity suite 0608, management console 0609, advanced options 0610, exit options 0611, console lock 0613 and various wizards 0612.

Client applications 0606 may include, for example, a web browser such as Mozilla Firefox or Opera, thin terminal client such as rdesktop, email client such as thunderbird or evolution, ssh client such as OpenSSH, or another type of client for any standard or proprietary type of service.

The file/network explorer 0607 may provide means for allowing the user, for example, to conveniently access reference material (e.g., a financial spreadsheet) stored on the computer's 0102 hard drive 0208, optical media disc, USB keydrive, floppy disk, network file share, website or other sources of data.

File/network explorer 0607 may include, for example, KDE's Konqueror, GNOME's nautilus, Midnight Commander, a web browser, or other types of file and network explorers.

The productivity suite 0608 may include, for example, software such as OpenOffice or AbiWord that is capable of reading and writing file formats for files that the user may access through the file/network explorer 0607. For some applications, it may be preferable to include a productivity suite 0608 such as OpenOffice that is somewhat compatible with popular file formats such as those created by the Microsoft Office productivity suite (e.g., Word, Excel, PowerPoint).

For some applications, it may be preferable to include management consoles 0609 (e.g., webmin) that can be used to configure the settings of system services such as, for example, remote desktop sharing, an SSH daemon, or network file sharing.

It should be noted however, that it is preferable to minimize the services offered and correspondingly reduce complexity for embodiments optimized for very high risk applications.

In one embodiment, an advanced options 0610 element, may be used by a more advanced or expert user, for example, to configure advanced settings, which are normally set to reasonable defaults. For some applications, it is preferable to conceal or separate such advanced options 0610 in order to avoid confusing the average non-technical user.

In one embodiment, the user may power off, suspend, reboot or otherwise end a secure session using the exit options 0611.

In one embodiment, the user may lock the session using the console lock 0613 element. The user may lock the session, for example, by selecting a GUI option (menu item, icon, etc.) or disconnecting the security device 0101 from the computer 0102. This may be useful in allowing the user to leave the computer 0102 unattended while, for example, participating in a meeting, or going out to a lunch break.

In one embodiment, wizards 0612 may assist the user in setup, and configuration of the system, especially immediately after the user boots into it for the first time. Some users prefer wizards 0612, which present a series of dialogs each including just a few related configuration options and the relevant explanations to be significantly less intimidating than having to configure all of the options at once.

7). Exemplary System Initialization

FIG. 7A is a high-level flow diagram that illustrates exemplary steps in the boot process 0701 for the preferred embodiment of the invention.

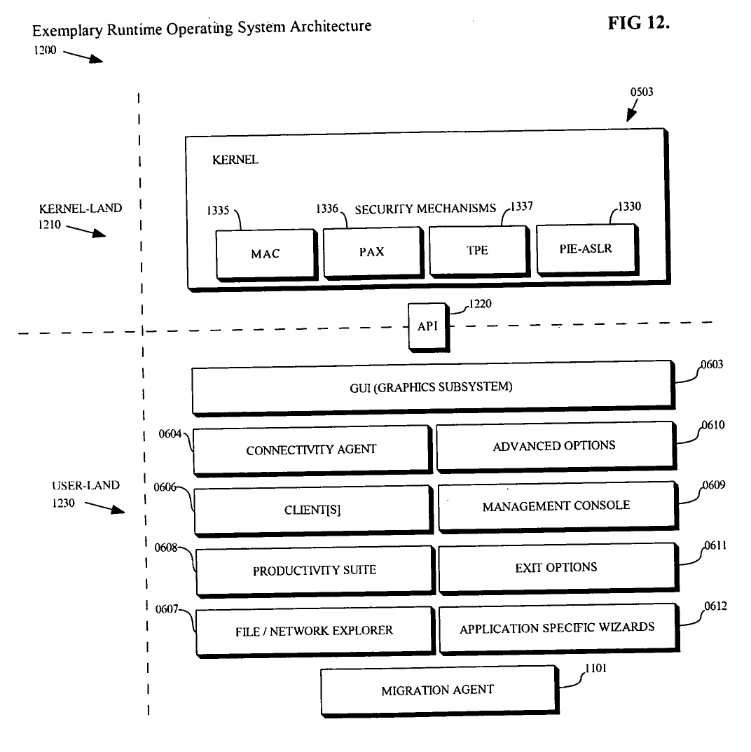

The result of the exemplary boot process 0701 illustrated in FIG. 7A is a running operating system environment further described in the Exemplary runtime OS architecture section below, with reference to FIG. 12.

Throughout the exemplary boot process 0701, the user may interact with the preferred embodiment as previously described above in the Exemplary user interaction section, with reference to FIG. 4A.

The context for the exemplary boot process 0701 steps described in the following, and the elements involved, have been previously introduced in the sections above.

Immediately after a computer 0102 is turned on or rebooted, the processor 0205 is controlled by special software in the BIOS 0206, which functions to perform basic initialization of hardware in preparation for bootstrapping an OS operating system.

First, the BIOS 0206, which has been instructed by the user to boot from the security device 0101, may pass control to a bootloader 0501.

Next, the bootloader passes control to the OS kernel 0503.

In one embodiment, the kernel 0503 starts up and mounts an initial root filesystem from the contents of the initrd 0502 RAM disk initialized by the bootloader. In this case the kernel 0503 calls a userland initialization program (e.g., /linuxrc) on the initial root filesystem, which may load the necessary drivers and probe devices, in order to mount the internal filesystem image 0504 as the new root filesystem, and continue the boot process 0701.

In one embodiment, if enough memory is available, the internal filesystem image 0504 on the outer filesystem 0500 may be loaded at this point into a temporary ram filesystem (ramfs) created in main memory 0204 (step 0702). As previously described, this may significantly increase performance and decrease power consumption.

Next, the internal filesystem image 0504 on the outer filesystem 0500 may be re-mounted as the root filesystem (step 0703).

Note, that in a specific embodiment, before the internal filesystem image 0504 can be accessed (step 0702 or step 0703), the initialization scripts in the initrd 0502 RAM disk image may need to load the necessary drivers, probe the computer's 0102 hardware for the security device 0101, and mount the outer filesystem 0500 in which the internal filesystem image 0504 is contained. For example, if a specific embodiment of the security device 0101 is connected to the computer 0102 as a USB peripheral, the initialization scripts in the initrd 0502 RAM disk may need to load USB drivers and probe the USB bus in order to re-interface with the security device 0101 and access the outer filesystem it contains. Similarly, if, for example, the internal filesystem image 0504 is compressed, and the kernel does not include built-in support for this type of compression, the initialization script may need to load a driver to support it.

Next, control of the boot process 0701 may be passed to the exemplary initialization manager 0601 software contained inside the internal filesystem 0504, which is further described in the following.

As previously described in the Exemplary functional overview section, the initialization manager 0601 may function to, for example, optimize the boot process 0701, determine hardware configuration parameters, load drivers, cache hardware settings, load system services, maintain a record of initialized system state, or perform other initialization operations.

In one embodiment, an exemplary initialization manager 0601 may use the Persistent Safe Storage (PSS) mechanism 0602 introduced in the Exemplary functional overview section above to store useful data persistently inside a safe opaque (e.g., encrypted) container file residing within the filesystems of the local operating system on a computer's 0102 internal storage 0208 devices.

The initialization manager 0601 may use the PSS mechanism 0602 to overcome the obvious limitations inherent in loading an operating system environment from a physically read-only memory element 0303/0308.

For example, when the user first boots into the security device 0101 a computer 0102 on which Microsoft Windows has been installed, the initialization manager 0601 may create a PSS element within a local NTFS (or FAT32) Microsoft Windows type partition on the hard drive 0208′.

The PSS element may then be used to securely store, for example, network configuration parameters, user settings, application content and configuration data, and miscellaneous user generated data. Furthermore, the initialization manager 0601 may store in the PSS element, hardware configuration parameters that were autodetected or manually configured in a previous boot, a record of initialized system state, or other data that may be created during the boot process.

This may allow the initialization manager 0601 to subsequently optimize the boot process 0701 for speed, efficiency and convenience.

In other words, the first time a user boots his computer 0102 into the security device 0101, the boot process 0701 may be relatively slow, and may require some manual interaction with the user, because the boot process may need to detect and configure hardware, initialize system services for the first time and perform other boot operations. In contrast, the next time the user boots the same computer 0102 into the security device 0101, the time it takes to load a running operating system environment may be significantly reduced and require little to no user interaction thanks to boot process 0701 optimizations enabled by the PSS mechanism 0602.

Consequently, in one embodiment of the invention, the PSS mechanism 0602 may play a significant role in the operation of an exemplary initialization manager 0601.

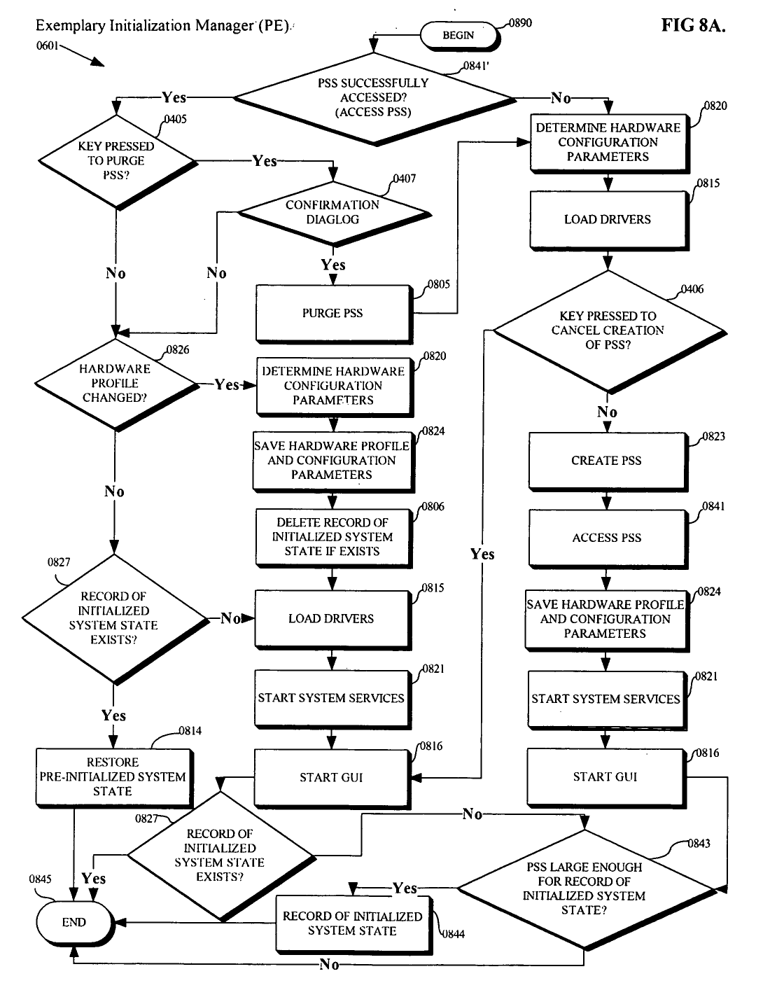

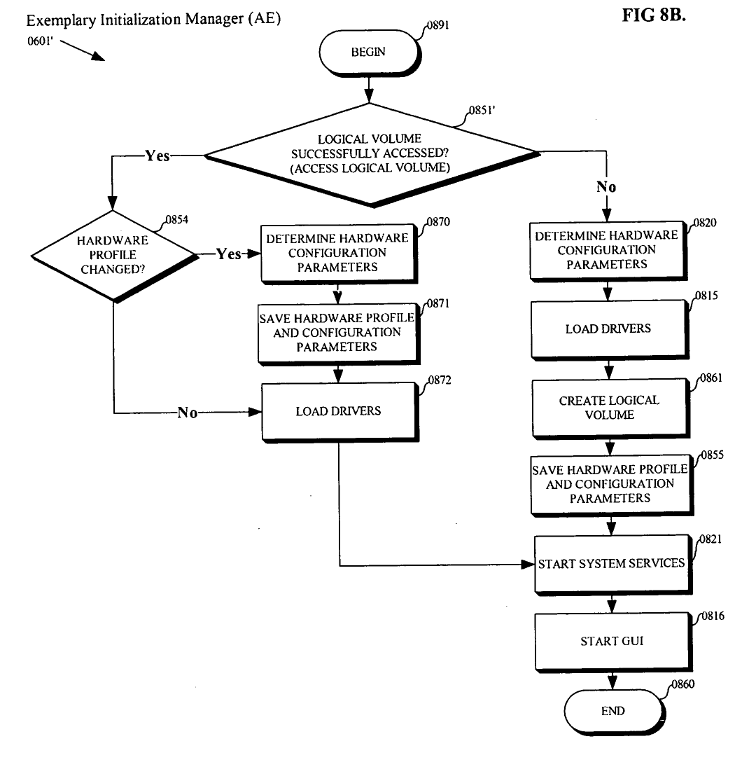

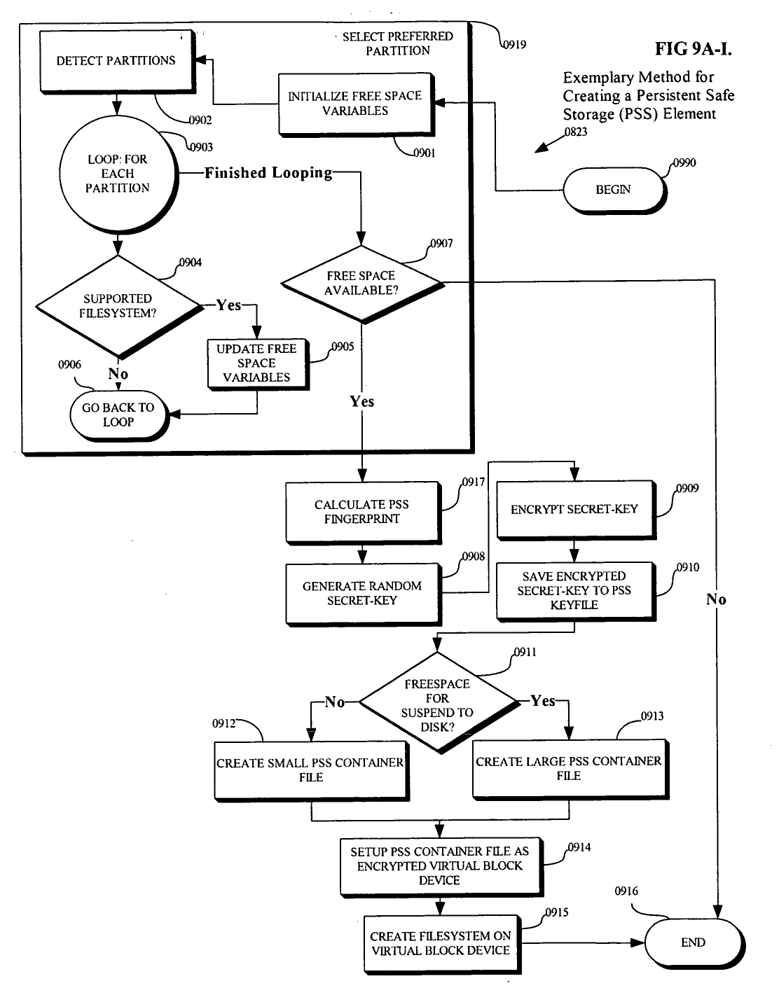

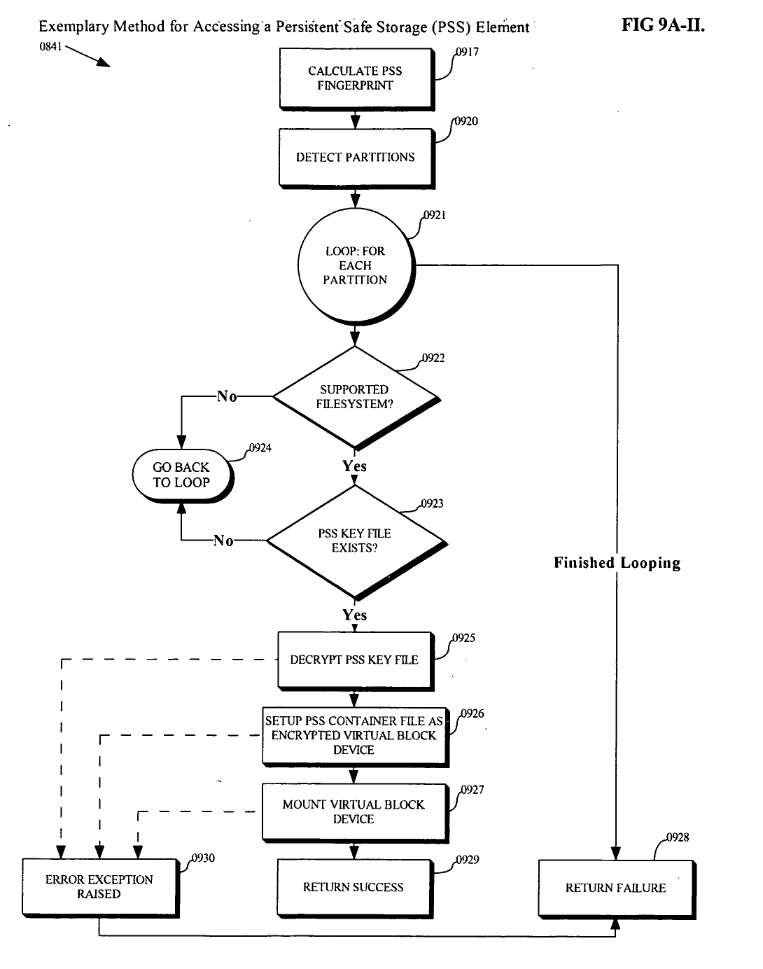

FIG. 8A is a flow diagram that illustrates exemplary steps in the operation of the initialization manager 0601 during the boot process 0701 of FIG. 7A.

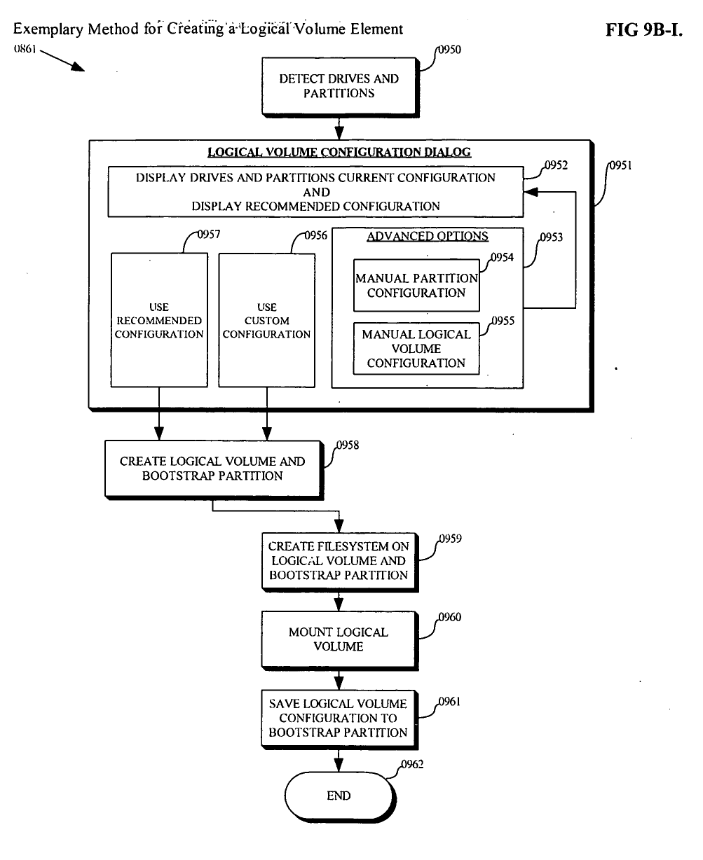

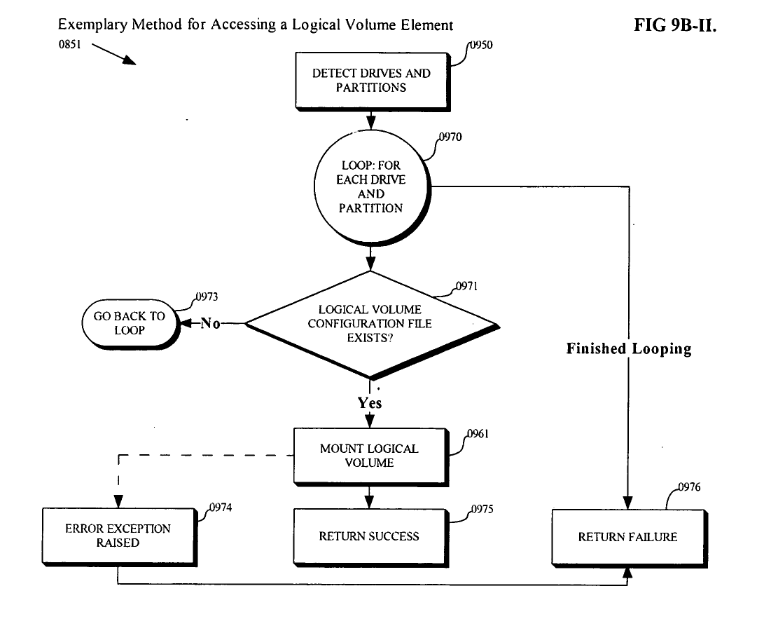

First, the initialization manager may attempt to access the Persistent Safe Storage (PSS) element (step 0841′) using the exemplary method for accessing a PSS element 0841′ further described below with reference to FIG. 9A-II.

This operation (step 0841′) may fail however, for example, if the PSS element has not yet been created because the user is booting into the security device 0101 for the first time, or if an existing PSS element has somehow become corrupted.

If the initialization manager 0601 fails to access the PSS element (step 0841′), it may then function to determine hardware configuration parameters (step 0820), load drivers (step 0815), and then create (or recreate, as the case may be) the PSS (step 0823) element unless creation of the PSS element is canceled by the user (step 0406).

Software for determining hardware configuration parameters may function to probe computer 0102 hardware (step 0820) previously described in the Exemplary environment in which the invention maybe used section with reference to FIG. 2, and automatically determine what operating system drivers need to be loaded to support it, along with the required parameters for these drivers.

For example, software for determining hardware configuration parameters may include functionality that queries the computer 0102 BUS 0209 for the type, make and vendor information of the hardware that is connected to it and then looks up the corresponding hardware configuration parameters in a special database that associates BUS hardware signatures with device drivers and device parameters. Software for determining hardware configuration parameters may further include functionality that interfaces with specific types of hardware including, for example, a graphics card controlling a visual display device 0202, to negotiate parameters such as preferred screen resolution, and other types of hardware configuration parameters.

In one embodiment, software for determining hardware configuration parameters may further include functionality for importing hardware configuration parameters from the configuration file formats of the local operating system installed on the computer's 0102 internal storage 0208 devices. Assuming an operating system (e.g., Microsoft Windows) is already installed on the computer's 0102 hard drive 0208, it would most likely already be configured to interoperate with the computer's hardware. As such, for some applications, it may be preferable to include software functionality which takes advantage of these existing configuration parameters, to further automate hardware detection and configuration operations. In order to support this functionality, the initrd 0502 may need to include appropriate drivers that are required for accessing the native file formats of mainstream operating systems (e.g., NTFS, VFAT).

Thus, software for determining hardware configuration parameters may include routines for parsing the configuration file formats (e.g., the registry) of mainstream operating systems (e.g., Microsoft Windows) to extract information that may be useful for automatic hardware configuration. For example, many visual display devices 0202 such as CRT monitors are capable of operating in a range of modes (e.g. resolution, refresh rate, color depth). Many different configurations for a monitor may be possible, but it is likely that a user has only one specific preference for any given monitor. Objectively, one valid monitor configuration is no more correct than another. The monitor configuration which the user would perceive to be correct can not always be detected by probing the hardware, so it is thus useful to include functionality for extracting this information from the configuration files of the local operating system that has been installed to the hard drive.

In one embodiment, if software for determining hardware configuration parameters fails to automatically discover hardware configuration parameters, it may interact with the user to perform manual, or semi-automatic configuration. It is generally preferred however, to minimize interaction with the user as much as possible because the average user will usually not be intimately familiar with the details of their computer's 0102 hardware configuration, so requesting to provide this information may serve to frustrate, confuse and otherwise inconvenience him.

Software for determining hardware configuration parameters may include, for example, Knoppix's hardware autodetection software, kudzu, or other software for detecting, probing and configuring hardware.

As previously explained in the Exemplary user interaction section above with reference to FIG. 4A, for some applications it may be preferable to allow the user to interact with the initialization manager 0601 to cancel creation of the PSS element (conditional 0406), for example, by pressing a special function key on the keyboard during boot.

As shown, for most applications, the PSS element will be created by default unless the user explicitly intervenes due to special circumstances.

For example, if users boot into the security device 0101 a computer 0102 they are unlikely to be using again in the future (e.g., an Internet kiosk at an airport), choosing to cancel the creation of a PSS element may be desirable as it will eliminate unnecessary steps in the boot process 0701 which may otherwise take a noticeable amount of time. Similarly, if the computer 0102 does not belong to the user of the security device 0101, the owner of the computer 0102 may prefer that the user does not create a large encrypted file on his computer's 0102 hard drive 0208.

Referring back to conditional 0406, unless the user cancels creation of a PSS element, the initialization manager 0601 may create the PSS element (step 0823) using the exemplary method for creating a persistent safe storage element 0823 further described below with reference to FIG. 9A-I.

Next, the initialization manager 0601 may access the PSS element (step 0841′).

After the PSS element has been created (step 0823) and accessed (step 0841′), the initialization manager may save to the PSS element the hardware profile and the configuration parameters (step 0824) that were autodetected or manually configured earlier (step 0820).

The hardware profile and configuration parameters that are saved to the PSS element (step 0824) may be used, for example, to subsequently optimize the boot process as previously described above.

Next, the initialization manager 0601 may start system services (step 0821).

In a specific embodiment, the initialization manager 0601 may start system services (step 0821) by executing a group of initialization scripts stored in a directory, in an order that may be determined by how the initialization scripts are dependent on one another. When possible, it may be preferable to execute initialization scripts in parallel, which may increase the speed and efficiency of this step of the boot process 0701.

System services may include, for example, scripts to enable security mechanisms such as the personal firewall and Mandatory Access Control policy. Other examples may include printing services, a font server, network neighborhood monitor, helper daemon for interfacing with removable devices, and any other useful services.

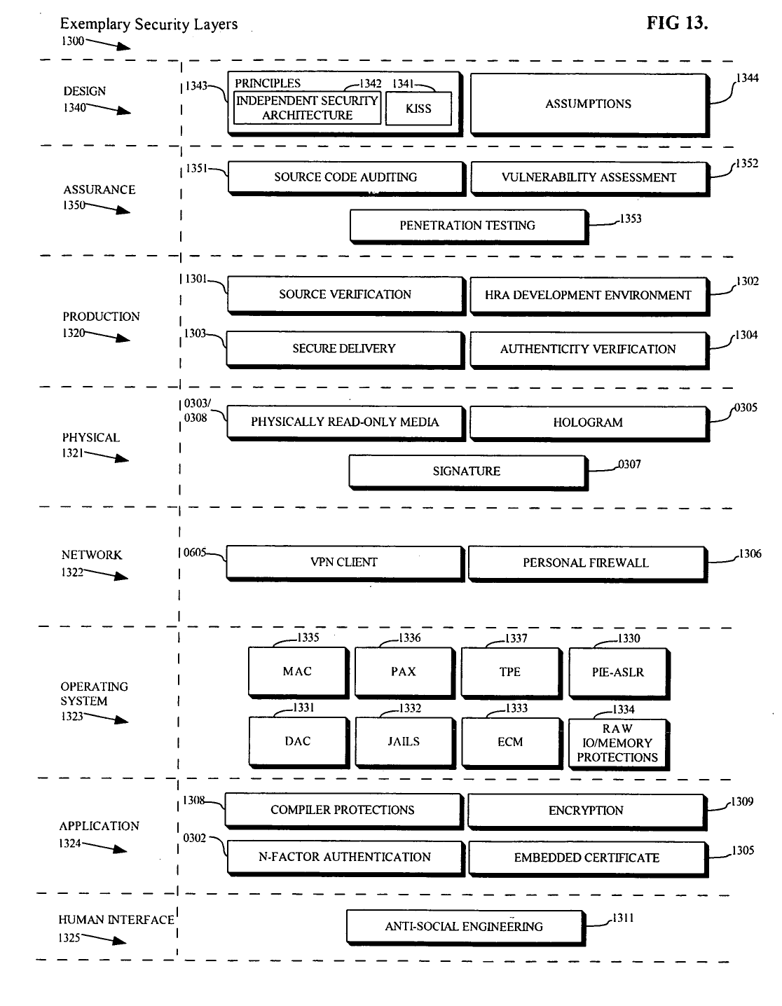

On the other hand, due to security considerations further explained in the Exemplary security layers section below with reference to FIG. 13 it may be preferable to reduce the complexity of a specific embodiment by minimizing included system services, especially those that require special privileges to run, preferring simpler services to provide the required functionality, and running services with as little privileges as possible.

Next, the initialization manager may start the Graphical User Interface (GUI) (step 0816), previously introduced as the workspace infrastructure level 0623 graphics subsystem 0603 in the Exemplary functional overview section above with reference to FIG. 6A.

It should be noted, that in one embodiment, starting the GUI (step 0816) may function to start other processes as specified by the configuration files and initialization scripts of the graphics subsystem 0603.

Next, if the PSS element is large enough to store a record of the state of the initialized system (conditional 0843), the initialization manager 0601 may function to write a record of the state of the initialized system to the PSS element (step 0844). In the art, this operation is sometimes called suspending to disk, and is most commonly used to freeze the runtime state of a mobile computer (e.g., laptop or PDA) that has been suspended, to the hard drive, in a way that allows this state to be later restored relatively quickly. In mobile computers, suspending to disk is useful because it provides convenience of use while conserving battery power. Naturally, in the context of the preferred embodiment of the invention, this step (0844) it is not intended to actually suspend or freeze the system during the boot process 0701.

Storing a record of the state of the initialized system (step 0844) may be useful to enable a significant reduction in the amount of time it takes to load a running operating system environment in subsequent boots because in certain circumstances loading the pre-initialized state of a system from disk may be more efficient than recreating the initialized state again in a conventional boot process.

On the other hand, saving state to disk may take a significant amount of time and consume considerable space on the hard drive, in direct proportion to how much state needs to be saved.

For example, one variation of a record initialized system state method may require an image of the entire contents of main memory 0204 to be included in the PSS element. For a computer 0102 with one gigabyte of memory, for example, saving a complete image of memory to disk may require a significant amount of time and internal storage 0208 space.

Consequently, for some applications, it is preferable to use more efficient variations of the record initialized system state method (step 0844) that require less state to be saved to disk. For example, one variation of this method may only require memory pages that are allocated by the operating system kernel's VM (virtual memory) mechanism to be saved to disk. Similarly, VM pages used as cache/buffers may also not be required. In this variation unallocated (free) and cache/buffer memory pages will not be saved, which may save considerable time and internal storage 0208 space.

Referring back to conditional 0843, if the PSS element is not large enough to contain a record of the state of the initialized system, the initialization manager 0601 ends (step 0845) without performing this operation (step 0844).

The circumstances that may influence the size of a PSS element are further described in the Exemplary method for creating a PSS element section below with reference to FIG. 9A-I.

Referring back to the top of FIG. 8A, if the initialization manager 0601 successfully accesses the PSS element, it may be preferable to allow the user to interact with the initialization manager 0601 to purge the PSS element (conditional 0405), for example, by pressing a special function key on the keyboard during boot.

This user interaction step 0405 was previously described in the Exemplary user interaction section above with reference to FIG. 4A.

The user may be notified of this option through the computer's 0102 output devices 0202, for example, by displaying a visual notification message to the screen.

As previously explained, if the user requests to purge the PSS element (conditional 0405), for example, by pressing an appropriate function key on the keyboard, a confirmation dialog (conditional 0407) may function to explain the ramifications of this action and prompt the user for further confirmation, in order to prevent accidental purging.

If the user confirms (conditional 0407), the PSS element may then be purged (step 0805) and the initialization manager 0601 may continue a previously described flow of execution from step 0820, as if the PSS element had never been successfully accessed (conditional 0841′).

Note, that purging the PSS element (step 0805) may permanently destroy all of the data stored inside it by deleting the PSS's associated files (e.g., key-file, container) from the filesystem it was created within.

As purging the PSS element is an irreversible destructive operation that may result in undesirable data loss, there are limited justifications for performing it. The user may, for example, wish to purge the PSS element (step 0805) in order to re-initialize a fresh instance of the operating system environment based on the default factory settings. For example, perhaps the user has broken the settings in the PSS 0602 so severely that re-initializing a fresh operating system environment is an appealing alternative to trying to fix the settings manually. In another example, a new employee inherits the security device 0101 and computer 0102 of an old employee that has left the company.

Otherwise, if the user does not request to purge the PSS element (conditional 0405), then the initialization manager 0601 may next attempt to detect if the computer's 0102 hardware profile has changed (conditional 0826).

In one embodiment, this step may be accomplished by querying the computer 0102 BUS 0209 for the identification information (e.g., type, make and vendor, etc.) of the hardware connected to it, and then comparing this hardware profile with a hardware profile previously stored in the PSS element.

The hardware profile may change when the user installs new hardware in his computer 0102 or replaces existing hardware. For example, the user may upgrade an old graphics card with a newer more powerful graphics card, add a new wireless network interface 0203 card, an additional hard drive 0208, change the amount of main memory 0204, upgrade the CPU 0205, or make other changes to computer hardware that may be reflected in the hardware profile.

If the hardware profile has changed (conditional 0826), the initialization manager 0601 may then function to determine hardware configuration parameters (step 0820), save the new hardware profile and configuration parameters to the PSS element (step 0824) and delete the record of initialized system state (step 0806) from the PSS element, if it exists. The rational for this behavior is that, if the hardware profile has changed (conditional 0826), the previously detected hardware configuration parameters saved to the PSS element in an earlier boot process may no longer apply for the new hardware. As such, in this case, it may be preferable to determine hardware configuration parameters again (step 0820).

Similarly, if the hardware profile has changed (conditional 0826), the record of initialized system state previously saved to the PSS element (step 0844) may no longer be compatible with the new hardware. As such, in this case, it may be preferable to delete it. (step 0806)

In one embodiment, new hardware configuration parameters are determined (step 0820) only for the hardware components which have changed according to a comparison of the current hardware profile and the previously saved hardware profile. Determining hardware configuration parameters only for new or replaced hardware may be performed more quickly and efficiently.

Referring back to conditional 0826, if, on the other hand, the hardware profile has not changed, the initialization manager 0601 may check whether a record of pre-initialized system state exists in the PSS element (conditional 0827), and if it does, restore the pre-initialized system state (step 0814).

As previously described, restoring the system from a pre-initialized state (step 0814) may be more efficient than recreating the initialized state again in a conventional boot process, thus enabling a significant reduction in the amount of time it takes to load a running operating system environment in subsequent boots. For some applications, shorter boot times may considerably improve the convenience of use for users of one embodiment of the invention.

As shown, if a record of the initialized system state does not exist in the PSS element (conditional 0827), or if execution is continued from step 0806, the initialization manager 0601 may then function to load the appropriate drivers (step 0815), start system services (step 0821), start the graphical user interface (step 0816) and finally save a record of initialized system state to the PSS element (step 0844) if the PSS element is large enough to contain it (conditional 0843).

Note, that these steps were previously explained in the context of describing the flow of steps depicted on the top right hand side of FIG. 8A, following a failure to successfully access the PSS element (conditional 0841′).

In other words, the steps may be functionally equivalent, as indicated by the identical numbering, except for relatively small variations due to context.

Referring back to FIG. 7A, the system initialization steps performed in the boot process 0701 may include, in one embodiment, starting the previously introduced connectivity agent 0604 software, which may be used to assist users in establishing network connectivity across a variety of circumstances and is further described in the Exemplary connectivity agent section below with reference to FIGS. 10-I, 10-II and 10-III.

For example, the connectivity agent 0604 may be started by the initialization scripts of the graphics subsystem 0603, which is itself started by the initialization manager 0601. This may be preferable for some embodiments as it may more easily allow the connectivity agent 0604 to interact with the user using a graphical interface.

a). Exemplary Persistent Safe Storage Methods

As previously explained, the Persistent Safe Storage (PSS) mechanism 0602 may be used to store data persistently inside a safe, opaque (i.e. encrypted), container file residing within the local operating system's filesystems on a computer's 0102 internal storage 0208 devices.

Exemplary Method for Creating a Persistent Safe Storage Element

FIG. 9A-I is a flow diagram illustrating exemplary steps in a method for creating a PSS (Persistent Safe Storage) element.

First, the method 0823 may select the preferred partition in which the PSS element will be created (step 0919).

Note, that it is common for a computer 0102 to contain multiple internal storage devices 0208 that may further be subdivided into partitions. For example, a hard drive may contain one partition for the bootloader and operating system kernel files, a second partition for system and application software, a third partition for user data and a fourth partition for swap.

The preferred partition may be, for example, the partition with the most free space available and a supported type of filesystem.

In one embodiment, as indicated by steps of block 0919, in order to select the preferred partition, free space variables may first be initialized (step 0901), internal storage 0208 devices may next be probed to compile a list of existing partitions (step 0902), and then, for each partition (loop 0903), free space variables (step 0905) may be updated to keep track of how much free space exists in the filesystem contained within a particular partition, if its filesystem type is supported (conditional 0904).

Free space variables may be used, for example, to store one value representing the identification of the partition with the maximum free space, and another value representing the amount of free space available in that partition.

In other words, for every loop 0903 iteration, free space variables may be updated (step 0905), such that they will store the details of the partition with the most free space by the end of the loop, assuming the filesystem type in that partition is supported (conditional 0904).

In an alternative embodiment, the method 0823 may interact with the user in order to select a partition based on the user's preferences. For example, the method 0823 may present the user with a list of detected partitions and the available free space in each of them, and allow users to select which partition they prefer the PSS element to be created in.

Referring to conditional 0907, if sufficient free space is not available on any of the partitions, the method 0823 may end 0916 without creating the PSS element.

Otherwise, the method 0823 may next function to calculate a PSS fingerprint (step 0917).

The PSS fingerprint may be used to allow multiple PSS elements to co-exist on one computer 0102. This is required if a private PSS element is to be created for each user that is booting a particular computer 0102 into his personal security device 0101.

For some applications, creating a private PSS element for each user may increase security and convenience of use by allowing each user to securely save individual settings, personal preferences and confidential data to his own private PSS element on a shared computer 0102.

For example, a private PSS element may be useful in enabling multiple family members or employees to share a home or work computer 0102 they are using in conjunction with a personal security device 0101, by allowing each family member or employee to individually tweak operating system environment settings according to their personal preferences and additionally store confidential data inside a private PSS element other family members or employees can not access.

In one embodiment, a part or all of the calculated PSS fingerprint (step 0917) may be embedded in the names of the PSS files (e.g. container, key-file). In another variation, the PSS fingerprint may be embedded within the contents of the PSS files, for example, as part of a suitably formatted header.

The PSS fingerprint may be calculated (step 0917) such that it is unique to each user or security device 0101 in order to prevent the fingerprints of any two separate PSS elements from colliding.

For example, in the security device 0101 embodiment of FIG. 3A, the calculated PSS fingerprint may be a fingerprint of the cryptographic identity keys stored in the security device's cryptographic component 0302. As is well known in the art, one technique for calculating the fingerprint of a cryptographic certificate or key may involve passing it through a one-way hashing function.

In security device 0101 embodiments that are intended to be used without an integrated 0302 or external cryptographic component (i.e. separate cryptographic token), the PSS fingerprint may be calculated from the authentication credentials provided by the user during the boot process. For example, in one embodiment, the PSS fingerprint may be the name of the user.

Next, the method 0823 may function to generate a random secret key (step 0908), encrypt the secret key (step 0909), and save it to a PSS key file (step 0910).

The secret key may later be used to encrypt the PSS element in order to protect its integrity and content confidentiality. The secret key is stored encrypted in a file such that a method for accessing the PSS element will have to access the key-file and decrypt it as described below.

A cryptographic quality source of entropy may be used to generate a random secret key (step 0908). The source of entropy may include, for example, special operating facilities for providing cryptographic quality randomness (urandom device on Linux), the values and precise timings of random inputs provided by the user (e.g., random key presses or mouse movements), another source of entropy or a combination of sources.

Random input from the source of entropy may further be hashed, which may further increase how difficult it is to predict or guess the secret key using advanced cryptanalysis techniques.

In the security device 0101 embodiment of FIG. 3A, the secret key may be encrypted (step 0909) by the integrated cryptographic component 0302 such that it can only be decrypted by the same specific cryptographic component 0302. For example, in an embodiment including a cryptographic component 0302 capable of performing asymmetric public key operations, a public key may be used to encrypt the secret key (step 0909), such that it may decrypted only by the same specific cryptographic component 0302 using the corresponding private key stored securely within it.

In another embodiment, an equivalent mechanism may be used in conjunction with a separate (external) cryptographic token (e.g. authentication token) that is simultaneously connected to the computer 0102 such that the security device 0101 may interface with it.

In security device 0101 embodiments that are intended to be used without an integrated 0302 or external cryptographic component (i.e. separate cryptographic token), the secret key may be encrypted (step 0909) using a symmetric cryptographic cipher and a password provided by the user. While possible, it is preferable not to encrypt the PSS element directly with a password as the secret key, as this may later require fully decrypting and then re-encrypting the PSS container whenever the password is changed, instead of just re-encrypting a new PSS key-file.

The encrypted secret key may be saved to a file inside the filesystem of the selected partition (step 0910). The name of the key file may comprise of, for example, a descriptive prefix (e.g., KEY-), part or all of the previously calculated PSS fingerprint (step 0917), and a descriptive suffix (e.g., .PSS).

For some types of filesystems, different naming conventions may be preferable because, for example, the filesystem restricts the length of the filename or restricts the use of some characters in the filename, or perhaps the local operating system reads special meaning into a component of the filename. (i.e., UNIX files are considered hidden by convention if they are prefixed by a dot‘.’)

It may be preferable to save PSS files inside an appropriately titled directory within the filesystem. For example, if a Windows NTFS or FAT32 filesystem partition is selected as the preferred partition, PSS files may be saved to a directory titled “SAFESTORAGE”. It may further be preferable to set the directory and file attributes such that the files are hidden, immutable and recognized as special system type files for the filesystem types that support this functionality, as this may decrease the risk that the PSS files will later be accidentally deleted or tampered with by the user (e.g., when booted into Microsoft Windows).

Next, if enough free space is available in the selected partition's filesystem to save a record of initialized system state (conditional 0911), a PSS container file large enough to hold this record may be created (step 0913), otherwise a smaller PSS container file may be created (step 0912).

A PSS container that is too small to hold a record of the initialized system state may still be used, for example, to store hardware configuration parameters, network settings, user preferences, and other miscellaneous data.

In one embodiment, the PSS container file may be created by writing a sufficient amount of bytes with arbitrary values to a suitably named file. Similar to the key file, the name of the container file may comprise of, for example, a descriptive prefix (e.g., CONTAINER-), part or all of the previously calculated PSS fingerprint (step 0917) and a descriptive suffix (e.g., .PSS).

As an alternative to storing the encrypted secret key and the encrypted container in separate files, one file containing both functional elements may be used, though this may require a more complex file format and support for this format in the operating system.

Next, the method may setup the PSS container file as an encrypted virtual block device (step 0914).

Some operating system kernels (Linux, for example), include built-in support for a loop device mechanism that may be used to provide a virtual block device interface to a file. This may allow an image of a filesystem in a regular file to be mounted as a virtual block device, the same way a filesystem in a hard drive partition would be mounted.

In Linux, an additional layer of symmetric encryption may be provided for the virtual block device by, for example, applying the loop-aes patch for the loop device kernel mechanism and auxiliary system utilities (e.g., losetup).

Alternatively, recent versions of the Linux kernel (2.6) include extensive support for creating logical devices using a device-mapper driver. This mechanism may also be used to setup a file as an encrypted virtual block device by using the cryptsetup utility (for example) to map a layer of encryption on top of a loop device that has been mapped to a file using the losetup utility (for example).

In one embodiment, the encryption layer may use a symmetric cipher such as, for example, AES. A cipher is symmetric if the same secret key if used symmetrically for both encryption and decryption operations. In contrast, a cipher is asymmetric if, for example, one key is used for encryption and another is used to decrypt (e.g., public key cryptography).

The key for the virtual block device's encryption layer may be the previously generated secret key (step 0908) that was saved encrypted to the PSS key file (step 0910).

Finally, a filesystem is created on the previously setup virtual block device (step 0915), which is mapped to the container file that has been created within the filesystem on the preferred partition.

The filesystem type may be, for example, ext2, ext3, reiserfs, fat32 (vfat), JFS, NTFS, or other type of writable filesystem.

Exemplary Method for Accessing a Persistent Safe Storage Element

The operations of the following exemplary method may be better understood in reference to the corresponding operations of its exemplary counterpart, previously described in the Exemplary method for creating a persistent safe storage element section above.

FIG. 9A-II is a flow diagram illustrating exemplary steps in a method for accessing a PSS element.

First, the method 0841 may calculate a PSS fingerprint (step 0917).

Next, the method 0841 may try to locate a PSS element previously created by the previously described exemplary method for creating a PSS element 0823.

In one embodiment, in order to locate a previously created PSS element, internal storage 0208 devices may be probed to compile a list of partitions which exist on all disk drives (step 0920). Then, for each partition (loop 0921), if the filesystem type contained within the partition is supported (conditional 0922), the method 0841 may check for the existence of a PSS key file (conditional 0923) within the filesystem, in the same filesystem location where the PSS files were created by the previously described exemplary method for creating a PSS element 0823.

If a PSS element is not located on any of the detected partitions, then the method 0841 returns failure (step 0928).

Otherwise, if a PSS element is located, for example, by discovering the existence of a PSS key-file (conditional 0923), then the encrypted secret key stored in the PSS key-file is decrypted (step 0925) and used to setup an encryption layer for a virtual block device that is mapped to the PSS container file (step 0926). Finally, virtual block device may be mounted to provide access to the filesystem contained within the encrypted PSS container file.

The method may return failure (step 0928) if it fails to perform any of the previous steps, because, for example, the PSS files have become corrupted, and an error exception has been raised (step 0930).

### Network PSS Element Variation

In one embodiment, a PSS element may be stored at a predetermined network location (e.g., network file share), replacing or supplementing the previously described PSS element stored on the computer's internal storage devices.

A PSS element accessed through the network may be preferable in some circumstances, for example, by enabling data persistence even on cheap computers which don't have internal storage devices (e.g., diskless thin clients).

Also, the user's data and personalized operating system environment settings would be universally accessible transparently from any computer with a network connection that is booted from the security device.

Note, that storing the PSS element on the network would break the natural association between any given PSS element and the hardware of a specific computer, because unlike a PSS element on internal storage devices, a network PSS element may potentially be accessed from any computer that is booted from the security device.

It is thus preferable to save hardware specific data (e.g., the hardware profile, the record of initialized system state) to a PSS element stored on a computer's 0102 internal storage devices 0208, if possible.

b). Exemplary Connectivity Agent

FIG. 10-I is a flow diagram illustrating exemplary steps in the operation of the connectivity agent software, which may be used, in the preferred embodiment, to assist users in establishing network connectivity across a variety of circumstances.

It should be noted that in principle, as previously described in the Exemplary user interaction section, to achieve optimal ease of use, it is preferable if by default, the connectivity agent 0604 interacts with the user only if it has failed to configure and establish network connectivity automatically. In this case, user interaction may then be required, for example, to manually provide the required settings for a dialup or ADSL modem connection, select which wireless network to use, configure a network's required proxy configuration, or provide other information required to configure the network in a given circumstance.

Before involving the user however, the exemplary network connectivity agent 0604 described in the following may perform a variety of operations in order to effect automatic detection and configuration of network connectivity.

To facilitate a better understanding of how this may be achieved, exemplary steps in the operation of the connectivity agent 0604 are described in the following.

First, the connectivity agent 0604 probes for network devices (step 1001), in order to detect the various types of network interface hardware 0203 installed in the computer 0102. As previously described in the Exemplary environment in which the invention may be used section, with reference to FIG. 2, a network interface can include, for example, a modem, wired ethernet, GigaEthernet, token ring network interface card, a wireless network interface card for use with 802.11a, 802.11b, 802.11g, WiMax or cellular wireless networks, or any other device that allows a computer to interface with a network.

Next, the connectivity agent 0604 checks if a PSS element has been successfully accessed (conditional 0841′) by the initialization manager 0601 as previously described above, and if a previous network configurations list exists in the PSS element (conditional 1050). If so, the previous network configurations list may be retrieved from the PSS element (step 1051), and passed as arguments to the test configurations procedure 1030 (step 1002), further described below with reference to FIG. 10-II.

In one embodiment, the previous network configurations list may be a list of previously successful network configurations. For some applications, it may be preferable if this list is prioritized according to how likely each network configuration is to work, based on historical patterns. For example, if a user connects his laptop to his home network 70% of the time, and a network at work 30% of the time, it may be more efficient for the connectivity agent 0604 to first try and configure the network with the home network configuration parameters. Similarly, the connectivity agent 0604 may be further optimized to recognize time or date-dependent patterns of network connectivity. Thus, in one embodiment, the connectivity agent might prioritize network configuration attempts based on how likely they are to succeed in respect to the time or date. For example, the connectivity agent 0604 may first try the corporate network configuration during office hours, and always try the home network configuration first during the weekend. And so forth.

Note, that for some applications, it may be preferable to attempt to establish wired network connectivity before wireless network connectivity, if circumstances permit it, because a wired network is often more reliable than a wireless network. For other applications, the opposite may be more preferable. In one embodiment, users may be allowed to choose their own preference.

FIG. 10-II illustrates exemplary steps in the test configurations procedure 1030. The procedure accepts a list of network configurations as its arguments. For each network configuration in the list that is passed to the procedure as an argument (loop 1008), an attempt is made to apply the network configuration and test connectivity (step 1003). If connectivity is successfully established the connectivity established procedure 1040 is then called, otherwise the loop continues to try the next network configuration. If none of the network configurations are successful, the procedure returns (step 1031) after it finishes looping.

Referring back to FIG. 10-I, if the PSS has not been successfully accessed (conditional 0841′), or if no previous network configurations have yet been saved to the PSS (conditional 1050), then the connectivity agent 0604 may attempt to import network configurations (step 1048) from the configuration files that may have been created (conditional 1053) by the local operating system that may be installed (conditional 1052) to the internal storage 0208 devices in the user's computer 0102.

For example, assuming the security device 0101 is used in conjunction with the user's computer 0102 only for high risk applications, the user may still be using his regular operating system (e.g., Microsoft Windows) for everything else. In this case, it is likely that Windows is already configured for the specific network connectivity configurations that apply to a user's given circumstance, and it may thus be useful if the connectivity agent functions to import these configurations located somewhere inside the native filesystem of the local operating system the user is using for regular low-risk applications.

If these configurations are successfully imported, then the connectivity agent may attempt to establish connectivity with them by passing them as arguments to the test configurations procedure (step 1007).

The connectivity agent 0604 may perform a network connectivity test 0103 in order to determine whether initial automatic or manual configuration of the network has been successful (steps 1003, 1006, 1009, 1015, 1016) and additionally to test whether a previously established connection to the network still exists. (step 1006)

Network connectivity may be tested, for example, by sending a ping to a prespecified hostname or IP address, making an HTTP request to a web server, or performing any other predefined reliable operation that requires network connectivity to succeed.

If a network connectivity test is successful, the connectivity agent 0604 may call the connectivity established procedure 1040.

FIG. 10-III illustrates exemplary steps in the connectivity established procedure 1040, which may be called by the connectivity agent after connectivity has been successfully established, which may be determined, for example by the previously described connectivity test. First, the procedure may add or update the parameters of the successful configuration to the previous network configurations list maintained in the PSS element (step 1004). Next, the procedure may switch to a continuous monitoring mode (loop 1005) in which it periodically tests for network connectivity (conditional 1006). In between connectivity tests (conditional 1006), the procedure may wait (step 1048) for a specific amount of time to pass (i.e., sleep). If a connectivity test (conditional 1006) returns failure, the procedure 1040 may attempt to re-establish network connectivity, for example, by restarting the operation of the connectivity agent 0604 from step 1001 (step 1041—goto 1001).

Referring back to FIG. 10-I, if the previous network configurations list and the imported network configurations do not exist or can not be accessed (conditional 1050 and conditional 1053), or if the connectivity agent 0604 fails to establish network connectivity with the previous or imported network configurations then the connectivity agent 0604 may attempt to configure network connectivity using reasonable defaults.

For example, if a wired network device exists (conditional 1010), the connectivity agent 0604 may attempt to automatically configure it using the DHCP protocol (step 1011), which is widely supported by many networks as it reduces the complexity and support requirements of network administrators.

Similarly, if a wireless network device exists (conditional 1012), the connectivity agent may configure it to automatically associate with the wireless network that has the most powerful signal and configure itself with DHCP (step 1049).

In one embodiment, if multiple wireless networks exist, and no previous network configurations can be retrieved, the connectivity agent 0604 may prompt users to choose which of these networks they prefer to attempt a connection to (step 1014/0408). Users may also be required to provide a password to access encrypted wireless networks (WEP).

Note, that even without DHCP support on a network, it may be possible for the connectivity agent 0604 to automatically configure the network in some circumstances by intercepting (sniffing), analyzing network traffic and resorting to trial and error. However, such non-standard methods should be used with caution, as some of these methods have the potential to disrupt network traffic, for example, by using an already allocated IP address on the network, or blocking traffic to a local gateway by accident when using ARP poisoning as a traffic interception technique.

In summary, if no network configurations can be retrieved, yet multiple network devices exist, the connectivity agent 0604 may try to establish network connectivity with any of them in whatever order is preferable for the specific application the embodiment is optimized for.

The connectivity agent 0604 may skip attempting to configure a device if it can detect that it is not interfacing with a network. For example, there is little use in attempting to configure a wired NIC interface that is not physically connected to a network, or a wireless card in a setting where no wireless networks are detected, and so forth.

Finally, If the connectivity agent 0604 fails to establish network connectivity with any of the automatic methods described above, it will prompt the user with manual configuration wizards (step 1016/0408).

Whether the network connection is manually or automatically configured, the previously described connectivity established procedure 1040 may save or update successful network connectivity configurations (step 1004) in the PSS so that user interaction may not be required for similar circumstances in the future.

In one embodiment, the connectivity agent 0604 may provide visual feedback to the user during its automatic attempts to configure the network, and may also provide a manual override option which allows the user to cancel automatic network configuration attempts and perform an immediate manual configuration of the network. This option may allow advanced users to save time in some circumstances.

Referring back to FIG. 7A, in one embodiment, after the connectivity agent 0604 successfully establishes network connectivity, further operations that require connectivity may be performed such as, for example, establishing a VPN connection (step 0707), authenticating to the service provider (step 0705), starting client applications (step 0706), and other operations that are appropriate for the specific application an embodiment is optimized for.

Dependencies between these operations may influence the order in which they are performed.

For example, client applications (e.g., web browser) may be started (step 0706) after a VPN connection has been established (step 0707), thus allowing the client applications to access resources (e.g., web server) that are only available on the private network.

Similarly, in one application, successfully authenticating to the service provider (step 0705) may be first required in order to establish a VPN connection (step 0707). In another application, a VPN connection may need to be established (step 0707) before authenticating to the service provider (step 0705), because the authentication process in this specific application depends on having access to resources accessible exclusively within the VPN (e.g. directory server).

8). Exemplary Migration Agent

The underlying principle governing the operation of the migration agent 1101 assumes that the functionality of application software integrated into the operating system environment provided by the security device is substantially isomorphic to the functionality of migrated application software.

Migrating the application content and configuration data between two software applications which are substantially isomorphic may allow a significant portion of the functionality provided by one software application to be provided by the other.

The security of any given application is dependent on the security of its design and implementation, as well as the security of the underlying operating system on which it is built. A significant increase in security may be thus be achieved by migrating the functionality of one software application to another potentially more secure software application that can provide substantially equivalent functionality and is integrated into the independent secure operating system environment provided by the security device 0101.

In one migration scenario, in which a user boots from the security device a computer previously operated by a mainstream operating system environment installed to the computer's internal storage devices, the migration agent 1101 may assist the user in migrating application content and configuration data located within the filesystems on the computer's internal storage devices.

In another scenario, a user may migrate application content and configuration data from a backup archive created by the migrated software application itself. Many software applications provide backup or data exporting functionality which generates an archive from which the migration agent 1101 may extract the necessary data.

Software applications that may be migrated include client side applications such as, for example, browsers (e.g., Microsoft Internet Explorer, Opera, Mozilla Firefox), mail clients (e.g., Microsoft Outlook, Thunderbird), instant messenger clients (e.g., ICQ, AIM, MSN messenger), VoIP clients (e.g., skype) or any other client side application.

In one embodiment, the migration agent 1101 may be invoked automatically during the security device's boot process, if it is detected that internal storage devices contain a local operating system on which applications that can be migrated may exist. If the user chooses to cancel automatic execution of the migration agent 1101 during boot, the migration agent 1101 may instead be invoked on demand by the user, for example, using a GUI option (e.g., menu item, desktop icon, management console).

FIG. 11-I is a flow diagram illustrating exemplary steps in the operation of the migration agent 1101 software, which may be used, in one embodiment, to assist users who are migrating the functionality of applications from other operating systems (i.e., a general purpose mainstream platform) to the independent secure operating system environment provided by the security device 0101.

First, the find migration candidates procedure 1102 may be called.

FIG. 11-II illustrates exemplary steps in the find migration candidates procedure 1102, which may be used to locate applications that can be migrated.

In one embodiment, before attempting to locate migration candidates, the procedure 1102 may first initialize an empty migration candidates list (step 1120), and load migration signatures (step 1121) from the security device, the network, or storage media.

If the migration signatures are loaded from an untrusted source (e.g. the network), the integrity of the signatures may be validated by verifying an associated cryptographic signature.

Migration signatures may be used to locate applications that can be migrated on internal storage devices, and may be used to assist in determining the corresponding locations of application content and configuration data.

Next, the user may interact with dialog-1 (step 1122), and choose either to search for migration candidates on internal storage drives automatically (option 1123), or browse manually for exported application data and backup archives (option 1160).

In one embodiment, if the user selects to search for migration candidates automatically (option 1123), internal storage 0208 devices may be probed to compile a list of partitions which exist on all disk drives (step 1124). Then, for each partition (loop 1125), if the filesystem type contained within the partition is supported (conditional 1126), the partition filesystem is mounted (step 1127) and a list is updated with the mounted filesystem's information (step 1128).

Next, the search partitions for signatures procedure 1130 may be called.

FIG. 11-III illustrates exemplary steps in the search partitions for signatures procedure 1130, which may be called to search mounted partitions for migration candidates using the previously loaded (step 1121) migration signatures.

In principle, the procedure 1130 may attempt to automatically locate migration candidates by enumerating the resources of the local operating system stored in the computer's 0102 internal storage devices and matching these enumerated resources against the previously loaded migration signatures.

First, for each of the previously mounted partitions (loop 1140), the procedure 1130 iterates through the previously loaded migration signatures (loop 1141).

In one embodiment, the procedure 1130 may attempt to locate each migration candidate using multiple signatures, which may also be different from one another in type. For example, to locate a specific application, the registry may first be searched, then the GUI interfaces, and finally the names of files and folders within the filesystem. Using a list of signatures to search for each migration candidate allows searching through multiple types of resources against a range of possible signatures for each resource, with each signature matching a different application version or installation location.

For each signature (loop 1142) in the list of signatures for each migration candidate, an application signature match (step 1146) may be attempted according to a signature's associated signature type. The signature type specifies which type of resource a signature is intended to match against.

If the signature type specifies that the registry should be searched (conditional 1143), a signature match may be performed, for example, by attempting to locate the Microsoft windows registry within the partition (conditional 1144), enumerating the Microsoft windows registry to extract registry keys and values (step 1145), and attempting to match the extracted registry keys and values against the signature (step 1146).

If the signature type specifies that the GUI should be searched (conditional 1150), a signature match may be performed, for example, by attempting to locate the files and folders (conditional 1151) specifying elements of the GUI interface of the local operating system environment which may be stored in the partition, enumerating the specified GUI interfaces (step 1152) to extract GUI elements (e.g. desktop icons, menu items, etc), and attempting to match the extracted GUI elements against the signature (step 1146).

If the signature type specifies that names of files and folders should be searched (conditional 1154), a signature match may be performed, for example, by recursively enumerating the directory and file names within a partition's filesystem, and attempting to match the names of files and directories against the signature (step 1146).

Other types of signatures may also be used, for example, in one embodiment it may be useful to attempt to match a signature against the contents of Microsoft metabase configuration and schema files such as metabase.bin, metabase.xml and mbschema.xml, or by enumerating the structure of any other resource within the partition and performing pattern matching against its contents.

Note, that the illustrated steps are primarily intended to illustrate the principle of operation, and are merely exemplary in nature, as previously described. For example, re-enumerating for each signature, resources such as the registry or the names of files and folders within a filesystem, may be prohibitively time consuming and inefficient with a significant number of signatures. In practice, a more efficient variant of this procedure may be used which is optimized to minimize how many times a resource such as the registry or the filesystem has to be enumerated and pattern matched against. More efficient variants of this procedure may also employ well known caching strategies (e.g., which trade off memory space for speed) to improve performance.

If a migration candidate signature is matched (conditional 1146), a migration candidate application has been located and the list of migration candidates is updated with the attributes (e.g., application type, name, version, filesystem location of application content and configuration data) of the located application (step 1147).

Finally, the procedure 1130 returns the list of migration candidates that have been located (step 1159).

Referring back to FIG. 11-II, if on the other hand, the user chooses in dialog-1 (step 1122) to browse for exported application data or backup archives (option 1160), a browse dialog (step 1161) may function to provide the user with a navigational interface which the user may interact with to specify the location of exported application data or backup archives on local storage (e.g., CDROM, DVDROM, hard drive, USB flash disk) or remote storage (e.g., network file share, ftp site).

Note, the browse dialog (step 1161) may also perform rudimentary pattern matching against the filenames and contents of files to which the user navigates to prevent the user from selecting unknown files and folders or the exported application data of software applications which are not yet supported by the migration agent 1101.

Next, the migration candidates list is updated (step 1162) to include the exported application data specified by the user.

At the end of its operation, the procedure 1102 may return a list of migration candidates (step 1131 or step 1163).

Referring back to FIG. 11-I, default migration configuration settings may next be loaded (step 1104) if they exist (conditional 1103) from a predetermined storage location (e.g., the PSS element), specifying the default values for configuration settings which may later be adjusted by the user in dialog-2 1105 and dialog-3 1180.

Default migration configuration settings may include, for example, which applications are selected for migration by default in dialog-2 1105, the default synchronization options for each application in dialog-3 1180, and other application specific configuration parameters.

Next, the user may interact with dialog-2 (step 1105) to select which applications to migrate (option 1106) from the list of migration candidates created in the previously described procedure 1102.

Next, for each application previously selected for migration in dialog-2 (loop 1107), the migrate application data procedure 1108 may be called and passed the attributes of the selected migrated application.

FIG. 11-IV illustrates exemplary steps in the migrate application data procedure, which accepts the attributes of a migrated application as its arguments.

First, the user may interact with dialog-3 (step 1180), which may display basic application information 1181 including, for example, application type, name, version, and filesystem location of content and configuration data.

In one embodiment, dialog-3 may additionally allow the user to configure synchronization options 1182 for the migrated application's content and configuration data, and set other application specific migration configuration settings.

The user may configure the synchronization options 1182 to control a synchronization mechanism used to synchronize application content and configuration data between the files of the migrated application software installed to internal storage devices and the files of the isomorphic target application software integrated into the independent secure operating system provided by the security device 0101.

After synchronization, the application content and configuration data within the data files of the synchronized applications may be substantially equivalent semantically. In other words, though the data may be encoded in the different native syntax (e.g., binary data formats) supported by each application, the meaning (i.e., semantics) of the data in the context of the synchronized application may be perceived as roughly equivalent by the user.

The effect is that changes made to application content and configuration data within the context of either the local operating system environment installed to the computer's internal storage devices or the independent operating system environment provided by the security device have been merged to allow users to more conveniently switch back and forth between the two operating system environments without having to suffer inconsistencies in application content and configuration data.

The user may configure synchronization options so that synchronization of application content and configuration data is either performed on demand by the user, or is triggered automatically according to a predetermined schedule or according to system events (e.g., included as a step in system initialization and shutdown scripts).

Triggering synchronization of application data according to a predetermined schedule may be implemented using a chronological scheduling facility such as, for example, the UNIX cron daemon.

In one embodiment, the synchronization options 1182 may further allow the user to specify the desired synchronization conflict resolution behavior. Synchronization conflicts may occur when two versions of application content or configuration data are mutually incompatible, such that it is impossible or unsafe to attempt to merge them into one version. The specific criteria for a synchronization conflict may vary between different types of applications and associated data.

The user may specify to prefer in case of conflict, for example, the application content and configuration data of the application software installed to internal storage, or vice versa. Synchronization conflict resolution may also be configured to interact with the user in order to make a decision when a conflict occurs.

Next, any of the previously specified migration parameters configured by the user in dialog-3 (step 1180) may be used to update default migration configuration settings (step 1183).

Next, application content and configuration data may be migrated from the data files of the migrated application to the data files of the target application integrated into the operating system environment provided by the security device.

Migrating application content and configuration data from the files of a migrated application may require software routines which provide the functionality to parse (i.e., decode) the file formats of the migrated application in order to read the desired application content and configuration data. On the other hand, migration of application content and configuration data in the opposite direction (i.e., to the files of the migrated application, during a synchronization) may require software routines which additionally provide the functionality to edit or rewrite the migrated application's file formats. Developing these routines for proprietary file formats may require significant effort (e.g., reverse engineering) in some cases.

As an alternative to reverse engineering proprietary file formats, it may be preferable in some cases to reverse engineer the software APIs of the software libraries which perform the required functionality for the migrated application, and leverage the software functionality of the migrated application itself by calling the routines of the migration application's native parsing software. Implementation of this approach may involve, for example, a translation or emulation layer for binary executables and software libraries if the local operating system installed to internal storage is incompatible in this respect with the operating system provided by the security device and dynamic loading of the migrated application's software archives (e.g. libraries, executables).

Note, that using native parsing software (e.g., software libraries) from the migrated application may introduce security risks if binary integrity is not verified. An attacker that has managed to compromise the security of the local operating system on top of which the migrated application is installed, may also violate the integrity of the migrated application's software libraries by, for example, replacing them with trojan horse versions or inserting malicious code into them. To mitigate this threat, a hash of the software libraries may be calculated and compared with a whitelist of known good hashes. The hash whitelist itself may be updated periodically over the network with new hashes for updated software versions.

Following these principles, in one embodiment, if support for leveraging the native parsing software of the migrated application is available (conditional 1184), the procedure 1108 may load a white-list of known good hashes (step 1185), calculate hashes for the native parsing software (step 1186), and may verify the integrity of the calculated hashes by looking them up in the previously loaded white-list.

If the calculated hashes can not be verified against the white-list (conditional 1187), it is possible that the integrity of the native parsing software may have been compromised by an attacker as previously described, and an exception may be raised (step 1193).

If on the other hand, the hashes are verified to be good (conditional 1187), the procedure 1108 may load the native parsing software (step 1188), and call routines for parsing the data files of the migrated application (step 1189).

Referring back to conditional 1184, if support for leveraging native parsing software is not available, the data files of the migrated application may be parsed using local routines (step 1194). In some cases, developing these routines may require reverse engineering proprietary file formats, as previously described.

Data from the files of the migrated application may be parsed (i.e. decoded) into a list of data elements which are loaded into memory.

Next, continuing execution from step 1189 (i.e., parse data files using native parsing software) or step 1194 (i.e., parse data files using local routines), the elements of data parsed from the data files of the migrated application may then be translated (step 1190) or mapped into the closest analog that is supported by the target software application the data is being migrated to.

Finally, the translated data is saved (step 1191) to the data files of the target application stored at a predetermined storage location (e.g., the PSS element).

Though the data may now be encoded in a different syntax (i.e., the binary data formats) supported by the target application, the meaning (i.e. semantics) of the data in the context of the target application may be perceived as roughly equivalent by the user.

In one embodiment, the software for performing the previously described operations may be updated in cryptographically signed packages over the network.

The exact nature of migrated application content and configuration data may vary significantly according to the type of application.

Application content may include, for example, files and folders, email content, database tables, and digital certificates.

Application configuration data may include, for example, user accounts, email accounts, access control lists, quota configurations, bandwidth throttling configurations, logging configurations, database connectivity configurations.

In one embodiment of the invention, the target application may be extended with special support for non-translatable application content or configuration data.

For example, translating the password hashes from the Microsoft SAM (Security Accounts Manager) database to the password hash format supported natively by a Linux application (e.g., SHA1 or MD5) may not be practical, as hashes are calculated using a non reversible one way function. In this case, migrating user accounts while preserving the original passwords may require extending the target application's authentication mechanisms to include support for the SAM password hashes.

9). Exemplary Runtime OS. Architecture

With the completion of the system initialization process previously described above in the Exemplary system initialization section with reference to FIGS. 7A, 8A, 9A-I, 9A-II, 10-I, 10-II and 10-III, an operational secure operating system environment may provide the user with the functionality required for the specific tasks a specific embodiment has been optimized for.

FIG. 12 is a high-level block diagram illustrating the exemplary runtime operating system architecture initialized by the boot process that has been previously described in the Exemplary system initialization section above.

As is well known in the art, the high-level runtime architecture of an operating system environment may comprise of kernel-land 1210 software elements that interface with user-land 1230 software elements through an operating system API 1220.

Kernel-land 1210 elements are primarily contained within the Operating System kernel 0503 previously introduced in the Exemplary outer filesystem section with reference to FIG. 5, which is loaded into memory along with modular kernel-land 1210 elements such as drivers, which may be loaded later than the basic kernel 0503, during the boot process, or even on-demand.

Kernel-land elements 1210 may provide the operating system infrastructure services that the functionality of User-land elements 1230 depends on, such as, for example, hardware abstraction, memory management, multi-tasking or real-time process scheduler, filesystem support, Inter Process Communication, network protocol stack, security mechanisms, and so forth.

As is well known in the art, Kernel-land elements 1210 may provide the shared context in which user-land elements may operate. Without this context, each software program would have to vertically integrate all of the functionality it depends on within itself, which would be very difficult to program, highly inefficient and make it difficult for multiple software programs to simultaneously co-exist on a single computer.

Kernel-land 1210 is also the ideal place to integrate some types of security mechanisms, because a security mechanism implemented in kernel-land may influence the security of the whole system, and the security of user-land 1230 elements without requiring those elements to be changed. For example, PAX 1336 is a memory bounds violation exploitation countermeasure, which prevents execution of arbitrary code in unauthorized memory regions (i.e., a common exploitation technique). Supporting PAX 1336 in the kernel 0503 may significantly increase how difficult it is for an attacker to exploit some types of security vulnerabilities in imperfectly implemented user-land 1230 software.

Referring back to FIG. 12, kernel-land 1210 multi-layer security mechanisms, may include, for example, Mandatory Access Control (MAC) 1335, PAX 1336, Trusted Path Execution 1337, PIE-ASLR 1330, and other security mechanisms.

These security mechanisms and others are further described in the Exemplary security layers section below with reference to FIG. 13.

User-land 1230 elements, may include, for example, workspace infrastructure 0623 and workspace 0415 level elements previously described with reference to FIG. 6A in the Exemplary functional overview section above, such as a graphics subsystem for providing a GUI 0603, connectivity agent 0604, migration agent 1101, clients 0606, productivity suite 0608, file/network explorer 0607, advanced options 0610, management console 0609, exit options 0611, and wizards 0612.

10). Exemplary Security Layers

A primary objective of the invention is to provide a safe platform for high risk applications with demanding security requirements.

As previously described in the Background of the invention the security of any given computer system can be measured by how difficult it is for an attacker to achieve objectives that conflict with the objectives of the defense.

The sum of all resources (time, specialized labor, equipment, finances, etc.) expended in a particular attack is called the cost of attack.

For any given malicious objective and computer system, the minimum cost of attack is the easiest (least expensive) path to achieving the malicious objective against the computer system.

In respect to a specific threat model, a system can be said to be secure, if the minimum cost of attack is either greater than the resources at the attacker's disposal, or greater than what it is worth for an attacker to successfully compromise the system.

In practice, it is difficult to make precise quantitative estimations regarding the minimum cost of attack, what a compromise is worth to an attacker, or what resources potential attackers will have at their disposal. A good deal of qualitative judgment is thus required in analyzing the security of a system. Experts must assign probabilities to approximate estimations, and provide generous margins for error.

FIG. 13 is a block diagram illustrating exemplary multi-level security layers for one embodiment of the invention.

In order to achieve a minimum cost of attack that satisfies the especially demanding security requirements of high risk applications, an embodiment of the invention may apply appropriate design assumptions and principles 1340, combine carefully crafted assurance 1350 and production 1320 processes, physical 1321 properties and redundant software security mechanisms at the network 1322, operating system 1323, application 1324 and human interface 1325 levels, structured in a fault-tolerant independent security architecture 1342 (i.e., multi-layered security architecture).

As previously explained, security is a holistic emergent property of the entire system that needs to be carefully structured from the ground up according to the appropriate principles. The security of a computer system depends on how its components are designed, implemented, integrated together, configured and used, and how closely the actual behavior of the resulting system is aligned with what is desired in relation to the system's security objectives.

Design level 1340

As such, achieving security begins at the design level 1340. Certain assumptions may be taken into account during the design process, and certain principles may be followed. The security provided by an embodiment of the invention will reflect these assumptions and principles.

Design 1340 assumptions may include, for example, that due to the inherent complexity and consequent imperfection of software, an attacker is in the possession of private exploits, which take advantage of vulnerabilities that are unknown to the public. Assumptions may further include, for example, that an attacker has perfect control over the network, in other words, the ability to intercept and manipulate traffic on the network arbitrarily, or that an attacker is experimenting against a perfect mirror of the attack target in his laboratory, trying to develop a successful attack routine. Furthermore, it is prudent to make generous assumptions regarding the sophistication and resources at an attacker's disposal. For example, that an attacker is not an individual, but rather a funded organization employing competent security researchers skilled in the arts.

Design 1340 principles may include, for example, the Keep It Simple Stupid (KISS) 1341 principle, the principle of structuring system elements in an independent security architecture 1342, and other security principles.

In the context of security, KISS 1341 means that an embodiment should be as simple as possible. This principle may be applied, for example, by minimizing the functionality provided to what is required for the specific tasks an embodiment is optimized for, reducing the amount of parts used in general, reducing the elements security is dependent on in particular, using simpler parts, minimizing interactions between parts, and so forth.

For example, in a specific embodiment based on a Unix-like operating system kernel, the KISS 1341 principle may be applied by minimizing the client and server programs that may interface with the network, minimizing runtime services (e.g., daemons), especially those that require special privileges to run, minimizing privilege escalation mechanisms such as SUID root (Set-UID to root) programs, isolating sensitive programs in jails 1332, minimizing the amount of software functionality provided (e.g., for example, no interpreters or compilers), using simpler programs to provide the required functionality, restricting execution of arbitrary software using TPE 1337, and so forth.

Applying the KISS 1341 principle may reduce the complexity of an embodiment significantly. As previously described, the more complex something is, the harder it is to fully understand. Thus, complexity tends to decrease the minimum cost of attack, by increasing how difficult it is to align a resulting system with what is desired in relation to a system's security objectives.

As previously described in the Background of the invention section above, a security architecture is the pattern of elements that security depends on in relation to any given attack strategy.

In an interdependent security architecture, the minimum cost of attack is the cost of breaking the weakest element.

A security architecture is said to be interdependent if the elements that security depends on are interdependent on one another such that breaking the weakest element will break the security objectives of the whole. In this sense, an interdependent security architecture is like a chain (as strong as its weakest link), or a house of cards (pull one card out and the entire structure collapses).

In contrast, in an independent security architecture 1342, the minimum cost of attack is the combined cost of attack for all elements that come into effect along the dimension of the given attack strategy.

A security architecture is independent if its elements are structured such that they contribute to the security of the system independently of one another. This is also called a multi layered security architecture 1342.

If compromising the security objectives of a computer system requires an attacker to separately overcome a series of redundant security obstacles then the security architecture is multi layered in the dimension of that attack. This is accomplished by designing each layer to redundantly enforce the desired behavior in a way that compensates for potential failure elsewhere.

In order to achieve any significant level of security, the components of a system must be carefully structured, so that sufficient independent reinforcement of desired behavior exists at multiple layers, relative to potential attack scenarios. This is necessary because sufficiently complex software can not be implemented such that its potential behavior is perfectly aligned with what is desired.

In other words, a multi layered security architecture 1342 may be the only practical strategy for providing reliable computer security.

Assurance level 1350

Security can be defined as the converse of vulnerability. Evaluating security is hard, because contrary to a functional requirement, which can be positively tested for, one can not positively test for the absence of vulnerability. This means it is possible to prove a program is vulnerable, but impossible to prove it is secure.

The only way to test security is to assume the role of the attacker, and repeatedly attack the weakest links of a system with sophistication and resources comparable to those of a potential attacker that is trying to take advantage of unintended aspects of a system's actual behavior to trick it into providing unauthorized access.

Testing for vulnerability provides assurance 1350, and may include, for example, techniques that are well known in the art such as source code auditing 1351, vulnerability assessment 1352 and penetration testing 1353.

Source code auditing 1351 is the process of auditing source code looking for imperfections (bugs) that may lead to exploitable security holes. The object of source code auditing 1351 is to uncover vulnerabilities in order to fix them and narrow the gap between what is and what is desired. The easiest class of vulnerabilities to find are those that follow predictable, well known patterns, such as, for example, buffer overflows. Finding and fixing the most obvious security vulnerabilities may significantly increase the minimum cost of attack, forcing an attacker to spend more resources looking for a more sophisticated type of vulnerability. Finding the most common class of vulnerabilities may be assisted by special purpose tools that automate part of the work, for example, protocol fuzzers such as SPIKE.

The objective of vulnerability assessment 1352 is to provide a comprehensive survey of vulnerability that reflects what is being protected (assets), who is it being protected from (threat model), and an estimation of the associated cost of attack for different attack strategies (vulnerability). For a given computer system in the context of its intended applications, a successful comprehensive vulnerability assessment 1352 process may result in an approximate estimation of the gap between what is and what is desired (in the dimension of security) at the design, specification, implementation, configuration and usage levels of a computer system. Vulnerability assessment 1352 is useful because it creates transparency that enables informed decisions to be made regarding where it is most beneficial to invest resources to achieve a higher level of security (higher minimum cost of attack).

Penetration testing 1353 is the assurance process 1350 most similar to a genuine attack. The objective of a penetration test 1353 is to actually break security objectives, which may assist in proving the practical ramifications of security vulnerabilities. In contrast to a vulnerability assessment 1352, which aims to systematically discover all paths to a successful attack, a penetration tester, like a genuine attacker, may only need to find one path to achieve his objective. Penetration testing 1353 is most useful when there is uncertainty regarding the implications of security vulnerabilities. Penetration testing 1353 may motivate a required investment in security that would otherwise have only been made in the aftermath of a genuine attack.

Applying assurance 1350 processes described above to an embodiment of the invention may assist in significantly increasing the security provided by an embodiment of the invention.

Production level 1320

Security may be compromised if an embodiment of the invention is not produced securely.

To mitigate this risk, security measures at the production process level 1320 may include, for example, source verification 1301, high risk application development environment 1302, secure delivery 1303, and authenticity verification 1304.

Source verification 1301 may include, for example, verifying the reputability of the software developers for a component, manual inspection of the software source code for components that are integrated into the system, to detect malicious functionality such as trojan horses, backdoors, spyware and others. It is preferable to minimize use of components for which source code is not available, as software in binary form is much harder to inspect. Inspection of software in binary form may involve reverse engineering techniques such as de-obfuscation, disassembly, system call tracing, and others.

Note, that inspecting a series of incremental changes to the source code (the patch history) is significantly easier than re-inspecting the entire source code for a software component every time a new version is released.

Source verification 1301 may mitigate the threat that a software component with malicious functionality compromises the security provided by an embodiment of the invention. This may occur, for example, if a component is included that is developed or maintained by an unscrupulous programmer, if an attacker manages to compromise the source code repository for an included component, or if an attacker manages to intercept and compromise the integrity of a component in-transit to the development environment.

An additional security measure that increases how difficult it is for an attacker to compromise the integrity of software components is authenticity verification 1304.

Some software developers sign software releases to allow file authenticity to be verified by cryptographic means that are well known in the art. For example, a software developer may compute a hash for the file containing the software release and then sign the hash cryptographically with his private key. The signed hashed is disseminated along with the software release. This allows his public key to be used to verify authenticity of the signed hash, which can be then compared with an independently computed hash of the file that has been downloaded from the main repository or a mirror, to determine the file's authenticity.

It should be noted that in order to use public key cryptography to verify the authenticity of a software release, it is necessary to first acquire and verify a copy of the developer's public key. This is not always possible as not all software developers cryptographically sign their software releases. As the integrity of the public key itself may be compromised by an attacker, it is necessary to verify its authenticity before relying on it, preferably using out of bands means. Some forms of public key cryptography, such as PGP, support a web of trust model that may reduce how difficult it is to verify the authenticity of any specific public key.

The risk associated with producing and transporting an embodiment of the security device 0101 is at least as high (arguably higher) as the risk associated with the application the security device 0101 is intended to be used for. As such, it is preferable to develop the security device 0101 in a secure facility optimized to perform as a safe environment for developing high risk applications 1302, and deliver the resulting products in a secure delivery process 1320 suitable for high-risk applications.

Otherwise, if an attacker compromises the production facility, or intercepts a shipment of security devices 0101, it may be possible for him to violate the integrity of the security device 0101, and circumvent the security it is designed to provide.

It is thus preferable to carefully optimize the delivery process and production environment itself for security, provided in an fault-tolerant interdependent security architecture with multiple layers that redundantly enforce desired security objectives.

Physical level 1321

Physical level 1321 security measures may include, for example, a physically read-only type of media 0303/0308 on which the outer filesystem 0500 is contained, and marks of authenticity such as a hologram 0305 and a signature 0307. These security measures have been further described in the Exemplary physical embodiments of the security device section above with reference to FIGS. 3A, 3A′ and 3B.

Network level 1322

Network level 1322 security measures may include, for example, a Virtual Private Network client 0605, and a personal firewall 1306.

A VPN client 0605 may be, for example, integrated as a kernel driver that provides support for the IPSec protocol. As previously described in the Exemplary functional overview section above with reference to FIG. 6A, the VPN client 0605 may function to, for example, establish a secure connection to a Virtual Private Network (VPN) through another network 0103 such as the PSTN, an Intranet, the Internet, or other type of network or combination of networks. First, this is useful because a VPN connection may be the only way to interface with some security sensitive networks from the outside. Second, a Virtual Private Network may be used to provide an additional layer of security by logically isolating the computer systems in the virtual private network from the range of threats on a potentially hostile public network.

A personal firewall 1306 may be used to enforce network access control for applications, preventing unauthorized access to and from the network. For example, using a personal firewall it is possible to prevent an attacker from interfacing with programs that have an interface to the network, such as a printing daemon. A firewall policy might allow access to the network only for trusted programs that are required to have it. This may act to enforce security objectives redundantly as even if an attacker somehow manages to execute a trojan horse on the computer system, without access to the network it may be difficult for the trojan horse to communicate back to the attacker.

A personal firewall 1306, may be, for example, a Linux iptables firewall operating at the network level in the kernel, a suitable Mandatory Access Control policy, a patch to the kernel to limit access to network sockets according to process group associations (grsecurity offers this feature), or another form of network access control mechanism.

Note, that it is preferable not to rely on the personal firewall to prevent applications from interfacing with the network. For example, some programs may use the network stack for Inter-process communication by default, even when there is no need for providing remote connectivity to client programs over the network. A personal firewall may be configured to block attempted access from the network to the network ports these programs may be listening on but it is preferable to configure or modify these programs so that they do not use the network interface at all, and instead communicate through a host-only form of Inter-process communication such as filesystem pipes or sockets (e.g. UNIX sockets).

Operating system level 1323

As previously explained in the Exemplary runtime OS architecture section above with reference to FIG. 12, kernel-land elements 1210 such as the operating system kernel 0503 may provide the shared context in which user-land elements 1230 may operate. As such, the kernel 0503 is the ideal place to integrate some types of operating system level 1323 security mechanisms, because security mechanisms at this level 1323 may influence the security of the system as whole in general, and the security of user-land 1230 applications in particular.

Operating system level 1323 security mechanisms may include, for example, Mandatory Access Control (MAC) 1335, PAX 1336, Trusted Path Execution (TPE) 1337, Position Independent Code-Address Space Layout Randomization (PIE-ASLR) 1330, Discretionary Access Control 1331, Jails 1332, Exploit countermeasures (ECM) 1333, and raw IO/Memory protections 1334.

MAC 1335 can be used to restrict what resources programs are allowed to access based on a global set of rules called a MAC policy.

This makes it possible, for example, to carefully restrict the privileges of each program to the minimum it needs to carry out its function, which limits what a program can be tricked into doing regardless of how it is internally implemented.

A carefully configured MAC policy isolates the potential damage that the compromise of any individual program might otherwise have had on the rest of the system, protects the integrity of the system and its security controls from tampering, and intrinsically reduces the complexity of a system by reducing the potential for undesired behavior and interaction between components.

Additionally, the software that implements MAC 1335 in the Operating System kernel 0503 is orders of magnitude less complex than the software that it restricts, and interacts with the rest of the system in a clean and simple way. This makes it easier to understand and easier to audit, therefore reducing its potential for vulnerability.

MAC 1335 may be, for example, integrated into a Linux kernel by applying the grsecurity patch, the RSBAC patch, the NSA's Security Enhanced Linux patch, and other patches that implement Mandatory Access Control.

MAC 1335 may also be provided, for example, by other operating system kernels that support it, such as trusted Solaris, trusted HP-UX, and others.

Jails 1332 may function to contain a program within a logical compartment, such that is it isolated from the rest of the system, at least at the filesystem level. Similar to MAC 1335, this may assist in containing the damage from a potential compromise of a jailed program to the logical compartment it is jailed in.

Types of logical compartments suitable for use as jails 1332 may include, for example, the UNIX chroot mechanism, User Mode Linux, XEN and others.

In contrast to MAC 1335, it may not be practical to apply jails 1332 globally to all programs on a system. Usually, each separately jailed program requires its own virtual root filesystem, containing copies of all the libraries and dependencies it needs in order to run. As such, jails 1332 are relatively inefficient and in practice their use is limited to specific classes of high risk programs such as network server software (the BIND DNS server is a well known example).

Note, that advanced techniques exist for breaking out of traditional UNIX chroot jails under certain conditions that have been used by exploits in the past. Jail hardening patches exist to prevent these techniques from working, and have been integrated, for example, into the grsecurity and openwall Linux kernel patches.

PAX 1336 is a memory bounds violation exploitation countermeasure, which prevents execution of arbitrary code in unauthorized memory regions (i.e., a common exploitation technique). Supporting PAX 1336 in the kernel 0503 may significantly increase how difficult it is for an attacker to exploit some memory bounds violation vulnerability types in imperfectly implemented user-land 1230 software.

PAX 1336 patches exist for several types of operating system kernels 0503, including, for example, Linux.

Other memory bounds violation exploitation countermeasures that provide similar or equivalent protections to PAX 1336 may also be used as an alternative.

Note, that some programs, such as, for example, the Java virtual machine runtime, or the X graphics subsystem, may require the ability to execute code in memory regions usually reserved for the storage of data (the heap or the stack, for example). For these programs, some or all of the memory protections provided by PAX 1336 may need to be disabled.

PIE-ASLR 1330 is a complimentary countermeasure for a similar class of common exploits. PIE-ASLR 1330 randomizes the address space layout of specially compiled executables (compiled as Position Independent Code), which may significantly increase how difficult it is for an attacker to exploit some memory bounds violation vulnerability types in imperfectly implemented user-land 1230. PIE-ALSR may provide an effective countermeasure for some types of sophisticated exploits that PAX 1336 may not provide protection for (e.g., return-to-libc).

Support for Address Space Layout Randomization may be provided by the PAX 1336 patch itself, but as previously described, enjoying the benefits may require programs to be specially compiled as Position Independent Code.

Trusted Path Execution (TPE) 1337 is a security mechanism that prevents execution of programs that are not in trusted filesystem paths. For example, TPE 1337 may be used to prevent accidental execution of trojan horses or other forms of malware by the user, or prevent an attacker that has achieved local access from executing a privilege escalation exploit, such as a kernel exploit that might take advantage of a vulnerability in the kernel to disable multi layered security mechanisms.

The Linux kernel, for example, can be made to support TPE 1337 by applying the grsecurity patch, the openwall patch, or other security hardening kernel patches.

Raw IO/memory protections 1334, may be used to prevent direct raw access to memory or hardware 10 interfaces. Allowing such raw access could allow an attacker that has achieved sufficient privileges at the host-level to a computer system to modify the contents of memory on the fly, for example, to disable multi layered security mechanisms such as MAC 1335 in the kernel, or install a backdoor directly into the runtime memory of an executing kernel to compromise the security provided by the computer system.

Support for raw 10/memory protections 1334 may be, for example, included within the Openwall and grsecurity patches for the Linux kernel.

Note, that some programs, such as, for example, the graphics subsystem, may require direct raw access to memory in order to operate efficiently. For these programs raw IO/memory protections 1334 may need to be disabled.

Exploit countermeasures (ECM) 1333, may function to further increase how difficult it is for an attacker to exploit vulnerabilities in imperfectly implemented kernel-land 1210 and user-land 1230 software.

Exploit countermeasures (ECM) 1333 may include, for example, hardening against specific class of race condition vulnerabilities such as disallowing programs to follow links in world writable directories, hardening against resource starvation attacks such as fork/memory bombs, or other hardening mechanisms that prevent a common class of exploits from working. Other examples may include hardening against leakage of system information that could make it easier to identify and exploit vulnerabilities such as, process information (e.g., /proc), network information (e.g., netstat), dmesg, network stack fingerprinting, predictable scheduler process IDs, kernel symbol values, and other information that may be useful to an attacker

Support for exploit countermeasures 1333 may be built-in into a standard version of specific operating system kernel, or applied as patches to the source code of kernels that have not included this functionality by default.

For example, some exploit countermeasures 1333 may be included with the grsecurity and openwall kernel patches for the Linux kernel.

Discretionary Access Control (DAC) 1331, is the standard type of access control mechanism supported by most operating systems by default.

As its name implies, in contrast to MAC 1335, the access control in DAC 1331 is discretionary, which means each resource (e.g., file) has an owner user account associated with it and access control is configured separately for each resource, at the discretion of the owner. In DAC 1331, access to resources is granted broadly to OS processes based on the associated owner of the process. In other words, privileges are associated with user accounts, not specific programs or processes.

One of the primary problems with DAC 1331, is that relying on it leads to a weak interdependent security architecture, which can not be relied on to strongly enforce the security objectives of a computer system.

Basic operating system components are usually owned by an all-powerful root or administrator account, which has also been endowed by operating system designers with many special privileges that it was deemed inappropriate for regular user account to have including the ability to bypass access control restrictions for resources owned by non-root/administrator users.

Programs that require access to root/administrator owned resources or any of the special privileges reserved for the root/administrator account must run with the full privileges of the root/administrator account.

Unfortunately, running a program as root/administrator makes it much more powerful than it usually needs to be.

Thus, according to the DAC 1331 model, the security of the entire system is dependent on the perfect implementation of every program that runs with root/administrator permissions. This results in an inherently weak interdependent security architecture that is unsuitable for high risk applications, as previously explained.

An additional problem with DAC 1331, is that its access control policies are distributed across the filesystem, defined separately for each resource. In contrast to MAC 1335, there is no centralized policy that can be easily defined, reviewed and audited. This makes the effect of DAC more difficult to fully comprehend, and consequently tends to increase the gap between what is and what is desired.

In an independent multi layered security architecture 1342 DAC 1331 may be useful as an additional layer of security if used in conjunction with other security mechanisms described in this section, such as, for example, MAC 1335.

Application level 1324

Security measures at the application level 1324 may include, for example, compiler protections 1308, encryption 1309, n-factor authentication 0302, embedded certificate 1305 and other application-level security measures.

Compiler protections 1308 may function to harden an application against a specific class of common security vulnerabilities, such as, for example, buffer overflows.

Note, that benefiting from compiler protections 1308 requires compiling software with a compiler toolchain that supports such protections.

For example, patching the GNU compiler toolchain with the SSP or stackguard patches may provide additional runtime protection against exploitation of buffer overflows by using bounds overrun checking techniques (e.g., inserting canaries with random values at the bounds of buffers).

Encryption 1309 may be used by an application to prevent interception and preserve the integrity of data stored on media or communicated through a medium. For example, a browser may use the SSL encryption protocol to provide end-to-end transport layer encryption to web servers that support it, an email client may use S/MIME to sign email messages so that the identity of the sender may be verified cryptographically and to encrypt messages such that they can only be decrypted by the intended recipient's private key, which an attacker that is merely intercepting email traffic should not have access to.

N-factor authentication 0302 is another useful application-level security mechanism that has been previously described in the Exemplary physical embodiments of the security device section with reference to FIGS. 3A and 3B.

An embedded certificate 1305 may be integrated into client applications 0606 such as a browser, in order to provide an indication to the service provider 0104 whether the user is connecting to the service provider 0104 from a specific embodiment of the security device 0101. This may be used by the service provider 0104, for example, to exclusively restrict services to clients that are connecting to the service provider using a suitable security device 0101. For example, an online bank might not allow certain types of accounts to perform high-risk banking transactions unless users have connected to the bank using a suitably secure embodiment of the security device 0101.

An embedded certificate 1305, may be, for example, an X509 certificate and private key pair that are compiled into a web browser such as Mozilla Firefox, so that when the browser connects to the service provider 0104 using a transport layer encryption protocol such as SSL, it will identify the embedded certificate 1305 as its client side certificate and be capable of completing a challenge response exchange.

As it may be possible for a sophisticated user to extract the embedded certificate 1305 from the security device 0101, for example, by using reverse engineering, it is thus preferable that security does not strongly rely on this mechanism.

For the security device 0101 embodiment of FIG. 3A, a stronger alternative may be to prevent the identity keys stored in the integrated cryptographic component 0302 from being used when not booted into the security device 0101, and then associate use of the security device 0101 with an ability to authenticate with these identity keys.

Other less secure ways to achieve a similar or equivalent function, is to change the client software 0606 in the security device 0101 such that it identifies itself in some fashion to the service provider 0104. For example, a browser might send a unique user-agent address, a secret cookie, or a special HTTP header in its requests. Such techniques may be easily overcome however.

Human interface level 1325

For some applications, it is preferable if an embodiment includes human interface level 1225 security countermeasures that make it more difficult for an attacker to social engineer the user. Social engineering is the art of fooling the user of a computer system into providing assistance to the attacker. Often users are susceptible to social engineering because they are naturally trusting and lack sufficient awareness and training.

For example, phishing attacks attempt to trick the user into providing the credentials (e.g., username/password) to his bank account by sending him deceptive emails messages that are intended to convince the user to login to a fake replica of the bank's website that is controlled by the attacker.

As such, a security structure intended for use in the context of high risk applications may include anti-social engineering mechanisms 1311 that protect the user from becoming the weak link security is dependent on.

In one embodiment, this may mean protecting the user from himself by providing the user exclusively with safe choices. For example, an attacker can not trick the user into logging in to a fake replica of the online bank's website (a phishing attack), if the user is not allowed to access arbitrary websites. One embodiment of the invention may not allow the user to communicate with the public network at all, only the Virtual Private Network. Similarly, an attacker can not trick the user into running a trojan horse if, for example, the user is not allowed to run arbitrary software programs.

An additional anti-social engineering 1311 mechanism may include, for example, increasing the user's awareness to potential attacks by integrating training materials into the computer system. For example, a training video warning users of potential risks may run the first time the user boots into the security device 0101, cautionary reminders may be embedded in logical proximity to problematic interfaces to warn users of the possible ramifications of a dangerous choice.

Yet another anti-social engineering 1311 mechanism may involve, for example, increasing the visibility of information that might allow a user to identify suspicious signs that indicate a social engineering attack is under progress (e.g., somebody is trying to trick him).

For example, a browser may emphasize whether or not a website that is pretending to be an online bank is using encryption, who the encryption certificate is registered to, who owns the network block, the country the website is hosted in (e.g., website claiming to be American online bank hosted on an eastern European web server), or other information that may provide the user with clues that a social engineering attack is being attempted.

11). Exemplary Secure Production Process

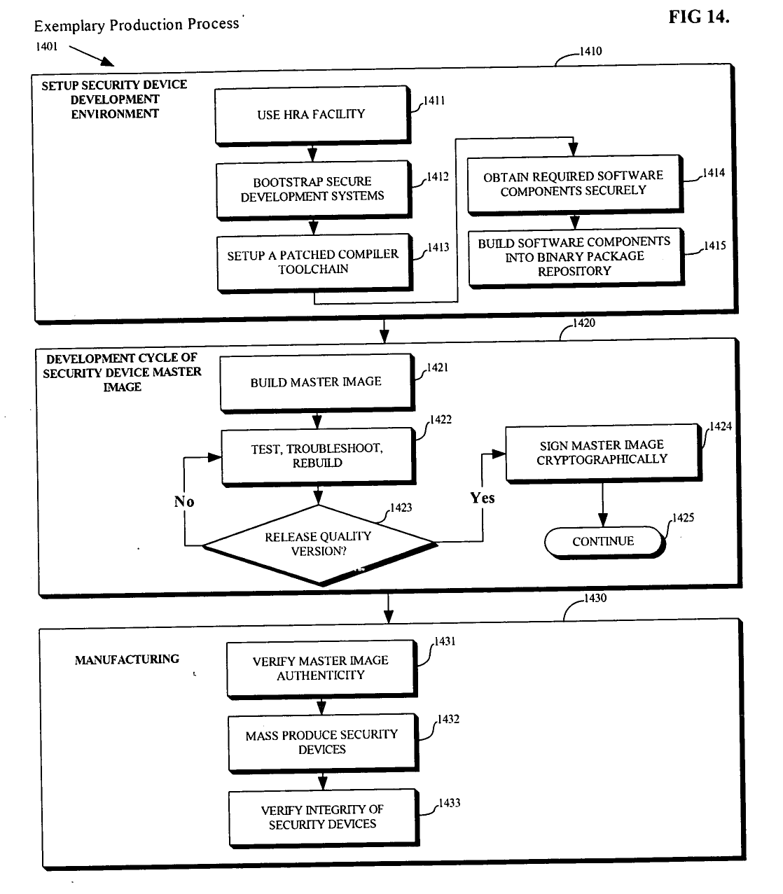

FIG. 14—is a high-level flow diagram illustrating the exemplary steps in the secure production process of one embodiment of the invention.

First, a sufficiently secure environment suitable as a context for safely developing the security device 1302 may be setup (step 1410).

As previously explained in the Exemplary security layers section with reference to FIG. 13, the risk associated with producing and transporting an embodiment of the security device 0101 is at least as high (arguably higher) as the risk associated with the application the security device 0101 is intended to be used for. As such, it is preferable to develop the security device 0101 in a secure facility designed to perform as a safe environment suitable for developing security solutions for high risk applications 1302.

Setting up this environment may involve, for example, using a suitably secure development facility 1411, bootstrapping secure development systems (step 1412), setting up a patched compiler toolchain (step 1413), obtaining the required software components securely (step 1414), and building software components into a binary package repository (step 1415).

A suitably secure development facility 1411 may be physically located, for example, at a site protected with multiple layers of physical security such as perimeter defenses (e.g., fences, walls), armed guards, pervasive external and internal video surveillance, nested levels of restricted areas (compartments), and so forth.

Access to the physical facility and to restricted areas within the facility may be strictly restricted to authorized trusted personnel, which may be identified by strong N-factor authentication means (e.g. biometrics, tokens, passwords/pincodes, etc.).

Similarly, the facility's IT (Information Technology) infrastructure (e.g., computer network) must also be sufficiently protected with multiple layers of security relative to potential attack scenarios.

It is preferable to secure computer systems that will be used for development with a level of security equivalent or higher to the security provided by an embodiment of the invention.

Eventually, embodiments of the security device 0101 specifically optimized production process 1401 development tasks may be used to develop embodiments of the security device 0101 that are optimized for other applications.

Initially, before embodiments optimized for use in the production process 1401 exist, development tasks may be performed on more conventional secure computer systems that may be custom made specifically for this purpose (step 1412).

In one embodiment, in order to benefit from compiler protections 1308 previously described in the Exemplary security layers section above, a suitably patched compiled toolchain may be installed on the development systems step (1413).

Obtaining required software components securely (step 1414) may involve, for example, using source verification 1301 and authenticity verification 1304 measures previously described in the Exemplary security layers section above.

It may be preferable to use a package management and build system to assist in automating the assembly of software components into more manageable binary packages that may be placed into a centralized package repository in the secure development environment (step 1415).

The build system may be configured to enabled the compiler protections 1308 supported by the patched compiled toolchain during compilation of software components written in compiled languages such as, for example, C, or C++.

A package management and build system may be, for example, gentoo portage, RPM, debian apt, or other package management and build systems.

It may be preferable to use a package management and build system that is capable of cryptographically signing and verifying packages after they are built, which may provide increased protection against the risk that the integrity of the packages in the repository will be violated by a potential attacker.

Next, a release quality, master image of the outer filesystem 0500 may be developed (step 1420), for example, by first building a master image (step 1421), and then iteratively testing, troubleshooting and rebuilding the master image (step 1422) until a release quality (conditional 1423) version is produced that sufficiently satisfies the functional and security objectives of one embodiment optimized for a specific application.

In one embodiment, developing the master image (step 1421) may involve, for example, building the kernel 0503, creating an appropriate initrd 0502, creating the internal filesystem image 0504 and integrating these elements along with a suitably configured bootloader 0501 and autorun 0505 element to create the outer filesystem 0500 previously described in the Exemplary outer filesystem section with reference to FIG. 5.

Creating the internal filesystem image 0504 may involve, for example, creating a new filesystem, deploying into it the required software components from the package repository created in step 1415, configuring these components, and then compiling an image of the internal filesystem that will be positioned in the outer filesystem 0500 as previously described.

Note, that deploying the required software components may populate the internal filesystem with the platform initialization 0622, workspace infrastructure 0623, workspace 0415 level functional elements and their associated dependencies previously described in the Exemplary functional overview section with reference to FIG. 6A.

Also note, that the internal filesystem may also include, for example, the software, data and configuration settings to enable software security mechanisms at the network 1322, operating system 1323, application 1324 and human interface 1325 levels previously described in the Exemplary security layers section with reference to FIG. 13.

Next, the master image is signed cryptographically (step 1424) to allow its authenticity to be cryptographically verified, which may increase how difficult it is for an attacker to compromise the integrity of the master image that may be imprinted into the security device 0101 during manufacturing (step 1430).

Finally, in the manufacturing phase (step 1430), the authenticity of the master image may be cryptographically verified (step 1431), a security device is mass produced (step 1432) with the master image imprinted on to its non volatile memory element 0303 or storage media 0308, and the integrity of the manufactured security devices is verified (step 1433).

Depending on the circumstances, it may provide additional security to verify the authenticity of the master image prior to mass production (step 1431). For example, manufacturing (step 1430) may take place at a third party manufacturing site, in a different country, or other location that is geographically separate from the development facility, in which case a resourceful attacker may have the opportunity to intercept and replace the master image in transit. The risk of interception may exist within the confines of a single secure development facility as well, especially if insiders are involved, though the cost of attack may be higher.

For some applications, in one embodiment, it may be preferable to mass produce a security device (step 1432) on which a specific master image is imprinted, because this may allow more efficient economies of scale.

On the other hand, in another embodiment, it may be preferable to imprint a unique master image on each security device 0101 (not shown). For example, this may be used to embed unique identity information into the master image that may be used for authentication purposes, embed unique visual marks of authenticity that may be displayed during the boot process such that users may more easily identify if the security device has been spoofed (i.e., replaced with a trojan horse), create a master image that is specially optimized to the specific requirements of a single user, or used for other purposes.

Verifying the integrity of the master image imprinted on the security device 1433 following production may be useful as a last line of defense to increase how difficult it is for an attacker that has managed to get past other security measures to actually compromise the integrity of the security device 0101 that will be delivered to users. For example, if the attacker manages to intercept the delivery of security devices from a separate manufacturing facility and replaces them with compromised security devices, independently verifying the integrity of the security devices on arrival will detect this breach of security. In another example, an attacker manages to compromise the computer controlling the mass production of the security device and reprograms the computer to imprint a trojan horse master image instead of the authentic master image, and so forth.

For some applications, it may be sufficient to verify the integrity of a random statistically meaningful sample of manufactured security devices. Sampling integrity may provide reasonable assurance that integrity has not been compromised, at a relatively low cost.

Note, that using cryptographic signatures to verify the authenticity of a file is well known operation in the art and has been previously explained further in the Exemplary security layers section above.

### Detailed Description of the Alternative Embodiment

1). Overview

The alternative embodiment is an embodiment of the invention optimized for non-personal use, in contrast to the previously described preferred embodiment optimized primarily for personal use. The alternative embodiment is designed to provide a platform for client side and server side applications utilizing dedicated computer hardware.

Contemporary computer systems used for non-personal client side and server side applications are often insecure because the solutions are built on top of general purpose platforms, which were never designed for security, and thus prioritize functionality over security, resulting in a weak security architecture which provides at best a medium level of security requiring constant maintenance (e.g. patching).

Additionally, systems are most likely to be installed, configured and maintained by IT professionals (i.e., network and system administrators) who are by trade, not security experts, and can not reasonably be expected to become security experts.

Furthermore, implementation of contemporary computer systems is often a labor intensive process involving relatively expensive system integration services, and it would be desirable to somehow reduce this expense while increasing the quality of the result and the provided security.

The alternative embodiment is similar in most respects to the preferred embodiment, except that is not optimized to allow users to quickly switch into a temporary high security mode or to co-exist in symbiosis with another operating system. Instead, the alternative embodiment is optimized for the most likely non-personal usage scenario, to run on dedicated computer hardware as the primary operating system environment.

This means, for instance, that boot process optimizations such as saving a record of initialized system state may not be needed for the alternative embodiment, because it is not expected to be rebooted as often as the preferred embodiment, so boot time performance is much less of an issue.

Similarly, the alternative embodiment may not need to provide a connectivity agent. Dedicated computer hardware is usually kept in a permanent physical location with a stable physical network environment, and in this case, allowing an administrator to provide network configuration parameters manually may be preferable.

Additionally, the alternative embodiment may use a logical volume element instead of a persistent safe storage element to store data in order to enjoy performance and scalability advantages that are easier to provide when managing data storage on dedicated computer hardware. Thus, the alternative embodiment may more efficiently and flexibly utilize the storage capacity of the internal storage devices of a dedicated computer, providing the increased data storage capacity required for some applications.

The objective of the alternative embodiment is to provide systems secure enough for high risk applications at a reduced total cost, as measured not only in the market price of a specific product embodying the alternative embodiment, but primarily in the reduction of the time, labor and expertise required to integrate, configure and maintain a high-security computer system.

In part, this is achieved by booting a computer directly from the security device to provide an independent operating system environment that has been pre-integrated by experts to carefully balance functionality with multi layered security, such that installation to the hard-drive is not required.

In one embodiment, the functionality of existing servers may be easily migrated to the independent secure operating system environment provided by the security device using a migration agent, enabling practical conversion of existing applications to a high-security environment.

Example applications for the alternative embodiment within the enterprise include, a thin client, thin client terminal server, a network management console and a secure server.

Other applications include, for example, kiosk applications such as e-voting terminals, secure Internet access stations, and even turning the commodity computers already available in an educational environment such as a school or college into compliant secure examination stations for automated testing of students.

The alternative embodiment is also optimized to be easily and economically distributable by, for example, service providers, government or integrators to provide a practical, turn key solution for many non-personal server side or client side applications.

For example, an integration company may distribute security devices that are consistent with the principles of the invention to their clients. The ministry of education might distribute devices to schools, enabling school students to participate in nationwide computerized exams in a secure manner.

The differences between the alternative embodiment and the preferred embodiment will now be further described in detail with reference to the diagrams.

2). Exemplary User Interaction

The following exemplary user interaction steps may be better understood in reference to the operations described in the alternative embodiment's Exemplary system initialization section below.

FIG. 4B is a high-level flow diagram that illustrates exemplary user interaction steps with the alternative embodiment of the invention.

User interaction for the alternative embodiment is mostly similar to the user interaction for the previously described preferred embodiment, except for changes relating to the use of a logical volume mechanism for data storage instead of a persistent safe storage (PSS) mechanism, for reasons further explained below in the

Exemplary System Initialization Section.

If a logical volume element does not exist (conditional 0851′) because, for example, the computer is booting from the security device 0101 for the first time and a logical volume element has not yet been created, a logical volume configuration dialog may be started (step 0951), which the user may interact with to configure a new logical volume element.

If an operating system is contained on the computer's 0102 internal storage devices 0208, the user may choose during interaction with the logical volume configuration dialog to either destroy the old partitions on which the operating system is contained, or preserve them, as backup or in order to allow migration of application content and configuration data from them. If the user chooses to preserve the old partitions, the logical volume element will be created by default on unallocated disk space or on partitions containing empty (i.e., recently formatted) filesystems.

In one embodiment, the existence of a logical volume element is required for the operation of the operating system environment provided by the alternative embodiment, so the user is not provided with an option to skip creation of the logical volume element, if the logical volume element does not yet exist.

Similarly, due to the different usage contexts, it is likely the step of authenticating to a service provider 0409 as described in the user interaction section for the preferred embodiment may also not be performed.

Dedicated computer hardware is usually kept in a permanent physical location with a stable physical network environment, and in this case, allowing an administrator or technical savvy user to provide network configuration parameters manually with a wizard 0612′ may be preferable, instead of relying on the operation of a connectivity agent used by the preferred embodiment.

At the end of the boot process, one embodiment may provide the user with management interfaces accessible through a GUI workspace 0415′ which may include enough functionality to allow the user to monitor, control and configure the operating system environment and target applications (e.g., a network service, kiosk application) which have been integrated into it for a specific embodiment.

In one embodiment, the GUI workspace 0415′ may include, for example, a variety of application specific configuration wizards 0612′, a management console 0609′, and console locking 0613 mechanism, which the user may interact with either locally (i.e., on the physical console) or remotely (i.e., through a network).

For some applications, it may be desirable and convenient to allow the user to access the management interfaces remotely through a network service such as, for example, an encrypted web interface, secure shell (SSH), VNC, or Microsoft Terminal Services.

In one embodiment, the user may interact with a migration agent to migrate primarily server side application content (e.g., email accounts, user accounts, web content, database content) and configuration data (e.g., access control lists, quotas) from an archive of exported application data (e.g., backup archive) or from files on the preserved partitions of a computer's 0102 internal storage devices 0208.

The migration agent may either be launched automatically during system initialization, or manually by the user (e.g., through a GUI menu item, desktop icon or management console).

Finally, for security reasons, it may be preferable to configure a console locking mechanism 0613 to automatically lock the physical console if the system does not receive user interaction within a predetermined amount of time. Alternatively, the user may lock a console manually by selecting a GUI option (menu item, icon, etc.).

Console locking may prevent unauthorized or accidental user interaction with the GUI workspace, as well as protect the contents of the GUI workspace from prying eyes by, for example, blanking the screen or covering it with graphic or animation (i.e., screen saver).

The console may remain locked until a user successfully authenticates to the system by, for example, entering a password, inserting an authentication token or passing biometric authentication.

3). Exemplary Functional Overview

FIG. 6B is a diagram illustrating the exemplary multi-level functional overview for an alternative embodiment of the invention.

At the functional overview level, the alternative embodiment is similar to the previously described preferred embodiment (i.e. FIG. 6A), except that the functionality of the alternative embodiment is designed according to different assumptions regarding the usage contexts for an embodiment of the invention optimized to enable non-personal applications running on dedicated hardware.

Several elements at the platform initialization 0622′ level may be embodied differently relative to the preferred embodiment.

For example, an alternative implementation of the initialization manager 0601′ further described below may be used, as well as a logical volume mechanism 0631 instead of the persistent safe storage (PSS) mechanism 0602.

The logical volume mechanism 0631 and the persistent safe storage (PSS) mechanism 0602 are both designed for data storage. They have however, been optimized for different circumstances. These differences are further described in the Exemplary system initialization section below.

In one embodiment, the preferred embodiment's connectivity agent 0604 may not be required, because dedicated computer hardware is usually kept in a permanent physical location with a stable physical network environment, and in this case, allowing an administrator to provide network configuration parameters manually may be preferable.

In one embodiment, the migration agent 1101′ may include support for migrating primarily server side instead of client side application content and configuration data.

Exemplary workspace elements 0415′ may include pre-integrated target applications 0708 (including network server applications) and application specific configuration wizards 0612′.

Pre-integrated target applications and network services 0708 may include, for example, a remote desktop sharing service, a secure shell (SSH) service, a file server, a web server, a database server, a mail server, an anti-spam service, a directory server, a certificate authority server, a caching accelerator, a proxy server, a firewall, a VPN server, an intrusion detection server or node, an intrusion prevention server, a DNS server, a DHCP server, a VoIP server, an instant messaging server, a load balancing server, a student examination application, an evoting kiosk application, custom vendor software, or other types of services and applications.

4). Exemplary System Initialization

FIG. 7B is a high-level flow diagram illustrating exemplary steps in the boot process 0701′ of the alternative embodiment of the invention.

The result of the exemplary boot process 0701′ illustrated in FIG. 7B is a running operating system environment with an architecture further described in the Exemplary runtime OS architecture section below, with reference to FIG. 11.

The user may interact with the exemplary boot process 0701′ as previously described in the Exemplary user interaction section above, with reference to FIG. 4B.

In one embodiment, the boot process is similar to the previously described boot process of the preferred embodiment (i.e., FIG. 7A), except for the final stages which may include, for example, invoking application specific configuration wizards 0612′, a management console 0609′ and target applications 0708.

Furthermore, an alternative implementation of the initialization manager 0601′ which uses a logical volume mechanism for data storage may be used.

Logical Volume Management (LVM) provides enhanced high-level disk storage management, enabling flexible storage space allocation of abstract logical volumes spanning multiple physical disks and partitions, in contrast to traditional data storage directly within the partitions of physical disks which can be much harder to manage.

LVM allows physical disks to be divided into storage units. Storage units from multiple disks can be pooled together into volume groups within which logical volumes can be created. Logical volumes are abstract functional equivalents of traditional hard-drive partitions in the sense that they can be used to store a filesystem. Additionally, the storage units of a logical volume can be re-allocated (i.e., added or removed) as storage capacity requirements change.

In comparison, attempting to resize a physical hard drive partition may prove time consuming and dangerous (i.e., result in data loss) and so usually, the allocation of a hard drive into partitions is fixed. This means if the storage capacity on any given partition has been saturated, it is very rarely considered practical to re-allocate free storage capacity from other partitions even if it is available.

On the other hand, with LVM, an entire disk or group of disks can easily be allocated to a single volume group within which logical volumes are allocated and reallocated as required.

For example, one storage management strategy might allocate minimal amounts of storage capacity from a volume group to each required logical volume, leaving the rest as unallocated storage capacity (i.e. storage units). Then, when a logical volume reaches a predetermined threshold of capacity (e.g., 70% full), it can be extended by administrators to include unallocated storage units.

When free storage capacity in a volume group runs out, additional physical disks can be installed in a machine and added to the volume group to increase capacity as required.

Additionally, damaged disks can be phased out of use without disrupting system service by using the LVM mechanism to remove a physical disk from a volume group while automatically moving its storage units to a different physical disk.

The advantages of the LVM mechanism over the PSS mechanism are clear, however using the LVM mechanism may not be practical for an embodiment optimized for use with a non dedicated computer (i.e., the preferred embodiment), because the computer's internal storage devices 0208 have already been partitioned and most likely contain filesystems created and used by a local operating system.

In general, logical volume management is considered a better storage management solution than traditional partitioning of physical hard drives, so use of the LVM mechanism is recommended when practical.

FIG. 8B is a flow diagram illustrating exemplary steps in the operation of an alternative implementation of the initialization manager 0601′ used in the boot process 0701′ of the alternative embodiment

The initialization manager of the alternative embodiment is similar to the previously described initialization manager of the preferred embodiment, except that the alternative initialization manager 0601′ utilizes a logical volume element instead of a persistent safe storage (PSS) element, for reasons previously described above.

If the initialization manager 0601′ successfully accesses the logical volume element (conditional 0851′), the initialization manager 0601′ may next attempt to detect if the computer's 0102 hardware profile has changed (conditional 0854). If so, it may then determine hardware configuration parameters (step 0870) and save the new hardware profile and configuration parameters to the logical volume (step 0871). Continuing execution from step 0854 or step 0871, the appropriate drivers are then loaded (step 0872) based on the previously determined (in step 0870) hardware configuration parameters.

Otherwise, if the initialization manager 0601′ fails to access the logical volume element (conditional 0851′), because, for example, it does not yet exist, it may then function to determine hardware configuration parameters (step 0820), load drivers (step 0815), create a logical volume element using the exemplary method for creating a logical volume element described below with reference to FIG. 9B-I (step 0861) and then save the determined hardware configuration parameters to the logical volume (step 0855).

Next, continuing execution from step 0855 (i.e., reached if the logical volume didn't exist and had to be created), or from step 0872 (i.e., reached if the logical volume was successfully accessed), system services may be started (step 0821).

Concluding the operation of the initialization manager 0601′, a graphical user interface (GUI) may be started (step 0816).

Note, that creation of the logical volume element (step 0861) is mandatory in the alternative embodiment, unlike the optional creation of the persistent safe storage (PSS), and that boot process optimizations such as saving a record of initialized system state may not be needed as the alternative embodiment is not expected to be rebooted as often as the preferred embodiment, so boot time performance is less of an issue.

Referring back to FIG. 7B, the boot process 0701′ of the alternative embodiment may include starting a management console (step 0609′), application specific configuration wizards (step 0612′), and target applications (step 0708).

A management console (step 0609′) such as, the webmin utility for example, may be used to assist users by providing an user interface for setting up and configuring the system and its services, for example, logical volume administration, remote desktop sharing, an SSH daemon, network file sharing, a web server, a mail server, a database server, a DNS server, and other system services.

a). Exemplary Logical Volume Methods

As previously explained, the logical volume mechanism 0631 may be used to provide high-level storage management of a computer's 0102 internal storage devices 0208, enabling flexible storage space allocation of an abstract logical volume element spanning multiple physical disks and partitions.

Note, that due to its different threat model, the alternative embodiment does not use filesystem level encryption to protect the logical volume element, unlike the preferred embodiment's encryption of the PSS element. The preferred embodiment needs filesystem level encryption, because as previously described, the preferred embodiment is optimized to co-exist with a local operating system running on the same physical computer hardware at different times. If the security of the local operating system is compromised, the attacker may gain access to the PSS element files, so encryption is required to protect the confidentiality and integrity of the data stored within the PSS. This threat does not apply to the alternative embodiment, which is optimized for use as the primary operating system on a dedicated computer.

### Exemplary Method for Creating a Logical Volume Element

FIG. 9B-I is a flow diagram illustrating exemplary steps in a method for creating a logical volume element.

As previously described, creation of the logical volume element is mandatory in this embodiment.

Preferably, a single logical volume element spanning all available internal storage capacity is created for each computer, in contrast to the preferred embodiment where multiple PSS elements 0602 may be created and used on a single computer by calculating a unique fingerprint used to identify each PSS element.

Note, some operating system kernels (Linux for example), include built-in support for logical volume management that may be used to provide support in creating and accessing a logical volume.

First, internal storage devices 0208 may be probed to compile a list of physical disk drives and partitions (step 0950).

In one embodiment, the user may be required to interact with a logical volume configuration dialog 0951 to configure which physical disks and partitions are pooled into creation of the logical volume and bootstrap partition (step 0958).

The logical volume configuration dialog 0951 may calculate and display the recommended configuration for the creation of a logical volume 0952, which may comprise, for example, deleting partitions containing empty (i.e., recently formatted) filesystems, creating new partitions according to parameters which maximize the utilizable storage capacity of each disk drive, and pooling these new partitions into one logical volume spanning all of the free disk space in all internal storage drives. This configuration will preserve the old partitions containing previously used operating system and application software for backup purposes or in order to allow migration of application content and configuration data from them. The exemplary recommended configuration assumes that a user is converting an existing computer (e.g., a server) for use with the security device and is interested in migrating application content and configuration data from the old environment, will prepare the required additional storage capacity for the logical volume element by, for example, installing additional disk drives, or vacating and formatting partitions on existing disk drives.

The logical volume configuration dialog 0951 may further include advanced options 0953 for allowing more advanced users to create a custom logical volume configuration.

Advanced options 0953 may include, for example, a partition management (i.e., deleting and creating partitions) dialog 0954, and dialog for selecting which physical disks and partitions to pool into the custom logical volume element 0955.

In one embodiment, the partition management dialog may assist the user in identifying old partitions by displaying partition information which may include, for example, partition size, label, filesystem type, and filesystem contents (e.g., directory and file structure). This may prevent users from accidentally mistaking an old partition containing valuable data for an old partition that can be safely deleted and pooled into the logical volume element.

Additionally, the partition management dialog may warn a user attempting to delete existing partitions potentially containing valuable data of the ramifications of this action (e.g., loosing data that can be migrated) and then ask the user for confirmation.

If the user creates a custom logical volume configuration by using the advanced options, the logical volume configuration dialog 0951 may update the graphical representation of the current configuration 0952, to represent the custom configuration.

The user may then choose to create the logical volume element 0958 using the recommended configuration 0957 or a custom configuration 0956 if it exists.

Creation of the volume element may begin, for example, by reconfiguring partitions on the available drives (e.g., using the fdisk utility on Linux) according to the recommended or custom configuration.

Next, physical volumes are created (e.g., using the pvcreate utility on Linux) on the previously configured physical partitions, and pooled into a volume group (e.g., using the vgcreate utility on Linux). A separate bootstrap partition is also created.

Next, a logical volume may be created spanning the full capacity of the volume group (e.g., using the lvcreate utility on Linux).

Next, file-systems may be created on the logical volume and bootstrap partition 0959, after which the file system created within the logical volume is accessed/mounted 0960.

Finally, the method 0861 may function to create a logical volume configuration file on the bootstrap partition (step 0961), a relatively small partition used to store the logical volume configuration file.

The exemplary method for accessing a logical volume 0851, further described below, may retrieve the required configuration parameters needed to successfully access the logical volume element from the logical volume configuration file stored on the bootstrap partition.

Note, that creating a logical volume element on other logical volume management (LVM) implementations (i.e., non Linux) may require different operations.

### Exemplary Method for Accessing a Logical Volume Element

The operations of the following exemplary method may be better understood in reference to the corresponding operations of its exemplary counterpart, previously described in the Exemplary method for creating a logical volume element section above.

FIG. 9B-II is a flow diagram illustrating exemplary steps in a method for accessing a logical volume element.

First, the method 0851 attempts to locate the previously created logical volume configuration file stored on the bootstrap partition.

In one embodiment, in order to locate the logical volume configuration file, internal storage 0208 devices may be probed to compile a list of partitions which exist on all disk drives (step 0950). Then, for each partition (loop 0970), if the filesystem type contained within the partition is supported, the method 0851 may check for the existence of the logical volume configuration file within the filesystem (conditional 0971), in the same location where it was created by the previously described Exemplary method for creating a logical volume element.

If the logical volume configuration file can not be located on any of the supported filesystems of the partition because, for example, a logical volume element has not yet been created, the method returns failure (step 0976).

Otherwise, if the logical volume configuration file exists, a logical volume may be accessed according to the parameters retrieved from the logical volume configuration file, the filesystem it contains may be mounted (step 0961) and the method returns success (step 0975).

If the logical volume fails to mount, for example, because it has become corrupted, a physical disk has been removed, or a physical disk has failed, an exception may be raised and the method may return failure.

Additionally, relevant error messages may be displayed and a set of appropriate utilities may be provided allowing the user to troubleshoot, diagnose and repair the problem.

5). Exemplary Migration Agent

The migration agent 1101′ used in the alternative embodiment is essentially equivalent in principle and operation to the previously described migration agent 1101 of the preferred embodiment, except for changes resulting in differences in usage context (i.e., saving data to a logical volume element instead of a PSS element) and differences in the type of applications being migrated (i.e., mostly server side).

In the alternative embodiment, it is expected that the migration agent 1101′ will primarily be used to migrate the functionality of server side applications including, for example, web servers (e.g., Microsoft IIS, Apache), mail servers (e.g., Microsoft Exchange, sendmail, qmail), database servers (e.g., Microsoft SQL, Oracle, MySQL, postgresql), firewalls (e.g., Microsoft ISA, Checkpoint firewall-1), file servers (e.g., SMB, NFS, FTP protocols), DNS servers, or any other server side application.

6). Exemplary Runtime OS Architecture

The runtime operating system architecture of the alternative embodiment is nearly identical to the runtime operating system architecture of the preferred embodiment previously described with reference to FIG. 12, except for user-land changes which reflect different usage context assumptions.

In the alternative embodiment, the operating system provides context for primarily non-personal applications running on dedicated computer hardware, in a stable network environment, and configured by a more technically knowledgeable user such as a system administrator.

These differences have been previously described in the Exemplary functional overview section above, with reference to FIG. 6B.

### Conclusion

As can be appreciated from the foregoing, the present invention provides a practical solution for allowing widespread adoption of computer systems in which security is a reliable, fault tolerant, and predictable property that can be safely taken for granted.

An ideal balance between the naturally conflicting objectives of security and usability can be achieved by carefully prefabricating the independent operating system environment provided by the security device according to the principles of the invention, with reference to the functional requirements of the specific task an embodiment of the invention is optimized for.

Within its intended usage context, an embodiment of the present invention can thus provide maximum security for the required functionality while simultaneously maximizing convenience and ease of use.

Booting from an embodiment of the invention is all that is required to temporarily transform an ordinary computer into a naturally inexpensive logical appliance which encapsulates a turn-key functional solution within the digital equivalent of a military grade security fortress.

This allows existing hardware to be conveniently leveraged to provide a self contained system which does not depend on the on-site labor of rare and expensive system integration and security experts.

To assist in achieving these advantages, a specific embodiment of the invention may employ any combination of the features previously described for the preferred and alternative embodiments including physical device hardware, multi layered security architecture, a connectivity agent, a migration agent, persistent safe storage mechanism, logical volume mechanism, boot process optimizations, an autorun element and a friendly graphical user interface.

It is noted that the foregoing examples have been provided merely for the purpose of explanation and are in no way to be construed as limiting of the present invention. While the invention has been described with reference to embodiments, it is understood that the words which have been used herein are words of description and illustration, rather than words of limitations.

Further, although the invention has been described herein with reference to particular means and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method for securing the client side of a transaction between a client and a service provider through a network comprising providing the client with an apparatus that a computer can boot from in order to provide an independent operating system environment, the apparatus comprising:
(a) a portable non-volatile memory element;
(b) an operating system environment stored on the portable non-volatile memory element;
(c) the operating system environment including client software for interfacing with the service provider to perform the transaction,
wherein the client software is configured to encrypt communication with the service provider; and
(d) a bootloader for booting the operating system environment from the portable non-volatile memory element.

2. The method of claim 1, wherein the network includes a computer communication component selected from the group consisting of:
a local area network;
a wireless local area network (WLAN);
a wide area network (WAN);
a telephone network;
an intranet; and
the internet.

3. The method of claim 1, wherein the transaction between the client and the service provider includes operations selected from the group consisting of:
performing a financial transaction;
accessing financial information;
accessing medical records;
accessing a virtual private network;
accessing a website;
accessing an intranet portal;
accessing a file server;
accessing a database;
accessing an email service;
accessing an instant messaging service;
accessing a voice over ip service;
accessing a project collaboration service;
accessing a source code repository;
accessing a terminal client server; and
accessing a custom application.

4. The method of claim 1, wherein the service provider is an online financial services provider,
and the client is a customer of the online financial services provider,
whereby the client of the online financial services provider can boot a computer from the apparatus to safely access financial information or conduct online transactions.

5. The method of claim 1, wherein the service provider is an employer,
and the client is an employee,
whereby the employee can boot an untrusted home computer from the apparatus to safely access network resources of the employer.

6. The method of claim 1, wherein the service provider is a government,
and the client is a citizen,
whereby the citizen can boot a computer from the apparatus to safely access the government's information and citizenship services.

7. The method of claim 1, wherein the operating system environment includes a first initialization component for initializing the operating system environment, the first initialization component including a second initialization component for loading a predetermined portion of the operating system environment into the computer's main memory.

8. The method of claim 7, wherein the second initializations component loads a large enough portion of the operating system environment into the computer's main memory so that the computer no longer needs to read from the portable non-volatile memory element.

9. The method of claim 1, wherein the apparatus that a computer can boot from further comprises
(e) an autorun component for automatically executing a user assistance component when the apparatus is first inserted into the computer while the computer is running a local operating system on the computer, the autorun component being stored on the portable non-volatile memory element.

10. The method of claim 9, wherein the user assistance component includes a component selected from the group consisting of:
(i) a user manual component for providing a user manual for the apparatus;
(ii) a bios reconfiguration component for helping a user reconfigure the computer's BIOS; and
(iii) a boot disk creation component for helping a user create boot disks.

11. The method of claim 9, wherein the user assistance component includes a smart reboot component for causing the local operating system to invoke a hibernation mode which preserves the state of the local operating system's running applications before rebooting the computer from the apparatus.

12. The method of claim 1, wherein the bootloader is stored on the portable non-volatile memory element wherein the computer can boot directly from the apparatus.

13. The method of claim 1, wherein the bootloader is stored on a separate storage media, the separate storage media being of a type that the BIOS of the computer supports booting from,
and wherein,
the operating system environment includes a main initialization component for initiating the operating system environment,
and the separate storage media contains a first initialization component for accessing the operating system environment stored on the portable non-volatile memory element and thereafter invoking the main initialization component.

14. The method of claim 1, wherein the apparatus that a computer can boot from further comprises
(e) a first interface component for operatively interfacing the apparatus with a device interface port of the computer as a peripheral device, the first interface component coupled to the portable non-volatile memory element.

15. The method of claim 14, wherein the apparatus that a computer can boot from further comprises
a cryptographic component for providing cryptographic services, the cryptographic component coupled to at least the first interface component.

16. The method of claim 1, wherein the portable non-volatile memory element is a storage media that is compatible with media read/write interfaces of the computer.

17. The method of claim 16, wherein the storage media is an optical media type in miniature form.

18. The method of claim 16, wherein the storage media includes a component for providing a visual mark of authenticity.

19. The method of claim 16, wherein the storage media provides a signature area.

20. The method of claim 1, wherein the operating system environment includes a plurality of security mechanisms that are configured to provide a substantially fault-tolerant multi layered security architecture.

21. The method of claim 20, wherein the operating system environment includes a mandatory access control component for enforcing a predetermined operating system level access control policy that substantially limits the potential damage that the compromise of any individual software component of the operating system environment will have on the overall security provided by the operating system environment.

22. The method of claim 20, wherein the operating system environment includes an exploitation countermeasure component for substantially increasing how difficult it is to exploit a predetermined group of vulnerability types in software components of the operating system environment.

23. The method of claim 1, wherein the operating system environment includes:
(i) a virtual private network component for establishing a virtual private network connection, and
(ii) a network configuration component for establishing network connectivity, the network configuration component including a component for invoking the virtual private network component to establish a virtual private network connection after network connectivity is established.

24. The method of claim 1, wherein the client component includes a component for providing a substantial indication to the service provider that the network service is being accessed securely from the operating system environment which is provided by the apparatus.

25. The method of claim 24, wherein the client component includes:
a client cryptographic certificate; and
a component for calculating a response to a cryptographic challenge provided by the service provider using the client cryptographic certificate.

26. The method of claim 1, wherein the operating system environment includes a connectivity agent component for establishing network connectivity across a variety of circumstances with minimum user interaction.

27. The method of claim 26, wherein the connectivity agent component includes: a component for maintaining a list of previous network configurations in a predetermined storage location;
a component for updating the list of previous network configurations according to the parameters of network configurations in which network connectivity was successfully established; and
a component for attempting to establish network connectivity by applying network configurations from the list of previous network configurations.

28. The method of claim 26, wherein the connectivity agent component includes a component for importing network configuration parameters from the files of the operating system installed on the computer's internal storage devices.

29. The method of claim 1, wherein the operating system environment includes:
(i) a persistent safe storage component for storing data persistently inside at least one persistent safe storage element, the persistent safe storage element comprising an opaque container, and
(ii) a first initialization component for initializing the operating system environment, the first initialization component including:
(ii1) an access component for attempting to locate and access the persistent safe storage element; and
(ii2) a creation component for creating the persistent safe storage element if the access component fails to locate or access persistent safe storage element.

30. An apparatus that a computer can boot from, in order to provide an independent operating system environment, comprising:
(a) a portable non-volatile memory element;
(b) an operating system environment stored on the portable non-volatile memory element;
(c) a bootloader for booting the operating system environment from the portable non-volatile memory element.

31. The apparatus of claim 30, wherein the operating system environment includes a plurality of security mechanisms that are configured to provide a substantially fault-tolerant multi layered security architecture.

32. The apparatus of claim 31, further comprising
(d) a first interface component for operatively interfacing the apparatus with a device interface port of the computer as a peripheral device,
the first interface component coupled to the portable non-volatile memory element.

33. The apparatus of claim 32, wherein the type of the first interface component is selected from the group consisting of universal serial bus (USB) and firewire and personal computer memory card international association (PCMCIA) and secure digital input output (SDIO) interface types.

34. The apparatus of claim 32, further comprising
(e) at least one additional interface component for operatively connecting the apparatus to a device interface port of the computer as a peripheral device, the type of the additional interface component differing from the type of the first interface component,
whereby the apparatus is compatible with multiple types of device interface ports.

35. The apparatus of claim 32, further comprising
(e) a cryptographic component for providing cryptographic services, the cryptographic component coupled to at least the first interface component.

36. The apparatus of claim 35, further comprising
(f) a physical casing surrounding at least the cryptographic component, the physical casing including means for resisting tampering,
wherein tampering with the physical casing will trigger the destruction of secret cryptographic data stored on the cryptographic component.

37. The apparatus of claim 35, wherein the cryptographic component includes means for substantially resisting tampering.

38. The apparatus of claim 35, wherein the cryptographic component includes means for providing public key cryptographic services.

39. The apparatus of claim 38, wherein the services provided by the means for providing public key cryptographic services include:
secure generation and storage of private keys; and
public-key decryption and encryption operations.

40. The apparatus of claim 35, wherein the cryptographic component includes a cryptographic storage component for storing secret cryptographic data, wherein the cryptographic storage component is detachable from the apparatus.

41. The apparatus of claim 35, wherein the cryptographic component includes a cryptographic interface protocol component for conforming to a standard authentication token interface protocol,
whereby the apparatus can provide equivalent functionality in the same usage contexts as a traditional authentication token.

42. The apparatus of claim 41, wherein the cryptographic interface protocol component includes means for conforming to the Cryptoki (PKCS 11) token standard.

43. The apparatus of claim 41, wherein the cryptographic interface protocol component includes means for conforming to the ISO 7816 standard.

44. The apparatus of claim 32, further comprising
(e) a biometrical sensor component for measuring unique biological metrics, the biometrical sensor component coupled to at least the first interface component.

45. The apparatus of claim 44, wherein the biometrical sensor component comprises component for reading a fingerprint.

46. The apparatus of claim 44, further comprising
(f) a cryptographic component for providing cryptographic services, the cryptographic component coupled to at least the first interface component, whereby the apparatus can support 2-factor authentication without using passwords.

47. The apparatus of claim 32, further comprising
(e) a physical casing surrounding at least the portable non-volatile memory element.

48. The apparatus of claim 47, wherein the physical casing includes
a component for providing a visual mark of authenticity.

49. The apparatus of claim 48, wherein the component for providing a visual mark of authenticity
comprises a hologram.

50. The apparatus of claim 47, wherein the physical casing includes a signature area.

51. The apparatus of claim 47, wherein the physical casing includes means for substantially resisting tampering.

52. The apparatus of claim 51, wherein tampering with the physical casing will render the apparatus inoperative.

53. The apparatus of claim 31, wherein the portable non-volatile memory element is storage media that is compatible with media read/write interfaces of the computer.

54. The apparatus of claim 53, wherein the type of the storage media is selected from the group consisting of optical and magnetic and solid state storage media types.

55. The apparatus of claim 53, wherein the storage media is an optical media type in miniature form.

56. The apparatus of claim 53, wherein the storage media includes means for providing a visual mark of authenticity.

57. The apparatus of claim 53, wherein the storage media provides a signature area.

58. The apparatus of claim 31, wherein the portable non-volatile memory element is physically read-only.

59. The apparatus of claim 31, wherein the bootloader is stored on the portable non-volatile memory element wherein the computer can boot directly from the apparatus.

60. The apparatus of claim 31, wherein the bootloader is stored on a separate storage media, the separate storage media being of a type that the BIOS of the computer supports booting from,
and wherein,
the operating system environment includes main initialization component for initiating the operating system environment,
and the separate storage media contains first initialization component for accessing the operating system environment stored on the portable non-volatile memory element and thereafter invoking the main initialization component.

61. The apparatus of claim 31, further comprising
(e) a separate cryptographic token.

62. The apparatus of claim 31, wherein the operating system environment includes:
(i) a virtual private network component for establishing a virtual private network connection; and
(ii) a network configuration component for establishing network connectivity, the network configuration component including a component for invoking the virtual private network component to establish a virtual private network connection after network connectivity is established.

63. The apparatus of claim 62, wherein the operating system environment includes a component for restricting outgoing and incoming network traffic to only allow traffic from within the virtual private network connection,
whereby the operating system environment is logically isolated from security threats on the public network through which the virtual private network connection is established.

64. The apparatus of claim 31, wherein the operating system environment includes a personal firewall component for enforcing a predetermined network access control policy that substantially prevents unauthorized network traffic to and from client and server side applications of the operating system environment.

65. The apparatus of claim 31, wherein the operating system environment includes a mandatory access control component for enforcing a predetermined operating system level access control policy that substantially limits the potential damage that the compromise of any individual software component of the operating system environment will have on the overall security provided by the operating system environment.

66. The apparatus of claim 65, wherein the predetermined operating system level access control policy is configured to
substantially minimize the privileges of each individual software component of the operating system environment, to the reduced set of privileges each individual software component needs to carry out its function.

67. The apparatus of claim 31, wherein the operating system environment includes a trusted path execution component for preventing execution of software programs whose executable files are not in predetermined trusted filesystem paths.

68. The apparatus of claim 31, wherein the operating system environment includes a logical compartment component for containing predetermined compartmentalized software programs within at least one logical compartment, wherein the predetermined compartmentalized software programs are logically isolated from the rest of the operating system environment.

69. The apparatus of claim 68, wherein the logical compartment component includes a type of logical compartmentalization security mechanism selected from the group consisting of unix chroot and user mode linux and vmware and xen logical compartment types.

70. The apparatus of claim 31, wherein the operating system environment includes a raw input output and memory protection component for preventing direct raw access to the operating system's virtual memory and to the operating system's hardware input output interfaces.

71. The apparatus of claim 31, wherein the operating system environment includes an exploitation countermeasure component for substantially increasing how difficult it is to exploit a predetermined group of vulnerability types in software components of the operating system environment.

72. The apparatus of claim 71, wherein the exploitation countermeasure component includes
a component for increasing how difficult it is to exploit memory bounds violation vulnerability types in software components of the operating system environment.

73. The apparatus of claim 71, wherein the exploit countermeasures component includes
a component for increasing how difficult it is to exploit race condition vulnerability types in software components of the operating system environment.

74. The apparatus of claim 31, wherein the operating system environment includes a predetermined group of software components which are compiled with a compiler toolchain that hardens the predetermined group of software components for preventing the exploitation of a predetermined group of vulnerability types in the predetermined group of software components.

75. The apparatus of claim 74, wherein the compiler toolchain that is used to harden the predetermined group of software components is selected from the group consisting of gnu compiler toolchain with the ssp patch applied and gnu compiler toolchain with the stackguard patch applied.

76. The apparatus of claim 74, wherein the compiler toolchain that is used to harden the predetermined group of software components provides substantial runtime protection against exploitation of buffer overflows vulnerability types in the predetermined group of software components.

77. The apparatus of claim 31, wherein the operating system environment includes a client component for accessing a network service provided by a service provider, the client component including a component for providing a substantial indication to the service provider that the network service is being accessed securely from the operating system environment which is provided by the apparatus.

78. The apparatus of claim 77, wherein the client component includes:
a client cryptographic certificate; and
a component for calculating a response to a cryptographic challenge provided by the service provider using the client cryptographic certificate.

79. The apparatus of claim 78, wherein the client component comprises a web browser that supports the secure sockets layer encryption protocol, the web browser including:
(i) an x509 client certificate; and
(ii) a component for calculating a response to a cryptographic challenge provided by the service provider, using the x509 client certificate, the cryptographic challenge and the calculated response conforming to the challenge response mechanism defined by the secure sockets layer encryption protocol.

80. The apparatus of claim 31, wherein the operating system environment includes an integrated training component for warning users of security risks.

81. The apparatus of claim 80, wherein the integrated training component includes means for providing cautionary reminders embedded in logical proximity to problematic interfaces.

82. The apparatus of claim 30, wherein the operating system environment includes:
(i) a virtual private network component for establishing a virtual private network connection; and
(ii) a network configuration component for establishing network connectivity, the network configuration component including a component for invoking the virtual private network component to establish a virtual private network connection after network connectivity is established.

83. The apparatus of claim 82, wherein the operating system environment includes a component for restricting outgoing and incoming network traffic to only allow traffic from within the virtual private network connection,
whereby the operating system environment is logically isolated from security threats on the public network through which the virtual private network connection is established.

84. The apparatus of claim 30, wherein the operating system environment includes a connectivity agent for establishing network connectivity across a variety of circumstances with minimum user interaction.

85. The apparatus of claim 84, wherein the operating system environment includes a first initialization component for initializing the operating system environment, the first initialization component including a second initialization component for invoking the connectivity agent.

86. The apparatus of claim 84, wherein the connectivity agent includes:
a component for determining network interface hardware of the computer; and
a component for attempting to establish network connectivity by iterating through each of the determined network interfaces, in a predetermined order sorted by the type of the determined network interfaces, and applying to each determined network interface appropriate predetermined default configuration parameters.

87. The apparatus of claim 86, wherein the connectivity agent includes a wireless configuration component for configuring a wireless network interface by determining a list of wireless networks that are detected by the wireless network interface, and for each wireless network in the list of wireless networks, attempting to establish network connectivity by associating the wireless network interface with the wireless network and applying to the wireless network interface appropriate predetermined default configuration parameters.

88. The apparatus of claim 87, wherein the wireless configuration component sorts the list of wireless networks detected by the wireless network interface according to the signal strength of each wireless network.

89. The apparatus of claim 86, wherein the connectivity agent includes:
a component for determining a list of wireless networks that are detected by a wireless type network interface; and
a component for interacting with a user to choose with which wireless network to associate the wireless network interface.

90. The apparatus of claim 84, wherein the connectivity agent includes:
a component for maintaining a list of previous network configurations in a predetermined storage location;
a component for updating the list of previous network configurations according to the parameters of network configurations in which network connectivity was successfully established; and
a component for attempting to establish network connectivity by applying network configurations from the list of previous network configurations.

91. The apparatus of claim 90, wherein the component for attempting to establish network connectivity includes
a component for prioritizing the order in which network configurations from the list of previous network configurations are each applied by calculating odds indicating how likely each network configuration is to work based on historical patterns.

92. The apparatus of claim 84, wherein the connectivity agent includes
a component for importing network configuration parameters from the files of the operating system installed on the computer's internal storage devices.

93. The apparatus of claim 84, wherein the connectivity agent includes
a component for testing whether an attempted configuration of the network was successful by performing a predetermined reliable operation that requires network connectivity.

94. The apparatus of claim 84, wherein the connectivity agent includes:
a manual configuration component for interacting with the user to manually provide network configuration parameters; and
a component for invoking the manual configuration component if automatic network configuration attempts fail.

95. The apparatus of claim 84, wherein the connectivity agent includes a manual override component for allowing the user to cancel automatic network configuration attempts and perform an immediate manual configuration of the network.

96. The apparatus of claim 84, wherein the operating system environment includes a client component for accessing a network service provided by a service provider, the client component including a component for providing a substantial indication to the service provider that the network service is being accessed securely from the operating system environment which is provided by the apparatus.

97. The apparatus of claim 96, wherein the client component includes:
a client cryptographic certificate; and
a component for calculating a response to a cryptographic challenge provided by the service provider using the client cryptographic certificate.

98. The apparatus of claim 97, wherein the client component comprises a web browser that supports the secure sockets layer encryption protocol, the web browser including:
(i) an x509 client certificate; and
(ii) a component for calculating a response to a cryptographic challenge provided by the service provider, using the x509 client certificate, the cryptographic challenge and the calculated response conforming to the challenge response mechanism defined by the secure sockets layer encryption protocol.

99. The apparatus of claim 30, wherein the operating system environment includes:
(i) a persistent safe storage component for storing data persistently inside at least one persistent safe storage element, the persistent safe storage element comprising an opaque container, and
(ii) a first initialization component for initializing the operating system environment, the first initialization component including:
(ii1) an access component for attempting to locate and access the persistent safe storage element; and
(ii2) a creation component for creating the persistent safe storage element if the access component fails to locate or access persistent safe storage element.

100. The apparatus of claim 99, wherein the persistent safe storage component includes
a component for setting up the opaque container as a virtual block device containing a filesystem.

101. The apparatus of claim 99, wherein the access component attempts to locate and access the persistent safe storage element within a filesystem of the local operating system on the computer's internal storage devices, and
the creation component creates the persistent safe storage element within a filesystem of the local operating system on the computer's internal storage devices.

102. The apparatus of claim 101, wherein the creation component includes:
a component for determining which internal storage partition has the most free space; and
a component for creating the persistent safe storage element automatically on the internal storage partition that is determined to have the most free space.

103. The apparatus of claim 101, wherein the creation component includes a component for interacting with the user to select the partition in which the persistent safe storage element will be created.

104. The apparatus of claim 99, wherein the first initialization component includes a component for allowing the user to choose to cancel creation of the persistent safe storage element.

105. The apparatus of claim 99, wherein the first initialization component includes a component for allowing the user to choose to purge the persistent safe storage element.

106. The apparatus of claim 99, wherein the access component attempts to locate and access the persistent safe storage element at a predetermined network storage location; and
the creation component creates the persistent safe storage element at a predetermined network storage location.

107. The apparatus of claim 99, wherein the persistent safe storage component includes
a component for encrypting the opaque container with a secret key.

108. The apparatus of claim 107, wherein the persistent safe storage component includes
a component for encrypting the secret key,
and wherein, the persistent safe storage element further comprises a key file for storing the encrypted secret key.

109. The apparatus of claim 107, wherein the persistent safe storage component includes:
a component for encrypting the secret key,
a component for embedding the encrypted secret key within the opaque container.

110. The apparatus of claim 107, further comprising:
(d) a first interface component for operatively interfacing the apparatus with a device interface port of the computer as a peripheral device, the first interface component coupled to the portable non-volatile memory element; and
(e) a cryptographic component for providing cryptographic services, the cryptographic component coupled to at least the first interface component; and wherein,
the persistent safe storage component includes a component for encrypting the secret key using the cryptographic component.

111. The apparatus of claim 107, further comprising
(d) a separate cryptographic token,
and wherein,
the persistent safe storage component includes a component for encrypting the secret key using the separate cryptographic token.

112. The apparatus of claim 107, wherein the persistent safe storage component includes:
a component for receiving a password provided by a user,
a component for encrypting the secret key using the password.

113. The apparatus of claim 99, wherein the persistent safe storage component includes
a fingerprint calculation component for calculating a fingerprint that uniquely identifies an instance of the persistent safe storage element.

114. The apparatus of claim 113, wherein the persistent safe storage component includes
a component for embedding a predetermined portion of the fingerprint within the names of the files of the persistent safe storage element.

115. The apparatus of claim 113, wherein the persistent safe storage component includes
a component for embedding a predetermined portion of the fingerprint within the contents of the files of the persistent safe storage element.

116. The apparatus of claim 113, further comprising:
(d) a first interface component for operatively interfacing the apparatus with a device interface port of the computer as a peripheral device, the first interface component coupled to the portable non-volatile memory element; and
(e) a cryptographic component for providing cryptographic services, the cryptographic component coupled to at least the first interface component; and wherein,
the fingerprint calculation component includes a component for calculating the fingerprint as the hash of a predetermined portion of the unique data stored on the cryptographic component.

117. The apparatus of claim 113, further comprising
(d) a separate cryptographic token,
and wherein,
the fingerprint calculation component includes a component for calculating the fingerprint as the hash of a predetermined portion of the unique data stored on the separate cryptographic token.

118. The apparatus of claim 113, wherein the fingerprint calculation component includes
a component for calculating the fingerprint using uniquely identifying information provided by the user.

119. The apparatus of claim 99, wherein the first initialization component includes a boot data component for maintaining within the persistent safe storage element boot data created during the boot process that is useful for enabling boot process optimizations.

120. The apparatus of claim 119, wherein the boot data component includes a component for maintaining hardware configuration parameters within the persistent safe storage element.

121. The apparatus of claim 119, wherein the boot data component includes a component for maintaining a record of initialized system state within the persistent safe storage element.

122. The apparatus of claim 99, wherein the operating system environment includes network configuration component for establishing network connectivity, the network configuration component including a component for maintaining network configuration parameters within the persistent storage element.

123. The apparatus of claim 122, wherein the network configuration component includes a connectivity agent component for establishing network connectivity across a variety of circumstances with minimum user interaction, the connectivity agent component including:
a component for maintaining a list of previous network configurations within the persistent storage element;
a component for updating the list of previous network configurations according to the parameters of network configurations in which network connectivity was successfully established; and
a component for attempting to establish network connectivity by applying network configurations from the list of previous network configurations.

124. The apparatus of claim 30, wherein the operating system environment includes a first initialization component for initializing the operating system environment, the first initialization component including:
(i) a hardware profiling component for determining current hardware profile of the computer;
(ii) a component for determining whether hardware parameters need to be configured, comprising:
(ii1) a component for determining if a previous hardware profile has been previously saved to a predetermined storage location, and
(ii2) a component for determining if hardware profile has changed by comparing the current hardware profile with the previous hardware profile if it is determined that the previous hardware profile exists; and
(iii) a component for configuring and saving hardware parameters if it is determined that hardware parameters need to be configured, comprising:
(iii1) a hardware configuration component for determining hardware configuration parameters,
(iii2) a component for saving determined hardware configuration parameters within a predetermined storage location, and
(iii3) a component for saving current hardware profile within a predetermined storage location; and
(iv) a component for loading hardware drivers based on saved hardware configuration parameters.

125. The apparatus of claim 124, wherein the hardware profiling component includes a component for querying the BUS of the computer for hardware identification information.

126. The apparatus of claim 124, wherein the hardware configuration component includes
a component for importing hardware configuration parameters from the files of the operating system installed on the computer's internal storage devices.

127. The apparatus of claim 124, wherein the hardware configuration component includes
a component for looking up hardware configuration parameters in a database that associates hardware configuration parameters with hardware information that can be derived from the current hardware profile.

128. The apparatus of claim 124, wherein the hardware configuration component includes
a component for interacting with the user to manually provide hardware configuration parameters.

129. The apparatus of claim 30, wherein the operating system environment includes a first initialization component for initializing the operating system environment, the first initialization component including
a state maintenance component for maintaining a record of initialized system state within a predetermined storage location.

130. The apparatus of claim 129, wherein the state maintenance component comprises:
(i) a hardware profiling component for determining a current hardware profile of the computer;
(ii) component for determining whether the computer's hardware profile has changed, comprising:
(ii1) component for determining if a previous hardware profile which has been previously saved to a predetermined storage location exists;
(ii2) component for determining if hardware profile has changed by comparing the current hardware profile with the previous hardware profile if it is determined that the previous hardware profile exists;
(iii) component for determining if a record of initialized system state has been previously saved to a predetermined storage location.
(iv) component for restoring state of the computer from the previously saved record of initialized system state, if previously saved record of initialized system state exists and if it is determined the computer's hardware profile has not changed since the previously saved record of initialized system state was created;
(v) component for creating a record of initialized system state and saving it to a predetermined storage location along with the current hardware profile, if a previously saved hardware profile does not exist, or if it is determined that the hardware profile has changed.

131. The apparatus of claim 129, wherein the state maintenance component includes:
component for creating an efficient record of initialized system state that requires only memory pages that are allocated to be saved; and
component for restoring system state from the efficient record of initialized system state.

132. The apparatus of claim 30, wherein the operating system environment includes:
(i) logical volume management component for storing data inside a logical volume element, and
(ii) first initialization component for initializing the operating system environment, the first initialization component including:
(ii1) an access component for attempting to locate and access the logical volume element on the computer's internal storage devices; and
(ii2) a creation component for creating the logical volume element on the computer's internal storage devices if the access component fails to locate or access logical volume element.

133. The apparatus of claim 132, wherein the creation component includes a configuration dialog component for interacting with the user to configure which partitions of the computer's internal storage devices are pooled into creation of the logical volume element.

134. The apparatus of claim 133, wherein the configuration dialog component includes:
a component for calculating a recommended configuration for the logical volume element; and
a component for allowing the user to choose to configure the logical volume element according to the calculated recommended configuration.

135. The apparatus of claim 134, wherein the component for calculating a recommended configuration includes
a component for detecting empty partitions which can be safely pooled into creation of the logical volume element without loosing data.

136. The apparatus of claim 133, wherein the configuration dialog component includes
a partition identification component for displaying the identifying information of a partition.

137. The apparatus of claim 136, wherein the partition identification component includes a component selected from the group consisting of:
a component for displaying the filesystem contents of a partition;
a component for displaying the type of filesystem contained in a partition;
a component for displaying a partition's label;
a component for displaying the size of a partition; and
a component for displaying the type of a partition.

138. The apparatus of claim 132, wherein the access component includes a component for attempting to locate a partition containing the configuration parameters of the logical volume element,
and wherein,
the creation component includes a component for creating a partition containing the configuration parameters of the logical volume element.

139. The apparatus of claim 30, wherein the operating system environment includes:
(i) a first software application, and
(ii) a migration agent for migrating application data between the first software application and a second software application that is substantially isomorphic to the first software application.

140. The apparatus of claim 139, wherein the operating system environment includes a first initialization component for initializing the operating system environment, the first initialization component including:
a component for determining if a local operating system is stored in the computer's internal storage devices; and
a component for executing the migration agent if it is determined that the local operating system exists.

141. The apparatus of claim 139, wherein the application data that is migrated by the migration agent includes predetermined types of application content data and application configuration data.

142. The apparatus of claim 139, wherein the first software application is selected from the group consisting of:
a web browser;
an email client; and
an instant messenger client.

143. The apparatus of claim 139, wherein the first software application is selected from the group consisting of:
a web server;
a mail server;
a database server;
a file server;
a name server; and
a firewall.

144. The apparatus of claim 139, wherein the migration agent includes a data migration component for migrating application data from the data files of the second software application to the data files of the first software application, the data migration component including:
(i) a data parsing component for parsing the data files of the second software application to extract a plurality of data elements;
(ii) a translating component for translating each of the data elements extracted by the data parsing component into the closest analog supported by the first software application; and
(iii) a component for saving the data elements translated by the translating component to the data files of the first software application.

145. The apparatus of claim 144, wherein the data parsing component includes:
(i1) a component for loading a predetermined portion of the second software application containing predetermined software routines for reading the data files of the second software application; and
(i2) a component for calling the predetermined software routines to leverage the data parsing functionality provided by the second software application.

146. The apparatus of claim 145, wherein the data parsing component further includes:
(i3) a component for calculating a hash of the predetermined portion of the second software application containing predetermined software routines for reading the data files of the second software application; and
(i4) a hash verification component for verifying the integrity of the predetermined portion of the second software application by looking up the calculated hash in a whitelist of known good hashes.

147. The apparatus of claim 146, wherein the hash verification component includes a component for updating the whitelist of known good hashes over the network.

148. The apparatus of claim 139, wherein the migration agent includes a component for providing the user with a navigational interface for specifying the location of exported application data or backup archives created by the second software application.

149. The apparatus of claim 139, wherein the migration agent includes a component for providing the user with the choice of searching automatically to locate the second software application within the filesystems on the computer's internal storage devices.

150. The apparatus of claim 139, wherein the migration agent includes an application search component for searching automatically to locate the second software application,
the application search component including:
(i) an enumeration component for enumerating resources of the local operating system stored on the computer's internal storage devices; and
(ii) a pattern matching component for attempting to match the resources enumerated by the enumeration component against a list comprising at least one signature pattern identifying the second software application.

151. The apparatus of claim 150, wherein the enumeration component includes:
(i1) a component for locating the Microsoft windows registry within the filesystems on the computer's internal storage devices; and
(i2) a registry enumeration component for enumerating the Microsoft windows registry to extract registry keys and values, and wherein,
the pattern matching component includes a component for attempting to match the registry keys and values extracted by the registry enumeration component against a list comprising at least one predetermined registry signature pattern identifying the second software application.

152. The apparatus of claim 150, wherein the enumeration component includes a filesystem enumeration component for recursively enumerating the directory and file names within the filesystems of the local operating system stored on the computer's internal storage devices,
and wherein,
the pattern matching component includes a component for attempting to match the names of files and directories enumerated by the filesystem enumeration component against a list comprising at least one predetermined signature pattern identifying the second software application.

153. The apparatus of claim 150, wherein the enumeration component includes a GUI enumeration component for enumerating the GUI interfaces of the local operating system environment stored on the computer's internal storage devices to extract GUI elements,
and wherein,
the pattern matching component includes a component for attempting to match the GUI elements extracted by the GUI enumeration component against a list comprising at least one predetermined GUI element signature pattern identifying the second software application.

154. The apparatus of claim 150, wherein the application search component further includes: a component for updating the list of signature patterns identifying the second software application over the network.

155. The apparatus of claim 139, wherein the migration agent includes a synchronization component for synchronizing application data between the first software application and the second software application,
the synchronization component including a component for adjusting the data files of the first software application and the second software application so that the semantical content of both is substantially equivalent.

156. The apparatus of claim 155, wherein the synchronization component includes a conflict detection component for determining that a synchronization conflict has occurred,
and wherein,
the migration agent further includes a component for interacting with the user to determine whether to prefer data from the first software application or the second software application when the conflict detection component determines that a synchronization conflict has occurred.

157. The apparatus of claim 155, wherein the migration agent further includes a synchronization trigger component for interacting with the user to specify the triggering criteria according to which synchronization of application data will be automatically performed,
and wherein,
the operating system environment further includes a component for triggering the synchronization component according to the triggering criteria specified by the user in the synchronization trigger component.

158. The apparatus of claim 157, wherein the synchronization trigger component includes an event configuration component for interacting with the user to specify systems events as the triggering criteria according to which synchronization of application data will be automatically performed,
and wherein,
the operating system environment further includes a component for triggering the synchronization component according to the system events specified by the user in the event configuration component.

159. The apparatus of claim 157, wherein the synchronization trigger component includes a synchronization scheduling component for interacting with the user to specify a chronological schedule as the triggering criteria according to which synchronization of application data will be automatically performed,
and wherein,
the operating system environment further includes a component for triggering the synchronization component according to the chronological schedule specified by the user in the synchronization scheduling component.

160. A method for providing an independent secure operating system environment on a computer, comprising:
(a) providing a portable non-volatile memory element;
(b) storing an operating system environment on the portable non-volatile memory element; and
(c) providing a bootloader for initial bootstrapping of the operating system environment from the portable non-volatile memory element, wherein initialization of the operating system environment is started by booting the computer from the portable non-volatile memory element using the bootloader.

161. The method of claim 160, wherein the operating system environment includes a plurality of security mechanisms that are configured to provide a substantially fault-tolerant multi layered security architecture.

162. The method of claim 161, further comprising
(e) providing a first interface that is compatible with a device interface port of the computer, the first interface coupled to the portable non-volatile memory element, wherein the portable non-volatile memory element can be operatively connected to the device interface port of the computer as a peripheral device.

163. The method of claim 162, wherein the type of the first interface is selected from the group consisting of universal serial bus (USB) and firewire and personal computer memory card international association (PCMCIA) and secure digital input output (SDIO) interface types.

164. The method of claim 162, further comprising
(f) providing at least one additional interface, the type of the additional interface differing from the type of the first interface.

165. The method of claim 162, further comprising
(f) providing a hardware cryptographic component, the hardware cryptographic component operatively connected to at least the first interface.

166. The method of claim 165, further comprising
(g) providing a physical casing surrounding at least the hardware cryptographic component, the physical casing being substantially tamper resistant, wherein tampering with the physical casing will trigger the destruction of secret cryptographic data that is stored on the hardware cryptographic component.

167. The method of claim 165, wherein the hardware cryptographic component is substantially resistant to tampering.

168. The method of claim 165, wherein the hardware cryptographic component is configured to provide public key cryptographic services.

169. The method of claim 168, wherein the public key cryptographic services the hardware cryptographic component is configured to provide includes:
secure generation and storage of private keys; and
public-key decryption and encryption operations.

170. The method of claim 165, wherein the hardware cryptographic component includes a hardware element within which secret cryptographic data is stored, wherein the hardware element is detachable.

171. The method of claim 165, wherein the hardware cryptographic component is configured to conform to a standard authentication token interface protocol, whereby other devices that support standard authentication token interface protocols can interface with the cryptographic functions of the hardware cryptographic component.

172. The method of claim 171, wherein the hardware cryptographic component is configured to conform to the Cryptoki (PKCS 11) token standard.

173. The method of claim 171, wherein the hardware cryptographic component is configured to conform to the ISO 7816 standard.

174. The method of claim 162, further comprising
(f) providing a biometrical sensor for measuring unique biological metrics, the biometrical sensor coupled to at least the first interface.

175. The method of claim 174, wherein the biometrical sensor is a fingerprint reader.

176. The method of claim 174, further comprising
(g) providing a hardware cryptographic component, the hardware cryptographic component coupled to at least the first interface,
whereby the operating system environment can support 2-factor authentication without using passwords.

177. The method of claim 162, further comprising
(f) providing a physical casing surrounding at least the portable non-volatile memory element.

178. The method of claim 177, wherein the physical casing includes a visual mark of authenticity.

179. The method of claim 178, wherein the visual mark of authenticity comprises a hologram.

180. The method of claim 177, wherein the physical casing includes a signature area.

181. The method of claim 177, wherein the physical casing provides substantial resistance to tampering.

182. The method of claim 181, wherein tampering with the physical casing will render the portable non-volatile memory element inoperative.

183. The method of claim 161, wherein the portable non-volatile memory element is storage media that is compatible with media read/write interfaces of the computer.

184. The method of claim 183, wherein the type of the storage media is selected from the group consisting of optical and magnetic and solid state storage media types.

185. The method of claim 183, wherein the storage media is an optical media type in miniature form.

186. The method of claim 183, wherein the storage media provides a visual mark of authenticity.

187. The method of claim 183, wherein the storage media provides a signature area.

188. The method of claim 161, wherein the portable non-volatile memory element is physically read-only.

189. The method of claim 161, wherein the act of initializing the operating system environment on the computer includes loading a predetermined portion of the operating system environment into the computer's main memory if enough the main memory is available.

190. The method of claim 189, wherein the act of loading a predetermined portion of the operating system environment into the computer's main memory, comprises loading a large enough portion of the operating system environment into the main memory so that the computer no longer needs to read from the portable non-volatile memory element.

191. The method of claim 161, wherein the bootloader is contained on the portable non-volatile memory element,
wherein the act of initializing the operating system environment on the computer is started by booting the computer directly from the portable non-volatile memory element.

192. The method of claim 161, wherein the bootloader is contained on a separate storage media, the separate storage media of a type that the BIOS of the computer supports booting from,
the operating system environment includes main initialization software for initiating the operating system environment,
and the separate storage media contains first initialization software for loading the software necessary for accessing the operating system environment stored on the portable non-volatile memory element and thereafter invoking the main initialization software,
wherein,
the act of initializing the operating system environment on the computer is started by booting the computer using the bootloader contained on the separate storage media, the bootloader starting the first initialization software which transfers control of the boot process to the main initialization software, after accessing the operating system environment.

193. The method of claim 161, further comprising
(e) providing a separate cryptographic token.

194. The method of claim 161, further comprising
(e) storing an autorun element on the portable non-volatile memory element for automatically executing a predetermined software program when the portable non-volatile memory element is interfaced with the computer while the computer is running a local operating system on the computer.

195. The method of claim 194, wherein the predetermined software program executed by the autorun element includes software selected from the group consisting of:
(i) software that provides a user manual;
(ii) software that helps a user reconfigure the computer's BIOS; and
(iii) software that helps the user create boot disks.

196. The method of claim 194, wherein the predetermined software program executed by the autorun element includes software for causing the local operating system to invoke a hibernation mode which preserves the state of the local operating system's running applications before rebooting the computer from the portable non-volatile memory element.

197. The method of claim 161, wherein the operating system environment includes:
(i) network configuration software for establishing network connectivity; and
(ii) virtual private network software for establishing a virtual private network connection;
wherein,
the network configuration software invokes the virtual private network software to establish a virtual private network connection after network connectivity is established.

198. The method of claim 197, wherein the operating system environment is configured to
allow outgoing and incoming network traffic exclusively from the virtual private network connection established by the virtual private network software,
whereby the operating system environment is logically isolated from security threats on the public network through which the virtual private network connection is established.

199. The method of claim 161, wherein the operating system environment includes personal firewall software configured to enforce a predetermined network access control policy for substantially preventing unauthorized network traffic to and from client and server side applications of the operating system environment.

200. The method of claim 161, wherein the operating system environment includes a mandatory access control security mechanism configured to enforce a predetermined operating system level access control policy for substantially limiting the potential damage that the compromise of any individual software component of the operating system environment will have on the security provided by the operating system environment.

201. The method of claim 200, wherein the predetermined operating system level access control policy is configured to
substantially minimize the privileges of each individual software component of the operating system environment, to the reduced set of privileges each individual software component needs to carry out its function.

202. The method of claim 161, wherein the operating system environment includes a trusted path execution security mechanism configured to prevent execution of software programs whose executable files are not in predetermined trusted filesystem paths.

203. The method of claim 161, wherein the operating system environment includes a logical compartment security mechanism configured to contain predetermined compartmentalized software programs within at least one logical compartment, wherein the predetermined compartmentalized software programs are logically isolated from the rest of the operating system environment.

204. The method of claim 203, wherein the type of logical compartment security mechanism is selected from the group consisting of unix chroot and user mode linux and vmware and xen logical compartment types.

205. The method of claim 161, wherein the operating system environment includes a raw input output and memory protection security mechanism configured to prevent direct raw access to the operating system's virtual memory and to the operating system's hardware input output interfaces.

206. The method of claim 161, wherein the operating system environment includes an exploit countermeasure configured to harden the operating system environment for preventing the exploitation of a predetermined group of vulnerability types in software components of the operating system environment.

207. The method of claim 206, wherein the exploit countermeasure includes a memory bounds violation exploitation countermeasure for increasing how difficult it is to exploit memory bounds violation vulnerability types in software components of the operating system environment.

208. The method of claim 206, wherein the exploit countermeasure includes a race condition exploitation countermeasure for increasing how difficult it is to exploit race condition vulnerability types in software components of the operating system environment.

209. The method of claim 161, wherein the operating system environment includes a predetermined group of software components which are compiled with a compiler toolchain that hardens the predetermined group of software components for preventing the exploitation of a predetermined group of vulnerability types in the predetermined group of software components.

210. The method of claim 209, wherein the compiler toolchain that is used to harden the predetermined group of software components is selected from the group consisting of gnu compiler toolchain with the ssp patch applied and gnu compiler toolchain with the stackguard patch applied.

211. The method of claim 209, wherein the compiler toolchain that is used to harden the predetermined group of software components provides substantial runtime protection against exploitation of buffer overflows vulnerability types in the predetermined group of software components.

212. The method of claim 161, wherein the operating system environment includes a client application for accessing a network service provided by a service provider, and wherein,
the client application is configured to provide a substantial indication to the service provider that the network service is being accessed securely from the operating system environment.

213. The method of claim 212, wherein the client application includes a client side cryptographic certificate,
wherein the client side cryptographic certificate is used by the client application to calculate a response to a cryptographic challenge provided by the service provider.

214. The method of claim 213, wherein the client application comprises a web browser that supports the secure sockets layer encryption protocol, the web browser including an x509 client side certificate,
wherein the x509 client side certificate is used by the web browser to calculate a response to a cryptographic challenge provided by the service provider, the cryptographic challenge and the calculated response conforming to the challenge response mechanism defined by the secure sockets layer encryption protocol.

215. The method of claim 161, wherein the operating system environment includes integrated training materials for warning users of security risks.

216. The method of claim 215, wherein the integrated training materials include cautionary reminders embedded in logical proximity to problematic interfaces.

217. The method of claim 160, wherein the operating system environment includes:
(i) virtual private network software for establishing a virtual private network connection; and
(ii) network configuration software for establishing network connectivity, wherein the network configuration software invokes the virtual private network software to establish a virtual private network connection after network connectivity is established.

218. The method of claim 217, wherein the operating system environment is configured to allow outgoing and incoming network traffic exclusively from the virtual private network connection established by the virtual private network software,
whereby the operating system environment is logically isolated from security threats on the public network through which the virtual private network connection is established.

219. The method of claim 160, wherein the operating system environment includes connectivity agent software for establishing network connectivity across a variety of circumstances with minimum user interaction.

220. The method of claim 219, wherein the act of initializing the operating system environment on the computer includes executing the connectivity agent software.

221. The method of claim 219, wherein the connectivity agent software is configured to
determine network interface hardware of the computer, and for each network interface, in a predetermined order sorted by the type of the network interface, attempts to establish network connectivity by applying to the network interface appropriate predetermined default configuration parameters.

222. The method of claim 221, wherein the connectivity agent software is further configured to
establish network connectivity with a wireless network interface by determining a list of wireless networks that are detected by the wireless network interface, and for each wireless network in the list of wireless networks, attempting to establish network connectivity by associating the wireless network interface with the wireless network and applying to the wireless network interface appropriate predetermined default configuration parameters.

223. The method of claim 222, wherein the connectivity agent software is further configured to
sort the list of wireless networks detected by the wireless network interface according to the signal strength of each wireless network.

224. The method of claim 221, wherein the connectivity agent software is further configured to
establish network connectivity with a wireless network interface by determining a list of wireless networks that are detected by the wireless network interface, and allowing the user to interact with the connectivity agent software to influence with which wireless network to associate the wireless network interface.

225. The method of claim 219, wherein the connectivity agent software is configured to
maintain a list of previous network configurations saved to a predetermined storage location, the list of previous network configurations updated according to the parameters of network configurations in which network connectivity was successfully established,
wherein,
the connectivity agent software will attempt to apply network configurations from the list of previous network configurations to establish network connectivity.

226. The method of claim 225, wherein the order in which the connectivity agent software attempts to apply network configurations from the list of previous network configurations, is prioritized according to odds that are calculated based on historical patterns which are used to determine how likely each network configuration is to work.

227. The method of claim 219, wherein the connectivity agent software is configured to
import network configuration parameters from the files of the operating system installed on the computer's internal storage devices.

228. The method of claim 219, wherein the connectivity agent software is configured to
perform a predetermined reliable operation that requires network connectivity as a test for determining whether an attempted configuration of the network was successful.

229. The method of claim 219, wherein the connectivity agent software is configured to
interact with the user to manually provide network configuration parameters if automatic network configuration attempts fail.

230. The method of claim 219, wherein the connectivity agent software is configured to
provide a manual override option for allowing the user to cancel automatic network configuration attempts and perform an immediate manual configuration of the network.

231. The method of claim 219, wherein the operating system environment includes a client application for accessing a network service provided by a service provider, and wherein,
the client application is configured to provide a substantial indication to the service provider that the network service is being accessed securely from the operating system environment.

232. The method of claim 231, wherein the client application includes a client side cryptographic certificate,
wherein the client side cryptographic certificate is used by the client application to calculate a response to a cryptographic challenge provided by the service provider.

233. The method of claim 232, wherein the client application comprises a web browser that supports the secure sockets layer encryption protocol, the web browser including an x509 client side certificate,
wherein the x509 client side certificate is used by the web browser to calculate a response to a cryptographic challenge provided by the service provider, the cryptographic challenge and the calculated response conforming to the challenge response mechanism defined by the secure sockets layer encryption protocol.

234. The method of claim 160, wherein the operating system environment includes software that defines a persistent safe storage mechanism for storing data persistently inside at least one persistent safe storage element, the persistent safe storage element comprising at least an opaque container,
and wherein,
the act of initializing the operating system environment on the computer includes:
(i) attempting to locate and access the persistent safe storage element; and
(ii) creating the persistent safe storage element if the persistent safe storage element can not be located or accessed.

235. The method of claim 234, wherein the software that defines a persistent safe storage mechanism is configured to setup the opaque container as a virtual block device containing a filesystem.

236. The method of claim 234, wherein the act of attempting to locate and access the persistent safe storage element, comprises attempting to locate and access the persistent safe storage element within a filesystem of the local operating system on the computer's internal storage devices, and
the act of creating the persistent safe storage element if the persistent safe storage element can not be located or accessed, comprises creating the persistent safe storage element within a filesystem of the local operating system on the computer's internal storage devices.

237. The method of claim 236, wherein the act of creating the persistent safe storage element within a filesystem of the local operating system on the computer's internal storage devices includes
automatically creating the persistent safe storage element on the internal storage partition that has the most free space.

238. The method of claim 236, wherein the act of creating the persistent safe storage element within a filesystem of the local operating system on the computer's internal storage devices includes
interacting with the user to select the partition in which the persistent safe storage element will be created.

239. The method of claim 234, wherein the act of initializing the operating system environment on the computer includes
providing the user a choice to cancel the creation of the persistent storage element if the persistent safe storage element can not be located or accessed.

240. The method of claim 234, wherein the act of initializing the operating system environment on the computer includes
providing the user a choice to purge the persistent safe storage element.

241. The method of claim 234, wherein the act of attempting to locate and access the persistent safe storage element comprises attempting to locate and access the persistent safe storage element at a predetermined network storage location, and the act of creating the persistent safe storage element if the persistent safe storage element can not be located or accessed comprises creating the persistent safe storage element at a predetermined network storage location.

242. The method of claim 234, wherein the software that defines a persistent safe storage mechanism is configured to
encrypt the opaque container with a secret key.

243. The method of claim 242, wherein the software that defines a persistent safe storage mechanism is further configured to
encrypt the secret key,
and wherein,
the persistent safe storage element further comprises a key file in which the encrypted secret key is stored.

244. The method of claim 242, wherein the software that defines a persistent safe storage mechanism is further configured to:
encrypt the secret key; and
embed the encrypted secret key within the opaque container.

245. The method of claim 242, further comprising:
(e) providing a first interface that is compatible with a device interface port of the computer, the first interface coupled to at least the portable non-volatile memory element, wherein the portable non-volatile memory element can be operatively connected to the device interface port of the computer as a peripheral device; and
(f) providing a hardware cryptographic component, the hardware cryptographic component coupled to at least the first interface;
and wherein,
the software that defines a persistent safe storage mechanism is further configured to encrypt the secret key using the hardware cryptographic component.

246. The method of claim 242, further comprising
(e) providing a separate cryptographic token,
and wherein,
the software that defines a persistent safe storage mechanism is further configured to encrypt the secret key using the separate cryptographic token.

247. The method of claim 242, wherein the software that defines a persistent safe storage mechanism is further configured to
encrypt the secret key using a password provided by the user.

248. The method of claim 234, wherein the software that defines a persistent safe storage mechanism is configured to
calculate a fingerprint for uniquely identifying the persistent safe storage element.

249. The method of claim 248, wherein a predetermined portion of the fingerprint is embedded within the names of the files of the persistent safe storage element.

250. The method of claim 248, wherein a predetermined portion of the fingerprint is embedded within the contents of the files of the persistent safe storage element.

251. The method of claim 248, further comprising:
(e) providing a first interface that is compatible with a device interface port of the computer, the first interface coupled to at least the portable non-volatile memory element, wherein the portable non-volatile memory element can be operatively connected to the device interface port of the computer as a peripheral device; and
(f) providing a hardware cryptographic component, the hardware cryptographic component coupled to at least the first interface;
and wherein,
the fingerprint is calculated as the fingerprint of a predetermined portion of the unique data stored on the hardware cryptographic component.

252. The method of claim 248, further comprising
(e) providing a separate cryptographic token,
and wherein,
the fingerprint is calculated as the fingerprint of a predetermined portion of the unique data stored on the separate cryptographic token.

253. The method of claim 248, wherein the fingerprint is calculated from uniquely identifying information provided by the user.

254. The method of claim 234, wherein the act of initializing the operating system environment on the computer includes
maintaining within the persistent safe storage element first boot data created during the boot process that is useful for enabling boot process optimizations.

255. The method of claim 254, wherein the first boot data includes
hardware configuration parameters.

256. The method of claim 254, wherein the first boot data includes
a record of initialized system state.

257. The method of claim 234, wherein the operating system environment includes network configuration software for establishing network connectivity, wherein the network configuration software is configured to maintain network configuration parameters within the persistent storage element.

258. The method of claim 257, wherein the network configuration software includes connectivity agent software for establishing network connectivity across a variety of circumstances with minimum user interaction,
wherein the connectivity agent software is configured to maintain a list of previous network configurations saved to the persistent storage element, the list of previous network configurations adjusted according to the parameters of network configurations in which network connectivity was successfully established, wherein, the connectivity agent software will attempt to apply network configurations from the list of previous network configurations to establish network connectivity.

259. The method of claim 160, wherein the act of initializing the operating system environment on the computer includes:
(i) determining current hardware profile of the computer;
(ii) if a previous hardware profile which has been previously saved to a predetermined storage location exists, then comparing the current hardware profile with the previous hardware profile;
(iii) if the current hardware profile does not equal the previous hardware profile, or if the previous hardware profile does not exist, then:
(iii1) determining hardware configuration parameters,
(iii2) saving determined hardware configuration parameters to a predetermined storage location, and
(iii3) saving current hardware profile to a predetermined storage location; and
(iv) loading hardware drivers based on saved hardware configuration parameters.

260. The method of claim 259, wherein the act of determining the current hardware profile of the computer comprises
querying the BUS of the computer for hardware identification information.

261. The method of claim 259, wherein the act of determining hardware configuration parameters includes
importing hardware configuration parameters from the files of the operating system installed on the computer's internal storage devices.

262. The method of claim 259, wherein the act of determining hardware configuration parameters includes
looking up hardware configuration parameters in a database that associates hardware configuration parameters with hardware information that can be derived from the current hardware profile.

263. The method of claim 259, wherein the act of determining hardware configuration parameters includes
interacting with the user to manually provide hardware configuration parameters.

264. The method of claim 160, wherein the act of initializing the operating system environment on the computer includes
maintaining a record of initialized system state.

265. The method of claim 264, wherein the act of maintaining a record of initialized system state comprises:
(i) determining a current hardware profile of the computer;
(ii) if a previous hardware profile which has been previously saved to a predetermined storage location exists, then comparing the current hardware profile with the previous hardware profile;
(iii) if the current hardware profile is equal to the previous hardware profile, and if a record of initialized system state has been previously saved to a predetermined storage location, then restoring state of the computer from the previously saved record of initialized system state;
(iv) if the current hardware profile does not equal the previous hardware profile, or if the previous hardware profile does not exist, then:
(iv1) saving record of initialized system state to a predetermined storage location; and
(iv2) saving current hardware profile to a predetermined storage location;

266. The method of claim 264, wherein the record of initialized system state requires only memory pages that are allocated to be saved as part of the record of initialized system state.

267. The method of claim 160, wherein the operating system environment includes logical volume management software for storing data inside a logical volume element,
and wherein,
the act of initializing the operating system environment on the computer includes:
(i) attempting to locate and access the logical volume element within the computer's internal storage devices; and
(ii) creating the logical volume element within the computer's internal storage devices if the logical volume element can not be located or accessed.

268. The method of claim 267, wherein the act of creating the logical volume element if the logical volume element can not be located or accessed includes
interacting with the user to configure which partitions of the computer's internal storage devices will not be pooled into creation of the logical volume element.

269. The method of claim 268, wherein the act of interacting with the user to configure which partitions of the computer's internal storage devices will not be pooled into creation of the logical volume element includes:
calculating a recommended configuration for the logical volume element according to predetermined rules that are optimized for a predetermined usage context; and
allowing the user to choose to configure the logical volume element according to the calculated recommended configuration.

270. The method of claim 269, wherein the act of calculating a recommended configuration for the logical volume element comprises
determining which partitions of the computer's internal storage devices contain filesystems which are not empty.

271. The method of claim 268, wherein the act of interacting with the user to configure which partitions of the computer's internal storage devices will not be pooled into creation of the logical volume element includes
displaying for each partition identifying information.

272. The method of claim 271, wherein the identifying information displayed for each partition includes partition information selected from the group consisting of:
partition filesystem contents;
partition filesystem type;
partition label;
partition size; and
partition type.

273. The method of claim 267, wherein the act of attempting to locate and access the logical volume element includes attempting to locate a bootstrap partition containing the configuration parameters for the logical volume element, and
the act of creating the logical volume element if the logical volume element can not be located or accessed includes creating a bootstrap partition containing the configuration parameters for the logical volume element.

274. The method of claim 160, wherein the operating system environment includes:
(i) a first software application configured to maintain its data files in a predetermined storage location; and
(ii) migration agent software for migrating application data between the data files of the first software application and the data files of a second software application that is substantially isomorphic to the first software application.

275. The method of claim 274, wherein the act of initializing the operating system environment on the computer includes:
determining if a local operating system is stored in the computer's internal storage devices; and
executing the migration agent software if it is determined that the local operating system exists.

276. The method of claim 274, wherein the application data that is migrated by the migration agent software includes predetermined types of application content data and application configuration data.

277. The method of claim 274, wherein the first software application is selected from the group consisting of:
a web browser;
an email client;
an instant messenger client; and
a voice over ip (VoIP) client.

278. The method of claim 274, wherein the first software application is selected from the group consisting of:
a web server;
a mail server;
a database server;
a file server;
a name server;
a firewall;
an intrusion detection system; and
an intrusion prevention system.

279. The method of claim 274, wherein the migration agent software is configured to migrate application data from the data files of the second software application to the data files of the first software application by:
(i) parsing the data files of the second software application to extract a plurality of data elements;
(ii) translating each of the extracted data elements into the closest analog supported by the first software application; and
(iii) saving the translated data elements to the data files of the first software application.

280. The method of claim 279, wherein the migration agent software is configured to parse the data files of the second software application by:
(i1) loading a predetermined portion of the second software application containing predetermined software routines for reading the data files of the second software application; and
(i2) calling the predetermined software routines to leverage the required software functionality provided by the second software application.

281. The method of claim 280, wherein the migration agent software is configured to calculate a hash of the predetermined portion of the second software application containing predetermined software routines for reading the data files of the second software application, and
verify the integrity of the predetermined portion of the second software application by looking up the calculated hash in a whitelist of known good hashes.

282. The method of claim 281, wherein the migration agent software is configured to update the whitelist of known good hashes over the network.

283. The method of claim 274, wherein the migration agent software is configured to provide the user with a navigational interface for specifying the location of exported application data or backup archives created by the second software application.

284. The method of claim 274, wherein the migration agent software is configured to provide the user with the choice of searching automatically to locate the second software application within the filesystems of the local operating system stored on the computer's internal storage devices.

285. The method of claim 274, wherein the migration agent software is configured to search automatically to locate the second software application by:
(i) enumerating resources of the local operating system stored on the computer's internal storage devices; and
(ii) attempting to match the enumerated resources against a list comprising at least one signature pattern identifying the second software application.

286. The method of claim 285, wherein the migration agent software is configured to search automatically to locate the second software application by:
(i) locating the Microsoft windows registry within the filesystems on the computer's internal storage devices;
(ii) enumerating the Microsoft windows registry to extract registry keys and values; and
(iii) attempting to match the extracted registry keys and values against a list comprising at least one predetermined registry signature pattern identifying the second software application.

287. The method of claim 285, wherein the migration agent software is configured to search automatically to locate the second software application by:
(i) enumerating recursively the directory and file names within the filesystems of the local operating system stored on the computer's internal storage devices; and
(ii) attempting to match the names of files and directories against a list comprising at least one predetermined signature pattern identifying the second software application.

288. The method of claim 285, wherein the migration agent software is configured to search automatically to locate the second software application by:
(i) enumerating the GUI interfaces of the local operating system environment stored on the computer's internal storage devices to extract GUI elements; and
(ii) attempting to match the extracted GUI elements against a list comprising at least one predetermined GUI element signature pattern identifying the second software application.

289. The method of claim 285, wherein the migration agent software is configured to update the list of signature patterns identifying the second software application over the network.

290. The method of claim 274, wherein the migration agent software is configured to support synchronization of application data between the first software application and the second software application,
wherein synchronization of application data adjusts the data files of the first software application and the second software application so that the semantical content of both is substantially equivalent.

291. The method of claim 290, wherein the migration agent software is configured to interact with the user to determine whether to prefer data from the first software application or the second software application when a synchronization conflict occurs.

292. The method of claim 290, wherein the migration agent software is configured to allow the user to specify the triggering criteria according to which synchronization of application data will be automatically performed.

293. The method of claim 292, wherein the migration agent software is configured to allow the user to specify systems events as the triggering criteria according to which synchronization of application data will be automatically performed.

294. The method of claim 292, wherein the migration agent software is configured to allow the user to specify a chronological schedule as the triggering criteria according to which synchronization of application data will be automatically performed.

295. A method for providing an independent operating system environment on a computer, comprising:
(a) inserting into the computer an apparatus that the computer can boot from, the apparatus comprising:
(a1) a portable non-volatile memory element,
(a2) an operating system environment stored on the portable non-volatile memory element, and
(a3) a bootloader for booting the operating system environment from the portable non-volatile memory element; and
(b) booting the computer from the apparatus.

296. The method of claim 295, wherein the apparatus that a computer can boot from further comprises:
(i) a first interface component for operatively interfacing the apparatus with a device interface port of the computer as a peripheral device, the first interface component coupled to the portable non-volatile memory element; and
(ii) a cryptographic component for providing cryptographic services, the cryptographic component coupled to at least the first interface component.

297. The method of claim 295, wherein the operating system environment includes a connectivity agent component for establishing network connectivity across a variety of circumstances with minimum user interaction.

298. The method of claim 295, wherein the operating system environment includes a plurality of security mechanisms that are configured to provide a substantially fault-tolerant multi layered security architecture.

299. The method of claim 295, wherein the operating system environment includes:
(i) a virtual private network component for establishing a virtual private network connection, and
(ii) a network configuration component for establishing network connectivity, the network configuration component including a component for invoking the virtual private network component to establish a virtual private network connection after network connectivity is established.

300. The method of claim 295, wherein the operating system environment includes:
(i) a first software application, and
(ii) a migration agent for migrating application data between the first software application and a second software application that is substantially isomorphic to the first software application.

301. The method of claim 295, wherein the operating system environment includes:
(i) logical volume management component for storing data inside a logical volume element, and
(ii) first initialization component for initializing the operating system environment, the first initialization component including:
(ii1) an access component for attempting to locate and access the logical volume element on the computer's internal storage devices; and (ii2) a creation component for creating the logical volume element on the computer's internal storage devices if the access component fails to locate or access logical volume element.

302. The method of claim 295, wherein the operating system environment includes:
(i) a persistent safe storage component for storing data persistently inside at least one persistent safe storage element, the persistent safe storage element comprising an opaque container, and
(ii) a first initialization component for initializing the operating system environment, the first initialization component including:
(ii1) an access component for attempting to locate and access the persistent safe storage element; and
(ii2) a creation component for creating the persistent safe storage element if the access component fails to locate or access persistent safe storage element.

303. The method of claim 295, wherein the operating system environment includes a first initialization component for initializing the operating system environment, the first initialization component including:
(i) a hardware profiling component for determining current hardware profile of the computer;
(ii) a component for determining whether hardware parameters need to be configured, comprising:
(ii1) a component for determining if a previous hardware profile has been previously saved to a predetermined storage location, and
(ii2) a component for determining if hardware profile has changed by comparing the current hardware profile with the previous hardware profile if it is determined that the previous hardware profile exists; and
(iii) a component for configuring and saving hardware parameters if it is determined that hardware parameters need to be configured, comprising:
(iii1) a hardware configuration component for determining hardware configuration parameters,
(iii2) a component for saving determined hardware configuration parameters within a predetermined storage location, and
(iii3) a component for saving current hardware profile within a predetermined storage location; and
(iv) a component for loading hardware drivers based on saved hardware configuration parameters.

304. The method of claim 295, wherein the operating system environment includes a first initialization component for initializing the operating system environment, the first initialization component including
a state maintenance component for maintaining a record of initialized system state within a predetermined storage location.

305. A computer system comprising:
(a) a network;
(b) a service provider interfacing with the network;
(c) a client computer interfacing with the network; and
(d) an apparatus that the client computer can boot from, the apparatus comprising:
(d1) a portable non-volatile memory element,
(d2) an operating system environment stored on the portable non-volatile memory element,
(d3) a bootloader for booting the operating system environment from the portable non-volatile memory element, wherein the client computer communicates with the service provider over the network.

306. The system of claim 305, wherein the operating system environment includes a plurality of security mechanisms that are configured to provide a substantially fault-tolerant multi layered security architecture.

307. The system of claim 305, wherein the operating system environment includes:
(i) a virtual private network component for establishing a virtual private network connection, and
(ii) a network configuration component for establishing network connectivity, the network configuration component including a component for invoking the virtual private network component to establish a virtual private network connection after network connectivity is established.

308. The system of claim 305, wherein the operating system environment includes a connectivity agent component for establishing network connectivity across a variety of circumstances with minimum user interaction.

309. The system of claim 305, wherein the operating system environment includes:
(i) a persistent safe storage component for storing data persistently inside at least one persistent safe storage element, the persistent safe storage element comprising an opaque container, and
(ii) a first initialization component for initializing the operating system environment, the first initialization component including:
(ii1) an access component for attempting to locate and access the persistent safe storage element; and
(ii2) a creation component for creating the persistent safe storage element if the access component fails to locate or access persistent safe storage element.

310. The system of claim 305, wherein the operating system environment includes a first initialization component for initializing the operating system environment, the first initialization component including:
(i) a hardware profiling component for determining current hardware profile of the computer;
(ii) a component for determining whether hardware parameters need to be configured, comprising:
(ii1) a component for determining if a previous hardware profile has been previously saved to a predetermined storage location, and
(ii2) a component for determining if hardware profile has changed by comparing the current hardware profile with the previous hardware profile if it is determined that the previous hardware profile exists; and
(iii) a component for configuring and saving hardware parameters if it is determined that hardware parameters need to be configured, comprising:
(iii1) a hardware configuration component for determining hardware configuration parameters,
(iii2) a component for saving determined hardware configuration parameters within a predetermined storage location, and
(iii3) a component for saving current hardware profile within a predetermined storage location; and
(iv) a component for loading hardware drivers based on saved hardware configuration parameters.

311. The system of claim 305, wherein the operating system environment includes
a first initialization component for initializing the operating system environment, the first initialization component including
a state maintenance component for maintaining a record of initialized system state within a predetermined storage location.

312. A method of communicating between a client computer and a service provider comprising:
(a) interfacing a service provider with a network;
(b) interfacing a client computer with the network;
(c) inserting into the client computer an apparatus that the client computer can boot from, the apparatus comprising:
(c1) a portable non-volatile memory element,
(c2) an operating system environment stored on the portable non-volatile memory element, and
(c3) a bootloader for booting the operating system environment from the portable non-volatile memory element, wherein the client computer communicates with the service provider over the network, and
(d) booting the client computer from the apparatus.

313. The method of claim 312, wherein the operating system environment includes a plurality of security mechanisms that are configured to provide a substantially fault-tolerant multi layered security architecture.

314. The method of claim 312, wherein the operating system environment includes:
(i) a virtual private network component for establishing a virtual private network connection, and
(ii) a network configuration component for establishing network connectivity, the network configuration component including a component for invoking the virtual private network component to establish a virtual private network connection after network connectivity is established.

315. The method of claim 312, wherein the operating system environment includes a connectivity agent component for establishing network connectivity across a variety of circumstances with minimum user interaction.

316. The method of claim 312, wherein the operating system environment includes:
(i) a persistent safe storage component for storing data persistently inside at least one persistent safe storage element, the persistent safe storage element comprising an opaque container, and
(ii) a first initialization component for initializing the operating system environment, the first initialization component including:
(ii1) an access component for attempting to locate and access the persistent safe storage element; and
(ii2) a creation component for creating the persistent safe storage element if the access component fails to locate or access persistent safe storage element.

317. The method of claim 312, wherein the operating system environment includes a first initialization component for initializing the operating system environment, the first initialization component including:
(i) a hardware profiling component for determining current hardware profile of the computer;
(ii) a component for determining whether hardware parameters need to be configured, comprising:
(ii1) a component for determining if a previous hardware profile has been previously saved to a predetermined storage location, and
(ii2) a component for determining if hardware profile has changed by comparing the current hardware profile with the previous hardware profile if it is determined that the previous hardware profile exists; and
(iii) a component for configuring and saving hardware parameters if it is determined that hardware parameters need to be configured, comprising:
(iii1) a hardware configuration component for determining hardware configuration parameters,
(iii2) a component for saving determined hardware configuration parameters within a predetermined storage location, and
(iii3) a component for saving current hardware profile within a predetermined storage location; and
(iv) a component for loading hardware drivers based on saved hardware configuration parameters.

318. The method of claim 312, wherein the operating system environment includes
a first initialization component for initializing the operating system environment, the first initialization component including
a state maintenance component for maintaining a record of initialized system state within a predetermined storage location.
